(19) United States
(12) Patent Application Publication
(10) Pub. No.: US 2024/0153683 A1
(43) Pub. Date: May 9, 2024

(54) NON-ORIENTED ELECTRICAL STEEL SHEET AND METHOD FOR MANUFACTURING SAME

(71) Applicant: NIPPON STEEL CORPORATION, Tokyo (JP)

(72) Inventor: Tesshu MURAKAWA, Tokyo (JP)

(73) Assignee: NIPPON STEEL CORPORATION, Tokyo (JP)

(21) Appl. No.: 18/281,193

(22) PCT Filed: Mar. 18, 2022
(86) PCT No.: PCT/JP2022/012735

§ 371 Date: Sep. 8, 2023

(30) Foreign Application Priority Data
Mar. 19, 2021 (JP) 2021-046056

(51) Int. Cl. H01F 1/147; C21D 6/00; C21D 8/12; C21D 9/46; C22C 38/00; C22C 38/02; C22C 38/04; C22C 38/06; C22C 38/20; C22C 38/30; C22C 38/32; C22C 38/34; C22C 38/40; C22C 38/60

(52) U.S. Cl. CPC H01F 1/14791; C21D 6/002; C21D 6/004; C21D 6/005; C21D 6/007; C21D 6/008; C21D 8/1233; C21D 8/1266; C21D 9/46; C22C 38/001; C22C 38/002; C22C 38/004; C22C 38/005; C22C 38/008; C22C 38/02; C22C 38/04; C22C 38/06; C22C 38/20; C22C 38/30; C22C 38/32; C22C 38/34; C22C 38/40; C22C 38/60; C22C 2202/02

(57) ABSTRACT

This non-oriented electrical steel sheet has a predetermined chemical composition, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M becomes more than 2.8 is indicated by S_{tyl}, a total area of orientated grains in which the Taylor factor M becomes 2.8 or less is indicated by Sₜᵣₐ, an average KAM value of the {411} orientated grains is indicated by K₄₁₁, and an average KAM value of the orientated grains in which the Taylor factor M becomes more than 2.8 is indicated by K_{tyl}, 0.20≤S_{tyl}/Sₜₒₜ≤0.85, 0.05≤S₄₁₁/Sₜₒₜ≤0.80, S₄₁₁/Sₜᵣₐ≥0.50, and K₄₁₁/K_{tyl}≤0.990 are satisfied.

### TECHNICAL FIELD OF THE INVENTION

The present invention relates to a non-oriented electrical steel sheet and a method for manufacturing the same.

Priority is claimed on Japanese Patent Application No. 2021-046056, filed Mar. 19, 2021, the content of which is incorporated herein by reference.

### RELATED ART

Non-oriented electrical steel sheets are used for, for example, cores of motors, and non-oriented electrical steel sheets are required to be excellent in terms of magnetic characteristics, for example, a low iron loss and a high magnetic flux density in a direction parallel to sheet surfaces thereof.

In order for this, it is advantageous to control the texture of the steel sheet such that the magnetization easy axis (<100> orientation) of crystals coincides with the sheet in-plane direction. Regarding such texture control, many techniques for controlling a {100} orientation, a {110} orientation, a {111} orientation, and the like have been disclosed like, for example, techniques described in Patent Documents 1 to 5.

Various methods have been devised as methods for controlling textures, and among them, there are techniques in which “strain-induced boundary migration” is utilized. In strain-induced boundary migration under specific conditions, it is possible to suppress the accumulation of {111} orientations that do not have any magnetization easy axis in the sheet in-plane direction, and thus the strain-induced boundary migration is effectively utilized for non-oriented electrical steel sheets. These techniques are disclosed in Patent Documents 6 to 10 and the like.

However, in conventional methods, it is possible to suppress the accumulation of {111} orientations, but a {110}<001> orientation (hereinafter, Goss orientation) grows. The Goss orientation is superior to {111} in terms of magnetic characteristics in one direction, but magnetic characteristics are rarely improved on a whole direction average. Therefore, in the conventional methods, there is a problem in that excellent magnetic characteristics cannot be obtained on a whole direction average.

### PRIOR ART DOCUMENT

### Patent Document

[Patent Document 1] Japanese Unexamined Patent Application, First Publication No. 2017-193754
[Patent Document 2] Japanese Unexamined Patent Application, First Publication No. 2011-111658
[Patent Document 3] PCT International Publication No. WO 2016/148010 [Patent Document 4] Japanese Unexamined Patent Application, First Publication No. 2018-3049
[Patent Document 5] PCT International Publication No. WO 2015/199211
[Patent Document 6] Japanese Unexamined Patent Application, First Publication No. H8-143960
[Patent Document 7] Japanese Unexamined Patent Application, First Publication No. 2002-363713
[Patent Document 8] Japanese Unexamined Patent Application, First Publication No. 2011-162821
[Patent Document 9] Japanese Unexamined Patent Application, First Publication No. 2013-112853
[Patent Document 10] Japanese Patent No. 4029430

### DISCLOSURE OF THE INVENTION

### Problems to be Solved by the Invention

The present invention has been made in consideration of the above-described problem, and an objective of the present invention is to provide a non-oriented electrical steel sheet in which excellent magnetic characteristics can be obtained on a whole direction average and a method for manufacturing the same.

### Means for Solving the Problem

The present inventors studied techniques for forming preferable textures for non-oriented electrical steel sheets utilizing strain-induced boundary migration. During the studies, attention was paid to the fact that crystal grains in a {411}<uvw> orientation (hereinafter, {411} orientation) are also crystal grains in which strain induction is as difficult as in the Goss orientation. That is, when the number of crystal grains in the {411} orientation is made to be larger than the number of crystal grains in the Goss orientation in a stage before the occurrence of strain-induced boundary migration, due to the strain-induced boundary migration, mainly the crystal grains in the {411} orientation encroach crystal grains in a {111} orientation, and a non-oriented electrical steel sheet having the {411} orientation as the main orientation is manufactured. It is found that, when the {411} orientation is made to be the main orientation as described above, magnetic characteristics on a whole direction average (the average of the rolling direction, the width direction, a direction at 45 degrees with respect to the rolling direction, and a direction at 135 degrees with respect to the rolling direction) are improved.

In addition, the inventors studied a method for increasing the number of crystal grains in the {411} orientation to be larger than that of crystal grains in the Goss orientation in a stage before the occurrence of strain-induced boundary migration. As a result, the inventors found a method in which a grain-oriented electrical steel sheet is used, the grain-oriented electrical steel sheet is cold-rolled at a predetermined rolling reduction in the width direction, and intermediate annealing and skin pass rolling are further performed.

As a result of repeating additional intensive studies based on such a finding, the present inventors obtained ideas of various aspects of the invention described below.

[1]

A non-oriented electrical steel sheet according to one aspect of the present invention containing, as a chemical composition, by mass %,
C: 0.0100% or less,
Si: 1.50% to 4.00%,
one or more selected from the group consisting of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass % c) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities,
in which, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {411} orientated grains is indicated by K₄₁₁, and an average KAM value of the orientated grains in which the Taylor factor M becomes more than 2.8 is indicated by K_{tyl}, Formulas (3) to (6) are satisfied.

([Mn]+[Ni]+[Co]+[Pt]+[Pb]+[Cu]+[Au])−([Si]+[sol. Al])≤0.00% (1)

M=(cosϕ×cosλ)⁻¹ (2)

0.20≤S_{tyl}/Sₜₒₜ≤0.85 (3)

0.05≤S₄₁₁/Sₜₒₜ≤0.80 (4)

S₄₁₁/S^{tra}≥0.50 (5)

K_{411/}K_{tyl}≤0.990 (6)

Here, ϕ in Formula (2) represents an angle formed by a stress vector and a slip direction vector of a crystal, and λ represents an angle formed by the stress vector and a normal vector of a slip plane of the crystal.

[2]

The non-oriented electrical steel sheet according to [1], in which, in a case where an average KAM value of the orientated grains in which the Taylor factor M becomes 2.8 or less is indicated by Kₜᵣₐ, Formula (7) may be satisfied.

K₄₁₁/Kₜᵣₐ≤1.010 (7)

[3]

The non-oriented electrical steel sheet according to [1] or [2], in which, in a case where an area of {110} orientated grains is indicated by Sino, Formula (8) may be satisfied.

S₄₁₁/S₁₁₀≥1.00 (8)

Here, it is assumed that Formula (8) is satisfied even when an area ratio S₄₁₁/S₁₁₀ diverges to infinity.

[4] The non-oriented electrical steel sheet according to any one of [1] to [3], in which, in a case where an average KAM value of {110} orientated grains is indicated by K₁₁₀, Formula (9) may be satisfied.

K₄₁₁/K₁₁₀<1.010 (9)

[5]

A non-oriented electrical steel sheet according to another aspect of the present invention containing, by mass %,
C: 0.0100% or less,
Si: 1.50% to 4.00%,
one or more selected from the group consisting of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass % c) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities,
in which, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {411} orientated grains is indicated by K₄₁₁, an average KAM value of the orientated grains in which the Taylor factor M becomes more than 2.8 is indicated by K_{tyl}, an average grain size in an observation region is indicated by dₐᵥₑ, an average grain size of the {411} orientated grains is indicated by d₄₁₁, and an average grain size of the orientated grains in which the Taylor factor M becomes more than 2.8 is indicated by d_{tyl}, Formulas (10) to (15) are satisfied.

([Mn]+[Ni]+[Co]+[Pt]+[Pb]+[Cu]+[Au])−([Si]+[sol. Al])≤0.00% (1)

M=(cosϕ×cosλ)⁻¹ (2)

S_{tyl}/Sₜₒₜ≤0.70 (10)

0.20≤S₄₁₁/Sₜₒₜ (11)

S₄₁₁/Sₜᵣₐ≥0.55 (12)

K₄₁₁/K_{tyl}≤1.010 (13)

d₄₁₁/dₐᵥₑ>1.00 (14)

d₄₁₁/d_{tyl}>1.00 (15)

Here, ϕ in Formula (2) represents an angle formed by a stress vector and a slip direction vector of a crystal, and λ represents an angle formed by the stress vector and a normal vector of a slip plane of the crystal.

[6]

The non-oriented electrical steel sheet according to [5], in which, in a case where an average KAM value of the orientated grains in which the Taylor factor M becomes 2.8 or less is indicated by Kₜᵣₐ, Formula (16) may be satisfied.

K₄₁₁/Kₜᵣₐ≤1.010 (16)

[7]

The non-oriented electrical steel sheet according to [5] or [6], in which, in a case where an average grain size of the orientated grains in which the Taylor factor M becomes 2.8 or less is indicated by dₜᵣₐ, Formula (17) may be satisfied.

d₄₁₁/dₜᵣₐ>1.00 (17)

[8]

The non-oriented electrical steel sheet according to any one of [5] to [7], in which, in a case where an area of {110} orientated grains is indicated by S₁₁₀, Formula (18) may be satisfied.

S₄₁₁/S₁₁₀≥1.00 (18)

Here, it is assumed that Formula (18) is satisfied even when an area ratio S₄₁₁/S₁₁₀ diverges to infinity.

[9]

The non-oriented electrical steel sheet according to any one of [5] to [8], in which, in a case where an average KAM value of {110} orientated grains is indicated by K₁₁₀, Formula (19) may be satisfied.

K₄₁₁/K₁₁₀<1.010 (19)

[10]

The non-oriented electrical steel sheet according to any one of [1] to [9], in which the chemical composition contains, by mass %, one or more selected from the group consisting of
Sn: 0.02% to 0.40%,
Sb: 0.02% to 0.40%, and
P: 0.02% to 0.40%.

[11]

The non-oriented electrical steel sheet according to any one of [1] to [10], in which the chemical composition contains, by mass %, one or more selected from Mg, Ca, Sr, Ba, Ce, La, Nd, Pr, Zn, and Cd: 0.0005% to 0.0100% in total.

[12]

A method for manufacturing a non-oriented electrical steel sheet according to one aspect of the present invention is
a method for manufacturing the non-oriented electrical steel sheet according to any one of [1] to [4], the method including
performing cold rolling in a width direction at a rolling reduction of 20% to 50% on a grain-oriented electrical steel sheet containing, as a chemical composition, by mass %:
   C: 0.0100% or less,
   Si: 1.50% to 4.00%,
   one or more selected from the group consisting of Mn, Ni, Co, Pt, Pb, Cu, and Au: less than 2.50% in total,
   sol. Al: 4.000% or less,
   S: 0.0400% or less,
   N: 0.0100% or less,
   Sn: 0.00% to 0.40%,
   Sb: 0.00% to 0.40%,
   P: 0.00% to 0.40%,
   Cr: 0.000% to 0.100%,
   B: 0.0000% to 0.0050%,
   O: 0.0000% to 0.0200%,
   one or more selected from the group consisting of Mg, Ca, Sr, Ba, Ce, La, Nd, Pr, Zn, and Cd: 0.0000% to 0.0100% in total,
   in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
   a remainder of Fe and impurities,
performing intermediate annealing on the steel sheet on which the cold rolling has been performed at a temperature of 650° C. or higher, and
performing skin pass rolling in the same direction as a rolling direction of the cold rolling at a rolling reduction of 5% to 30% on the steel sheet on which the intermediate annealing has been performed.

([Mn]+[Ni]+[Co]+[Pt]+[Pb]+[Cu]+[Au])−([Si]+[sol. Al])≤0.00% (1)

[13]

A method for manufacturing a non-oriented electrical steel sheet according to another aspect of the present invention is a method for manufacturing the non-oriented electrical steel sheet according to any one of [5] to [9], the method including
performing a heat treatment on the non-oriented electrical steel sheet according to any one of [1] to [4] at a temperature of 700° C. to 950° C. for 1 second to 100 seconds.

[14]

A non-oriented electrical steel sheet according to another aspect of the present invention containing, as a chemical composition, by mass %,
C: 0.0100% or less,
Si: 1.50% to 4.00%,
one or more selected from the group consisting of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more selected from the group consisting of Mg, Ca, Sr, Ba, Ce, La, Nd, Pr, Zn, and Cd: 0.0000% to 0.0100% in total,
in which, when a Mn content (mass %) is indicated by [Mn], a Ni content (mass % c) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities,
in which, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average grain size in an observation region is indicated by dₐᵥₑ, an average grain size of the {411} orientated grains is indicated by d₄₁₁, and an average grain size of the orientated grains in which the Taylor factor M becomes more than 2.8 is indicated by d_{tyl}, Formulas (20) to (24) are satisfied.

([Mn]+[Ni]+[Co]+[Pt]+[Pb]+[Cu]+[Au])−([Si]+[sol. Al])≤0.00% (1)

M=(cosϕ×cosλ)⁻¹ (2)

S_{tyl}/Sₜₒₜ<0.55 (20)

S₄₁₁/Sₜₒₜ>0.30 (21)

S₄₁₁/Sₜᵣₐ≥0.60 (22)

d₄₁₁/dₐᵥₑ≥0.95 (23)

d₄₁₁/d_{tyl}≥0.95 (24)

Here, ϕ in Formula (2) represents an angle formed by a stress vector and a slip direction vector of a crystal, and λ represents an angle formed by the stress vector and a normal vector of a slip plane of the crystal.

[15]

The non-oriented electrical steel sheet according to [14], in which, in a case where an average grain size of the orientated grains in which the Taylor factor M becomes 2.8 or less is indicated by dₜa, Formula (25) may be satisfied.

d₄₁₁/dₜᵣₐ≥0.95 (25)

[16]

A method for manufacturing a non-oriented electrical steel sheet according to another aspect of the present invention, including
performing a heat treatment on the non-oriented electrical steel sheet according to any one of [1] to [11] at a temperature of 950° C. to 1050° C. for 1 second to 100 seconds or at a temperature of 700° C. to 900° C. for longer than 1000 seconds.

### Effects of the Invention

According to the above-described aspects of the present invention, it is possible to provide a non-oriented electrical steel sheet in which excellent magnetic characteristics can be obtained on a whole direction average and a method for manufacturing the same.

### EMBODIMENTS OF THE INVENTION

Hereinafter, embodiments of the present invention will be described. A non-oriented electrical steel sheet according to an embodiment of the present invention is manufactured by using a grain-oriented electrical steel sheet having a chemical composition to be described below as a material and performing a cold rolling step of performing cold rolling in the width direction of the grain-oriented electrical steel sheet, an intermediate annealing step, and a skin pass rolling step. A non-oriented electrical steel sheet according to another embodiment of the present invention is manufactured by performing a cold rolling step of performing cold rolling in the width direction of a grain-oriented electrical steel sheet, an intermediate annealing step, a skin pass rolling step, and a first heat treatment step. In addition, a non-oriented electrical steel sheet according to another embodiment of the present invention is manufactured by performing a cold rolling step of performing cold rolling in the width direction of a grain-oriented electrical steel sheet, an intermediate annealing step, a skin pass rolling step, a first heat treatment step that is performed as necessary, and a second heat treatment step.

Due to the heat treatments (the first heat treatment and/or the second heat treatment) after the skin pass rolling, the steel sheet undergoes strain-induced boundary migration and then normal grain growth. The strain-induced boundary migration and the normal grain growth may occur in the first heat treatment step or may occur in the second heat treatment step. The steel sheet after the skin pass rolling is a base sheet of the steel sheet after the strain-induced boundary migration or a base sheet of the steel sheet after the normal grain growth. In addition, the steel sheet after the strain-induced boundary migration is a base sheet of the steel sheet after the normal grain growth. Hereinafter, steel sheets after skin pass rolling, steel sheets after strain-induced boundary migration, and steel sheets after normal grain growth will be all described as non-oriented electrical steel sheets regardless of before or after the heat treatments.

In addition, in the present embodiment, the number of crystal grains mainly oriented in a {411} orientation (hereinafter, {411} orientated grains) is made to be larger than the number of crystal grains mainly oriented in a Goss orientation (hereinafter, {110} orientated grains) in the metallographic structure of the steel sheet before the skin pass rolling, whereby the number of the {411} orientated grains is further increased in the subsequent heat treatment steps, and the magnetic characteristics around the whole direction are improved. The number of the {411}orientated grains may be increased before the skin pass rolling by a step other than the above-described process.

First, the chemical compositions of the non-oriented electrical steel sheet according to the present embodiment and the grain-oriented electrical steel sheet, which is the material that is used in a method for manufacturing the same, will be described. Since the chemical composition does not change by rolling or a heat treatment, the chemical composition of the grain-oriented electrical steel sheet, which becomes a material, and the chemical composition of the non-oriented steel sheet that is obtained through each step are the same. In the following description, “%” that is the unit of the amount of each element that is contained in the non-oriented electrical steel sheet or the steel material means “mass %” unless particularly otherwise described. The non-oriented electrical steel sheet according to the present embodiment and the grain-oriented electrical steel sheet, which becomes a material, contain, as a chemical composition, C: 0.0100% or less, Si: 1.50% to 4.00%, one or more selected from the group consisting of Mn, Ni, Co, Pt, Pb, Cu, and Au: less than 2.50% in total, sol. Al: 4.000% or less, S: 0.0400% or less, N: 0.0100% or less, Sn: 0.00% to 0.40%, Sb: 0.00% to 0.40%, P: 0.00% to 0.40%, Cr: 0.000% to 0.100%, B: 0.0000% to 0.0050%, O: 0.0000% to 0.0200%, and one or more selected from the group consisting of Mg, Ca, Sr, Ba, Ce, La, Nd, Pr, Zn, Cd: 0.0000% to 0.0100% in total, and a remainder of Fe and impurities. In addition, when the Mn content (mass %) is indicated by [Mn], the Ni content (mass %) is indicated by [Ni], the Co content (mass %) is indicated by [Co], the Pt content (mass %) is indicated by [Pt], the Pb content (mass %) is indicated by [Pb], the Cu content (mass %) is indicated by [Cu], the Au content (mass %) is indicated by [Au], the Si content (mass %) is indicated by [Si], and the sol. Al content (mass %) is indicated by [sol. Al], ([Mn]+[Ni]+[Co]+[Pt]+[Pb]+[Cu]+[Au])−([Si]+[sol. Al])≤0.00% is satisfied. As the impurities, impurities that are contained in a raw material such as ore or a scrap or impurities that are contained during manufacturing steps are exemplary examples.

In addition, instead of the grain-oriented electrical steel sheet, a steel sheet having the above-described chemical composition may be used as the material after a single crystal is formed and grains that become a Goss orientation are cut out.

(C: 0.0100% or less)

C increases the iron loss or causes magnetic aging. Therefore, the C content is preferably as small as possible. Such a phenomenon becomes significant when the C content exceeds 0.0100%. Therefore, the C content is set to 0.0100% or less. The lower limit of the C content is not particularly limited, but the C content is preferably set to 0.0005% or more based on the cost of a decarburization treatment at the time of refining.

(Si: 1.50% to 4.00%)

Si increases the electric resistance to decrease the eddy-current loss to reduce the iron loss or increases the yield ratio to improve punching workability for forming cores. When the Si content is less than 1.50%, these effects cannot be sufficiently obtained. Therefore, the Si content is set to 1.50% or more. On the other hand, when the Si content is more than 4.00%, the magnetic flux density decreases, the punching workability deteriorates or cold rolling becomes difficult due to an excessive increase in hardness. Therefore, the Si content is set to 4.00% or less.

(One or more selected from group consisting of Mn, Ni, Co, Pt, Pb, Cu, and Au: less than 2.50% in total)

These elements are austenite (γ phase)-stabilizing elements, and, when these elements are contained in a large quantity, ferrite-austenite transformation (hereinafter, α-γ transformation) occurs during the heat treatment of the steel sheet. The effect of the non-oriented electrical steel sheet according to the present embodiment is considered to be exhibited by controlling the area and area ratio of a specific crystal orientation in a cross section parallel to the steel sheet surface; however, when α-γ transformation occurs during the heat treatment, the area and the area ratio significantly change due to the transformation, and it becomes difficult to obtain a predetermined area ratio. Therefore, the total of the amounts of one or more selected from the group consisting of Mn, Ni, Co, Pt, Pb, Cu, and Au is limited to less than 2.50%. The total of the contents is preferably less than 2.00% and more preferably less than 1.50%. The lower limit of the total of the amounts of these elements is not particularly limited, but is preferably set to 0.0001% or more from the viewpoint of cost.

In addition, as a condition for preventing the occurrence of the α-γ transformation, the chemical composition is made to further satisfy the following condition. That is, when the Mn content (mass %) is indicated by [Mn], the Ni content (mass %) is indicated by [Ni], the Co content (mass %) is indicated by [Co], the Pt content (mass %) is indicated by [Pt], the Pb content (mass % f) is indicated by [Pb], the Cu content (mass %) is indicated by [Cu], the Au content (mass %) is indicated by [Au], the Si content (mass %) is indicated by [Si], and the sol. Al content (mass %) is indicated by [sol. Al], the contents are made to satisfy Formula (l).

([Mn]+[Ni]+[Co]+[Pt]+[Pb]+[Cu]+[Au])−([Si]+[sol. Al])≤0.00% (1)

(sol. Al: 4.000% or less)

sol. Al increases the electric resistance to decrease the eddy-current loss to reduce the iron loss. sol. Al also contributes to improvement in the relative magnitude of a magnetic flux density B50 with respect to the saturated magnetic flux density. Here, the magnetic flux density B50 refers to a magnetic flux density in a magnetic field of 5000 A/m. When the sol. Al content is less than 0.0001%, these effects cannot be sufficiently obtained. In addition, Al also has a desulfurization-promoting effect in steelmaking. Therefore, the sol. Al content is preferably set to 0.0001% or more. The sol. Al content is more preferably 0.001% or more and still more preferably 0.300% or more. On the other hand, when the sol. Al content is more than 4.000%, the magnetic flux density decreases or the yield ratio decreases, whereby the punching workability deteriorates. Therefore, the sol. Al content is set to 4.000% or less. The sol. Al content is preferably set to 2.500% or less and more preferably set to 1.500% or less.

(S: 0.0400% or less)

S is not an essential element and is contained in steel, for example, as an impurity. S causes the precipitation of fine MnS and thereby inhibits recrystallization and the growth of crystal grains in annealing. Therefore, the S content is preferably as small as possible. An increase in the iron loss and a decrease in the magnetic flux density resulting from such inhibition of recrystallization and grain growth become significant when the S content is more than 0.0400%. Therefore, the S content is set to 0.0400% or less. The S content is preferably set to 0.0200% or less and more preferably set to 0.0100% or less. The lower limit of the S content is not particularly limited, but the S content is preferably set to 0.0003% or more based on the cost of a desulfurization treatment at the time of refining.

(N: 0.0100% or less)

Similar to C, N degrades the magnetic characteristics, and thus the N content is preferably as small as possible. Therefore, the N content is set to 0.0100% or less. The lower limit of the N content is not particularly limited, but the N content is preferably set to 0.0010% or more based on the cost of a denitrification treatment at the time of refining.

(Sn: 0.00% to 0.40%, Sb: 0.00% to 0.40% and P: 0.00% to 0.40%)

When Sn, Sb or P is excessively contained, steel is embrittled. Therefore, the Sn content and the Sb content are both set to 0.40% or less, and the P content is set to 0.40% or less.

On the other hand, Sn and Sb improve the texture after cold rolling or recrystallization to improve the magnetic flux density. P contributes to securing the hardness of the steel sheet after recrystallization. Therefore, these elements may be contained as necessary. In the case of imparting an additional effect on the magnetic characteristics or the like, one or more selected from the group consisting of 0.02% to 0.40% of Sn, 0.02% to 0.40% of Sb and 0.02% to 0.40% of P are preferably contained.

(One or more selected from the group consisting of Mg, Ca, Sr, Ba, Ce, La, Nd, Pr, Zn, and Cd: 0.0000% to 0.0100% in total)

Mg, Ca, Sr, Ba, Ce, La, Nd, Pr, Zn, and Cd react with S in molten steel during the casting of the molten steel to form the precipitate of a sulfide, an oxysulfide or both. Hereinafter, Mg, Ca, Sr, Ba, Ce, La, Nd, Pr, Zn, and Cd will be collectively referred to as “coarse precipitate forming elements” in some cases. The grain sizes in the precipitate of the coarse precipitate forming element are approximately 1 μm to 2 μm, which is significantly larger than the grain sizes (approximately 100 nm) in the fine precipitates of MnS, TiN, AlN, or the like. Therefore, these fine precipitates adhere to the precipitates of the coarse precipitate forming elements and are less likely to inhibit the growth of crystal grains in strain-induced boundary migration. Therefore, these elements may be contained. In order to sufficiently obtain the above-described effect, the total of the amounts of these elements is preferably 0.0005% or more. On the other hand, when the total of the amounts of these elements exceeds 0.0100%, the total amount of the sulfide, the oxysulfide, or both becomes excessive, and the growth of crystal grains in strain-induced boundary migration is inhibited. Therefore, the amount of the coarse precipitate forming elements is set to 0.0100% or less in total.

(Cr: 0.000% to 0.100%)

Cr bonds to oxygen in steel and forms Cr₂O₃. This Cr₂O₃ contributes to improvement in the texture. Therefore, Cr may be contained. In the case of obtaining the above-described effect, the Cr content is preferably set to 0.001% or more.

On the other hand, when the Cr content exceeds 0.100%, Cr₂O₃ inhibits grain growth during annealing, the grain sizes become fine, and Cr₂O₃ causes an increase in iron loss. Therefore, the Cr content is set to 0.100% or less.

(B: 0.0000% to 0.0050%)

B contributes to improvement in the texture in a small quantity. Therefore, B may be contained. In the case of obtaining the above-described effect, the B content is preferably set to 0.0001% or more.

On the other hand, when the B content exceeds 0.0050%, a compound of B inhibits grain growth during annealing, the grain sizes become fine, and B causes an increase in iron loss. Therefore, the B content is set to 0.0050% or less.

(O: 0.0000% to 0.0200%)

O bonds to Cr in steel and forms Cr₂O₃. This Cr₂O₃ contributes to improvement in the texture. Therefore, O may be contained. In the case of obtaining the above-described effect, the O content is preferably set to 0.0010% or more.

On the other hand, when the O content exceeds 0.0200%, Cr₂O₃ inhibits grain growth during annealing, the grain sizes become fine, and Cr₂O₃ causes an increase in iron loss. Therefore, the O content is set to 0.0200% or less.

Next, the sheet thickness of the non-oriented electrical steel sheet according to the present embodiment will be described. The thickness (sheet thickness) of the non-oriented electrical steel sheet according to the embodiment is preferably 0.10 mm to 0.28 mm. When the thickness exceeds 0.28 mm, there are cases where it is not possible to obtain an excellent high-frequency iron loss. Therefore, the thickness is preferably set to 0.28 mm or less. When the thickness is less than 0.10 mrn, the influence of magnetic flux leakage from the surface of the non-oriented electrical steel sheet or the like becomes large, and there, are cases where the magnetic characteristics deteriorate. In addition, when the thickness is less than 0.10 mm, there is a possibility that threading along an annealing line may become difficult or the number of non-oriented electrical steel sheets required for cores having a certain size may increase, which causes deterioration of productivity due to an increase in man-hours and an increase in the manufacturing cost. Therefore, the thickness is preferably set to 0.10 mm or more. The thickness is more preferably 0.20 mm to 0.25 mm.

Next, the metallographic structure of the non-oriented electrical steel sheet according to the present embodiment will be described. Hereinafter, a non-oriented electrical steel sheet of each embodiment will be specified by the metallographic structure after skin pass rolling, the metallographic structure after the first heat treatment, and the metallographic structure after the second heat treatment.

First, a metallographic structure to be specified and a method for specifying the same will be described. The metallographic structure to be specified in the present embodiment is a metallographic structure that is specified in a cross section parallel to the sheet surface of the steel sheet and is specified by the following procedure.

First, the steel sheet is polished so that the sheet thickness center is exposed, and a region of 2500 μm² or more on the polished surface (surface parallel to the steel sheet surface) is observed by EBSD (electron back scattering diffraction). As long as the total area is 2500 μm² or more, the observation may be performed at several sites in several divided small sections. The step intervals during measurement are desirably 50 to 100 nm. The following kinds of areas, KAM (Kernel average misorientation) values, and average grain sizes are obtained from the EBSD observation data by an ordinary method.
Sₜₒₜ: Total area (observed area)
S_{tyl}: Total area of orientated grains in which the Taylor factor M according to Formula (2) becomes more than 2.8
Sₜᵣₐ: Total area of orientated grains in which the Taylor factor M according to Formula (2) becomes 2.8 or less
S₄₁₁: Total area of {411} orientated grains
S₁₁₀: Total area of {110} orientated grains
K_{tyl}: Average KAM value of orientated grains in which the Taylor factor M according to Formula (2) becomes more than 2.8
Kₜᵣₐ: Average KAM value of orientated grains in which the Taylor factor M according to Formula (2) becomes 2.8 or less
K₄₁₁: Average KAM value of {411} orientated grains
K₁₁₀: Average KAM value of {110} orientated grains
dₐᵥₑ: Average grain size in observation region
d₄₁₁: Average grain size of {411} orientated grains
d_{tyl}: Average grain size of orientated grains in which the Taylor factor M according to Formula (2) becomes more than 2.8
dₜᵣₐ: Average grain size of orientated grains in which the Taylor factor M according to Formula (2) becomes 2.8 or less

Here, the orientation tolerance of crystal grains is set to 15°. In addition, even when orientated grains appear subsequently, the orientation tolerance is set to 15°.

Here, the Taylor factor M is assumed to follow Formula (2).

M=(cosϕ×cosλ)⁻¹ (2)
ϕ: Angle formed by a stress vector and a slip direction vector of a crystal
λ: Angle formed by the stress vector and a normal vector of a slip plane of the crystal

The above-described Taylor factor M is a Taylor factor in the case of performing compressive deformation in the sheet thickness direction on an in-plane strain in a surface parallel to the sheet thickness direction and the rolling direction with an assumption that the slip deformation of a crystal occurs in a slip plane {110} and in a slip direction <111>. Hereinafter, unless particularly otherwise described, an average value of the Taylor factors according to Formula (2) obtained for all crystallographically equivalent crystals will be simply referred to as “Taylor factor.”

Next, in Embodiments 1 to 3 below, characteristics will be regulated by the above-described area, KAM value, and average grain size.

### Embodiment 1

First, the metallographic structure of the non-oriented electrical steel sheet after skin pass rolling will be described. This metallographic structure accumulates sufficient strain to cause strain-induced boundary migration and can be positioned as an initial stage state before strain-induced boundary migration occurs. The characteristics of the metallographic structure of the steel sheet after skin pass rolling are roughly regulated by an orientation for crystal grains in an intended orientation to develop and conditions regarding the strain sufficiently accumulated to cause strain-induced boundary migration.

In the non-oriented electrical steel sheet according to the present embodiment, the areas of each kind of orientated grains satisfy Formulas (3) to (5).

0.20≤S_{tyl}/Sₜₒₜ≤0.85 (3)

0.05≤S₄₁₁/Sₜᵣₐ≤0.80 (4)

S₄₁₁/Sₜᵣₐ≥0.50 (5)

S_{tyl} is the abundance of an orientation in which the Taylor factor is sufficiently large. In the strain-induced boundary migration step, an orientation in which the Taylor factor is small and strain attributed to processing is less likely to accumulate preferentially grows while encroaching an orientation in which the Taylor factor is large and strain attributed to processing has accumulated. Therefore, in order to develop a special orientation by strain-induced boundary migration, a certain amount of S_{tyl} needs to be present. In the present embodiment, S_{tyl} is regulated as an area ratio to the total area S_{tyl}/Sₜₒₜ, and the area ratio S_{tyl}/Sₜₒₜ is set to 0.20 or more. When the area ratio S_{tyl}/Sₜₒₜ is less than 0.20, an intended crystal orientation does not sufficiently develop by strain-induced boundary migration. The area ratio S_{tyl}/Sₜₒₜ is preferably 0.30 or more and more preferably 0.50 or more.

The upper limit of the area ratio S_{tyl}/Sₜₒₜ is associated with the abundance of crystal orientated grains that should be developed in a strain-induced boundary migration step to be described below, but the condition is not simply determined only by proportions of a preferentially-growing orientation and an orientation to be encroached. First, as described below, since the area ratio S₄₁₁/Sₜₒₜ of {411}orientated grains that should be developed by strain-induced boundary migration is 0.05 or more, the area ratio S_{tyl}/Sₜₒₜ becomes inevitably 0.95 or less. However, when the abundance of the area ratio S_{tyl}/Sₜₒₜ becomes excessive, preferential growth of the {411} orientated grains does not occur due to an association with strain to be described below. The association with the strain amount will be described in detail below; however, in the present embodiment, the area ratio S_{tyl}/Sₜₒₜ becomes 0.85 or less. The area ratio S_{tyl}/Sₜₒₜ is preferably 0.75 or less and more preferably 0.70 or less.

In the subsequent strain-induced boundary migration step, the {411}orientated grains are preferentially grown. A {411} orientation is one of orientations in which the Taylor factor is sufficiently small and strain attributed to processing is less likely to accumulate and is an orientation capable of preferentially growing in the strain-induced boundary migration step. In the present embodiment, the presence of the {411} orientated grains is essential, and, in the present embodiment, the area ratio S₄₁₁/Sₜₒₜ of the {411} orientated grains becomes 0.05 or more. When the area ratio S₄₁₁/Sₜₒₜ of the {411} orientated grains is less than 0.05, the {411} orientated grains do not sufficiently develop by subsequent strain-induced boundary migration. The area ratio S₄₁₁/Sₜₒₜ is preferably 0.10 or more and more preferably 0.20 or more.

The upper limit of the area ratio S₄₁₁/Sₜₒₜ is determined depending on the abundance of crystal orientated grains that should be encroached by strain-induced boundary migration. In the present embodiment, the area ratio S_{tyl}/Sₜₒₜ in the orientation in which the Taylor factor becomes more than 2.8, which is encroached by strain-induced boundary migration, is 0.20 or more, and thus the area ratio S₄₁₁/Sₜₒₜ becomes 0.80 or less. However, when the abundance of the {411} orientated grains before strain-induced boundary migration is small, the effect becomes significant, and it becomes possible to develop the {411} orientated grains. In consideration of this, the area ratio S₄₁₁/Sₜₒₜ is preferably 0.60 or less, more preferably 0.50 or less, and still more preferably 0.40 or less.

As orientated grains that should be preferentially grown, the {411} orientated grains have been mainly described, but there are many other orientated grains which are an orientation in which, similar to the {411} orientated grains, the Taylor factor is sufficiently small and strain attributed to processing is less likely to accumulate and are capable of preferentially growing in strain-induced boundary migration. Among them, an orientation that is likely to be present in the non-oriented electrical steel sheet is a {110} orientation. These orientated grains compete with the {411} orientated grains that should be preferentially grown. On the other hand, these orientated grains do not have as many magnetization easy axis directions (<100> directions) as the {411} orientated grains in the steel sheet surface, and thus, when these orientations develop by strain-induced boundary migration, the magnetic characteristics deteriorate, which becomes disadvantageous. Therefore, in the present embodiment, it is regulated that the abundance ratio of the {411} orientated grains in the orientations in which the Taylor factor is sufficiently small and strain attributed to processing is less likely to accumulate is secured.

In the present invention, the area of the orientated grain in which the Taylor factor becomes 2.8 or less, including orientated grain considered to compete with the {411} orientated grains in strain-induced boundary migration, is indicated by Sₜᵣₐ. In addition, the area ratio S₄₁₁/Sₜᵣₐ is set to 0.50 or more as shown in Formula (5), and superiority in the growth of the {411} orientated grains is secured. When this area ratio S₄₁₁/Sₜᵣₐ is less than 0,50, the {411} orientated grains do not sufficiently develop by strain-induced boundary migration. The area ratio S₄₁₁/Sₜᵣₐ is preferably 0.80 or more and more preferably 0.90 or more. On the other hand, the upper limit of the area ratio S₄₁₁l/Sₜᵣₐ does not need to be particularly limited, and the orientated grains in which the Taylor factor becomes 2.8 or less may be all the {411} orientated grains (that is, S₄₁₁/Sₜᵣₐ=1.00).

Furthermore, in the present embodiment, particularly, a relationship with the {110} orientated grains, which are known as an orientation in which grains are likely to grow by strain-induced boundary migration, is regulated. The {110} orientation is an orientation that is likely to develop relatively easily even in versatile methods in which grain sizes are increased in a hot-rolled steel sheet and grains are recrystallized by cold rolling or grains are recrystallized by cold rolling at a relatively low rolling reduction and should be particularly taken care of in the competition with the {411}orientated grains that should be preferentially grown. When the {110} orientated grains develop by strain-induced boundary migration, the steel sheet in-plane anisotropy of characteristics becomes extremely large, which becomes disadvantageous. Therefore, in the present embodiment, it is preferable to secure the superiority of the growth of the {411} orientated grains by making the area ratio S₄₁₁/S₁₁₀ of the {411} orientated grains to the {110} orientated grains satisfy Formula (8).

S₄₁₁/S₁₁₀≥1.00 (8)

In order to more reliably avoid the careless development of the {110}orientated grains by strain-induced boundary migration, the area ratio S₄₁₁/S₁₁₀ is preferably 1.00 or more. The area ratio S₄₁₁/S₁₁₀ is more preferably 2.00 or more and still more preferably 4.00 or more. The upper limit of the area ratio S₄₁₁/S₁₁₀ does not need to be particularly limited, and the area ratio of the {110} orientated grains may be zero. That is, it is assumed that Formula (8) is satisfied even when the area ratio S₄₁₁/S₁₁₀ diverges to infinity.

In the present embodiment, more excellent magnetic characteristics can be obtained by combining strain to be described below in addition to the above-described crystal orientations. In the present embodiment, as a regulation regarding strain, Formula (6) needs to be satisfied.

K₄₁₁/K_{tyl}≤0.990 (6)

A requirement regarding strain is regulated by Formula (6). Formula (6) is the ratio of strain that is accumulated in the {411} orientated grains (average KAM value) to strain that is accumulated in the orientated grains in which the Taylor factor becomes more than 2.8 (average KAM value). Here, the KAM value is an orientation difference from an adjacent measurement point within the same grain, and the KAM value becomes high at a site where there is a large strain amount. From the crystallographic viewpoint, for example, in a case where compressive deformation in the sheet thickness direction is performed in a planar strain state in a surface parallel to the sheet thickness direction and the rolling direction, that is, in a case where a steel sheet is simply rolled, ordinarily, the ratio K₄₁₁/K_{tyl} of these K₄₁₁ to K_{tyl} becomes smaller than 1. However, in reality, due to an influence of constraints by adjacent crystal grains, precipitates present in the crystal grains, and, furthermore, a macroscopic deformation fluctuation including contact with a tool (rolling roll or the like) during deformation, strain corresponding to a crystal orientation that is microscopically observed has various forms. Therefore, an influence of a purely geometrical orientation by the Taylor factor is less likely to appear. In addition, for example, even between grains have the same orientation, an extremely large fluctuation is formed depending on the grain sizes, the forms of the grains, the orientation or grain size of an adjacent grain, the state of a precipitate, the position in the sheet thickness direction, and the like. Furthermore, even in one crystal grain, the strain distribution significantly fluctuates depending on whether strain is present in the vicinity of the grain boundary or within the grain and the formation of a deformation band or the like.

In order to obtain excellent magnetic characteristics in the present embodiment in consideration of such fluctuations, K₄₁₁/K_{tyl} is set to 0.990 or less. When K₄₁₁/K_{tyl} becomes more than 0.990, since the specialty of a region that should be encroached is lost, strain-induced boundary migration is less likely to occur. K₄₁₁/K_{tyl} is preferably 0.970 or less and more preferably 0.950 or less.

In the competition with the {411} orientated grains that should be preferentially grown, Formula (7) is preferably satisfied regarding a relationship with the orientated grains in which the Taylor factor becomes 2.8 or less.

K₄₁₁/Kₜᵣₐ<1.010 (7)

In order for the {411} orientated grains to preferentially grow, K₄₁₁/Kₜᵣₐ is preferably set to less than 1.010. This K₄₁₁/Kₜᵣₐ is also an index relating to competition between orientations in which strain is less likely to accumulate and which have a possibility of preferential growth, and, when K₄₁₁/Kₜᵣₐ is 1.010 or more, the priority of the {411} orientation in strain-induced boundary migration is not exhibited, and an intended crystal orientation does not develop. K₄₁₁/Kₜᵣₐ is more preferably 0.970 or less and still more preferably 0.950 or less.

In the competition with the {411} orientated grains that should be preferentially grown, it is also preferable to take strain into account in the same manner as the area regarding the relationship with the {110} orientated grains. In this relationship, it is preferable to secure the superiority of the growth of the {411}orientated grains by making the ratio K₄₁₁/K₁₁₀ of the average KAM values between the {411} orientated grains and the {110} orientated grains satisfy Formula (9).

K₄₁₁/K₁₁₀<1.010 (9)

In order to more reliably avoid the careless development of the {110} orientated grains by strain-induced boundary migration, K₄₁₁/K₁₁₀ is preferably less than 1.010. K₄₁₁/K₁₁₀is more preferably 0.970 or less and more preferably 0.950 or less.

In Formula (9), in a case where there are no crystal grains having an orientation corresponding to the denominator, evaluation by a numerical value is not performed on the formula, and the formula is regarded as being satisfied.

In the metallographic structure of the non-oriented electrical steel sheet in a state after the skin pass rolling of the present embodiment, the grain sizes are not particularly limited. This is because the relationship with the grain sizes is not so strong in a state where appropriate strain-induced boundary migration is caused by the subsequent first heat treatment. That is, whether or not intended appropriate strain-induced boundary migration occurs can be almost determined by the relationship of the abundance (area) in each crystal orientation and the relationship of the strain amount in each orientation in addition to the chemical composition of the steel sheet.

Here, when the grain sizes become too coarse, although grain growth is induced by strain, sufficient grain growth in a practical temperature range is less likely to occur. In addition, when the grain sizes become too coarse, deterioration of the magnetic characteristics also becomes difficult to avoid. Therefore, a practical average grain size is preferably set to 300 μm or less. The practical average grain size is more preferably 100 μm or less, still more preferably 50 μm or less, and particularly preferably 30 μm or less. As the grain sizes become finer, it is easier to recognize the development of an intended crystal orientation by strain-induced boundary migration when the crystal orientation and the distribution of strain have been appropriately controlled. However, when the grain size becomes too fine, it becomes difficult to form a difference in the strain amount in each crystal orientation due to constraints with adjacent grains in processing for imparting strain as described above. From this viewpoint, the average grain size is preferably 3 μm or more, more preferably 8 μm or more, and still more preferably 15 μm or more.

### Embodiment 2

Next, the metallographic structure of a non-oriented electrical steel sheet after strain-induced boundary migration is caused by a heat treatment (first heat treatment) (before the completion of the strain-induced boundary migration) will be described. In the non-oriented electrical steel sheet according to the present embodiment, at least a part of strain is released by strain-induced boundary migration, and the characteristics of the metallographic structure of the steel sheet after strain-induced boundary migration are regulated by crystal orientations, strain, and grain sizes.

The crystal orientations in the present embodiment satisfy Formulas (10) to (12). These regulations are different in the numerical value ranges compared with Formulas (3) to (5) regarding the non-oriented electrical steel sheet after skin pass rolling. This is because, along with strain-induced boundary migration, the {411} orientated grains preferentially grow, the area thereof increases, the orientated grains in which the Taylor factor becomes more than 2.8 are mainly encroached by the {411} orientated grains, and the area thereof decreases.

S_{tyl}/Sₜₒₜ≤0.70 (10)

0.20≤S₄₁₁/Sₜₒₜ (11)

S₄₁₁/Sₜᵣₐ≥0.55 (12)

The upper limit of the area ratio S_{tyl}/Sₜₒₜ is determined as one of the parameters indicating the degree of progress of strain-induced boundary migration. When the area ratio S_{tyl}/Sₜₒₜ is more than 0.70, it is indicated that the crystal grains of the orientated grains in which the Taylor factor becomes more than 2.8 are not sufficiently encroached and the strain-induced boundary migration does not sufficiently occur. That is, since development of the {411} orientated grains that should be developed is not sufficient, the magnetic characteristics do not sufficiently improve. Therefore, in the present embodiment, the area ratio S_{tyl}/Sₜₒₜ is set to 0.70 or less. The area ratio S_{tyl}/Sₜₒₜ is preferably 0.60 or less and more preferably 0.50 or less. Since the area ratio S_{tyl}/Sₜₒₜ is preferably as small as possible, the lower limit does not need to be regulated and may be 0.00.

In addition, in the present embodiment, the area ratio S₄₁₁/Sₜₒₜ is set to 0.20 or more. The lower limit of the area ratio S₄₁₁/Sₜₒₜ is determined as one of the parameters indicating the degree of progress of strain-induced boundary migration, and, when the area ratio S₄₁₁/Sₜₒₜ is less than 0.20, development of the {411} orientated grains is not sufficient, and thus the magnetic characteristics do not sufficiently improve. The area ratio S₄₁₁/Sₜₒₜ is preferably 0.40 or more and more preferably 0.60 or more. Since the area ratio S₄n/Sₜₒₜ is preferably as high as possible, the upper limit does not need to be regulated and may be 1.00.

Similar to Embodiment 1, a relationship between orientated grains that are considered to compete with the {411} orientated grains in strain-induced boundary migration and the {411} orientated grains is also important. In a case where the area ratio S₄₁₁/Sₜᵣₐ is large, the superiority of the growth of the {411} orientated grains is secured, and the magnetic characteristics become favorable. When this area ratio S₄₁₁/Sₜₒₜ is less than 0.55, it indicates a state where the {411} orientated grains are not sufficiently developed by strain-induced boundary migration and the orientated grains in which the Taylor factor becomes more than 2.8 have been encroached by orientations in which the Taylor factor is small other than the {411} orientated grains. In this case, the in-plane anisotropy of the magnetic characteristics also becomes large. Therefore, in the present embodiment, the area ratio S₄₁₁/Sₜᵣₐ is set to 0.55 or more. The area ratio S₄₁₁/Sₜᵣₐ is preferably 0.65 or more and more preferably 0.75 or more. On the other hand, the upper limit of the area ratio S₄₁₁/Sₜᵣₐ does not need to be particularly limited, and the orientated grains in which the Taylor factor becomes 2.8 or less may be all the {411} orientated grains.

Furthermore, in the present embodiment, similar to Embodiment 1, a relationship with the {110} orientated grains is also regulated. In the present embodiment, it is preferable that the area ratio S₄₁₁/S₁₁₀ of the {411} orientated grains to the {110} orientated grains satisfies Formula (18), and the superiority of the growth of the {411} orientated grains be secured.

S₄₁₁/S₁₁₀≥1.00 (18)

As shown in Formula (18), in the present embodiment, the area ratio S₄₁₁/S₁₁₀ is preferably 1.00 or more. When the {110} orientated grains develop by strain-induced boundary migration and this area ratio S₄₁₁/S₁₁₀ becomes less than 1.00, the anisotropy in the steel sheet surface becomes extremely large, which is likely to become disadvantageous in terms of characteristics. The area ratio S₄₁₁/S₁₁₀ is more preferably 2.00 or more and still more preferably 4.00 or more. The upper limit of the area ratio S₄₁₁/S₁₁₀ does not need to be particularly limited, and the area ratio of the {110} orientated grains may be zero. That is, it is assumed that Formula (18) is satisfied even when the area ratio S₄₁₁/S₁₁₀ diverges to infinity.

Next, a regulation regarding strain that should be satisfied in the present embodiment will be described. The strain amount in the non-oriented electrical steel sheet according to the present embodiment significantly decreases compared with the strain amount in the state after the skin pass rolling described in Embodiment 1 and is in a state of having a characteristic in the strain amount in each crystal orientation.

The regulation regarding strain in the present embodiment is different in the numerical value range compared with Formula (6) regarding the non-oriented electrical steel sheet after the skin pass rolling and satisfies Formula (13).

K₄₁₁/K_{tyl}≤1.010 (13)

When strain-induced boundary migration sufficiently progresses, a large part of strain in the steel sheet is in a released status, strain in each crystal orientation is made uniform, the fluctuation of strain becomes sufficiently small, and the ratio shown in Formula (13) becomes a value close to 1.

In order to obtain excellent magnetic characteristics in the present embodiment in consideration of such fluctuations, K₄₁₁/K_{tyl} is set to 1.010 or less. When the K₄₁₁/K_{tyl} is more than 1.010, since release of strain is not sufficient, particularly, reduction in the iron loss becomes insufficient. K₄₁₁/K_{tyl} is preferably 0.990 or less and more preferably 0.970 or less. Although the non-oriented electrical steel sheet according to the present embodiment is obtained by performing the first heat treatment on a steel sheet satisfying Formula (6), it is also conceivable that the value of Formula (13) may exceed 1.000 due to a measurement error or the like.

In the competition with the {411} orientated grains that should be preferentially grown, Formula (16) is preferably satisfied regarding a relationship with the orientated grains in which the Taylor factor becomes 2.8 or less.

K₄₁₁/Kₜᵣₐ≤1.010 (16)

In order for the {411} orientated grains to preferentially grow, K₄₁₁/Kₜᵣₐ is preferably set to less than 1.010. When K₄₁₁/Kₜᵣₐ is 1.010 or more, release of strain is not sufficient, and, in particular, reduction in the iron loss becomes insufficient. The first heat treatment is performed on the non-oriented electrical steel sheet satisfying Formula (7), whereby a non-oriented electrical steel sheet satisfying Formula (16) is obtained.

In Embodiment 1, it has been described that the relationship with strain in the {110} orientated grains is preferably taken into account. On the other hand, the present embodiment is a status where strain-induced boundary migration has sufficiently progressed and a large part of strain in the steel sheet has been released. Therefore, the value of K₁₁₀ corresponding to strain that is accumulated in the {110} orientated grains becomes a value at which strain has been released to approximately the same extent as K₄₁₁, and, similar to Formula (9), Formula (19) is preferably satisfied.

K₄₁₁/K₁₁₀<1.010 (19)

That is, similar to Formula (9), K₄₁₁/K₁₁₀is preferably less than 1.010. When this K₄₁₁/K₁₁₀is 1.010 or more, there are cases where release of strain is not sufficient and, in particular, reduction in the iron loss becomes insufficient. In addition, the first heat treatment is performed on the non-oriented electrical steel sheet satisfying Formula (9), whereby a non-oriented electrical steel sheet satisfying Formula (19) is obtained.

In Formula (13) and Formula (19), in a case where there are no crystal grains having an orientation corresponding to the denominator, evaluation by a numerical value is not performed on the formula, and the formula is regarded as being satisfied.

Next, a regulation regarding grain sizes that should be satisfied in the present embodiment will be described. In a metallographic structure in a status where strain-induced boundary migration has sufficiently progressed and a large part of strain has been released, grain sizes in each crystal orientation have a significant influence on the magnetic characteristics. Crystal grains in an orientation in which the crystal grains are preferentially grown by strain-induced boundary migration become coarse, and crystal grains in an orientation that is encroached by this become fine. In the present embodiment, the relationships between average grain sizes are set to satisfy Formula (14) and Formula (15).

d₄₁₁/dₐᵥₑ>1.00 (14)

d₄₁₁/d_{tyl}>1.00 (15)

These formulas indicate that the average grain size dan of the {411}orientated grains, which are preferentially grown orientation, is relatively large. These ratios in Formula (14) and Formula (15) are preferably 1.30 or more, more preferably 1.50 or more, and still more preferably 2.00 or more. The upper limits of these ratios are not particularly limited. Although the growth rate of the crystal grains in the orientation to be encroached is slow compared with that of the {411} orientated grains, the grains grow during the first heat treatment, and thus the ratios are less likely to become excessively large, and a practical upper limit is approximately 10.00.

In addition, in the present embodiment, Formula (17) is preferably satisfied.

d₄₁₁/dₜᵣₐ>1.00 (17)

This formula indicates that the average grain size d₄₁₁ of the {411} orientated grains, which are preferentially grown orientation, is relatively large. This ratio in Formula (17) is more preferably 1.30 or more, still more preferably 1.50 or more, and particularly preferably 2.00 or more. The upper limit of this ratio is not particularly limited. Although the growth rate of the crystal grains in the orientation to be encroached is slow compared with that of the {411} orientated grains, the grains grow during the first heat treatment, and thus the ratios are less likely to become excessively large, and a practical upper limit is approximately 10.00.

In addition, the range of the average grain size is not particularly limited; however, when the average grain size becomes too coarse, it also becomes difficult to avoid deterioration of the magnetic characteristics. Therefore, the practical average grain size of the {411} orientated grains, which are relatively coarse grains in the present embodiment, is preferably set to 500 μm or less. The average grain size of the {411} orientated grains is more preferably 400 μm or less, still more preferably 300 μm or less, and particularly preferably 200 μm or less. On the other hand, regarding the lower limit of the average grain size of the {411} orientated grains, with an assumption of a state where sufficient preferential growth of the 44111 orientation is secured, the average grain size of the {411} orientated grains is preferably 40 μm or more, more preferably 60 μm or more, and still more preferably 80 μm or more.

In Formula (15), in a case where there are no crystal grains having an orientation corresponding to the denominator, evaluation by a numerical value is not performed on the formula, and the formula is regarded as being satisfied.

### Embodiment 3

In Embodiments 1 and 2, characteristics of a steel sheet have been regulated by specifying the strain in the steel sheet with the KAM value. In contrast, in the present embodiment, a steel sheet obtained by annealing the steel sheet according to Embodiment 1 or 2 for a sufficiently long time and, furthermore, growing grains will be regulated. Since strain-induced boundary migration is almost completed, and, as a result, strain is almost completely released, such a steel sheet becomes extremely preferable in terms of characteristics. That is, a steel sheet in which the {411} orientated grains are grown by strain-induced boundary migration and further normally grown by the second heat treatment until strain is almost completely released becomes a steel sheet in which accumulation in the {411} orientation is stronger. In the present embodiment, the crystal orientations and grain sizes of a steel sheet obtained by performing the second heat treatment using the steel sheet according to Embodiment 1 or 2 as a material (that is, a non-oriented electrical steel sheet obtained by performing the first heat treatment and then performing the second heat treatment on the non-oriented electrical steel sheet after skin pass rolling or a non-oriented electrical steel sheet obtained by performing the second heat treatment without the first heat treatment after skin pass rolling) will be described.

The crystal orientations of the steel sheet that is obtained by performing the second heat treatment satisfy Formulas (20) to (22). These regulations are different in the numerical value range compared with Formulas (3) to (5) relating to the above-described non-oriented electrical steel sheet after skin pass rolling and Formulas (10) to (12) relating to the non-oriented electrical steel sheet after strain-induced boundary migration by the first heat treatment. This is because, along with strain-induced boundary migration and the subsequent second heat treatment, the {411} orientated grains further grow, the area thereof increases, the orientated grains in which the Taylor factor becomes more than 2.8 are mainly encroached by the {411} orientated grains, and the area thereof further decreases.

S_{tyl}/Sₜₒₜ<0.55 (20)

S₄₁₁/Sₜₒₜ>0.30 (21)

S₄₁₁/Sₜᵣₐ≥0.60 (22)

In the present embodiment, the area ratio S_{tyl}/Sₜₒₜ is set to less than 0.55. The total area S_{tyl} may be zero. The upper limit of the area ratio S_{tyl}/Sₜₒₜ is determined as one of the parameters indicating the degree of progress of the growth of the {411}orientated grains. When the area ratio S_{tyl}/Sₜₒₜ is 0.55 or more, it is indicated that the orientated grains in which the Taylor factor becomes more than 2.8 that should be encroached in the stage of strain-induced boundary migration are not sufficiently encroached. In this case, the magnetic characteristics do not sufficiently improve. The area ratio S_{tyl}/Sₜₒₜ is preferably 0.40 or less and more preferably 0.30 or less. Since the area ratio S_{tyl}/Sₜₒₜ is preferably as small as possible, the lower limit is not regulated and may be 0.00.

In addition, in the present embodiment, the area ratio S₄₁₁/Sₜₒₜ is set to more than 0.30. When the area ratio S₄₁₁/Sₜₒₜ is 0.30 or less, the magnetic characteristics do not sufficiently improve. The area ratio S₄₁₁/Sₜₒₜ is preferably 0.40 or more and more preferably 0.50 or more. A status where the area ratio S₄₁₁/Sₜₒₜ is 1.00 is a status where all crystal structures are the {411} orientated grains and no other orientated grains are present, and the present embodiment also covers this status.

Similar to Embodiments 1 and 2, a relationship between orientated grains that are considered to have competed with the {411} orientated grains in strain-induced boundary migration and the {411} orientated grains is also important. In a case where the area ratio S₄₁₁/Sₜᵣₐ is sufficiently large, even in a status of normal grain growth after strain-induced boundary migration, the superiority of the growth of the {411} orientated grains is secured, and the magnetic characteristics become favorable. When this area ratio S₄₁₁/Sₜᵣₐ is less than 0.60, the {411} orientated grains are not sufficiently developed by strain-induced boundary migration, the orientated grains having a small Taylor factor other than the {411} orientated grains have grown to a considerable extent in the status of normal grain growth after strain-induced boundary migration, and the in-plane anisotropy of the magnetic characteristics also become large. Therefore, in the present embodiment, the area ratio S₄₁₁/Sa is set to 0.60 or more. The area ratio S₄₁₁/Sₜᵣₐ is preferably 0.70 or more and more preferably 0.80 or more. On the other hand, the upper limit of the area ratio S₄₁₁/Sₜᵣₐ does not need to be particularly limited, and the orientated grains in which the Taylor factor becomes 2.8 or less may be all the {411} orientated grains.

In a metallographic structure in a status where strain-induced boundary migration and subsequent normal grain growth have sufficiently progressed and almost all strain in a steel sheet has been released as well, grain sizes in each crystal orientation have a significant influence on the magnetic characteristics. The {411}orientated grains that have preferentially grown at the time of strain-induced boundary migration become coarse crystal grains even after normal grain growth. In the present embodiment, the relationships between average grain sizes are set to satisfy Formula (23) and Formula (24).

d₄₁₁/dₐᵥₑ≥0.95 (23)

d₄₁₁/d_{tyl}≥0.95 (24)

These formulas indicate that the average grain size d₄₁₁ of the {411}orientated grains is 0.95 times or more the average grain size of other grains. These ratios in Formula (23) and Formula (24) are preferably 1.00 or more, more preferably 1.10 or more, and still more preferably 1.20 or more. The upper limits of these ratios are not particularly limited. Although crystal grains other than the {411} orientated grains also grow during normal grain growth, at the time when normal grain growth begins, that is, at a time when strain-induced boundary migration ends, the {411}orientated grains are coarse and have a so-called size advantage. Since the coarsening of the {411} orientated grain even in the normal grain growth process is advantageous, the above-described ratios hold sufficiently characteristic ranges. Therefore, the practical upper limits are approximately 10.00. When any of these ratios exceeds 10.00, grains become duplex grains, and a problem in association with processing such as punching occurs in some cases.

Furthermore, it is preferable that the Formula (25) is also satisfied in relation to the average grain size.

d₄₁₁/dₜᵣₐ≥0.95 (25)

This formula indicates that the average grain size d₄₁₁ of the {411} orientated grains, which are preferentially grown orientation, is relatively large. This ratio in Formula (25) is more preferably 1.00 or more, still more preferably 1.10 or more, and particularly preferably 1.20 or more. The upper limit of this ratio is not particularly limited. Although crystal grains other than the {411} orientated grains also grow during normal grain growth, at the time when normal grain growth begins, that is, at a time when strain-induced boundary migration ends, the {411} orientated grains are coarse and have a so-called size advantage. Since the coarsening of the {411}orientated grain even in the normal grain growth process is advantageous, the above-described ratios hold sufficiently characteristic ranges. Therefore, the practical upper limits are approximately 10.00. When any of these ratios exceeds 10.0, grains become duplex grains, and a problem in association with processing such as punching occurs in some cases.

In addition, the range of the average grain size is not particularly limited; however, when the average grain size becomes too coarse, it also becomes difficult to avoid deterioration of the magnetic characteristics. Therefore, similar to Embodiment 2, the practical average grain size of the {411} orientated grains, which are relatively coarse grains in the present embodiment, is preferably set to 500 μm or less. The average grain size of the {411} orientated grains is more preferably 400 μm or less, still more preferably 300 μm or less, and particularly preferably 200 μm or less. On the other hand, regarding the lower limit of the average grain size of the 14111 orientated grains, with an assumption of a state where sufficient preferential growth of the {411} orientation is secured, the average grain size of the {411} orientated grains is preferably 40 μm or more, more preferably 60 μm or more, and still more preferably 80 μm or more.

In Formula (24), in a case where there are no crystal grains having an orientation corresponding to the denominator, evaluation by a numerical value is not performed on the formula, and the formula is regarded as being satisfied.

[Characteristics]

In the non-oriented electrical steel sheet according to the present embodiment, since the chemical composition and the metallographic structure are controlled as described above, excellent magnetic characteristics (low iron loss) can be obtained not only on the average of the rolling direction and the width direction but on a whole direction average (the average of the rolling direction, the width direction, a direction at 45 degrees with respect to the rolling direction, and a direction at 135 degrees with respect to the rolling direction).

The rolling direction and the width direction mentioned herein are the rolling direction and width direction of a non-oriented electrical steel sheet to be obtained.

Magnetic measurement may be performed by a measuring method described in JIS C 2550-1 (2011) and JIS C 2550-3 (2019) or may be performed by a measuring method described in JIS C 2556 (2015). In addition, in a case where the sample is fine and the measurement described in the above-described JIS is not possible, electromagnetic circuits may be measured using a device capable of measuring a 55 mm×55 mm test piece according to JIS C 2556 (2015) or a finer test piece.

Next, a method for manufacturing the non-oriented electrical steel sheet according to the present embodiment will be described. In the present embodiment, a grain-oriented electrical steel sheet is used as a material, and a cold rolling step in the width direction, an intermediate annealing step, and a skin pass rolling step are performed.

First, as a material to be subjected to cold rolling, a grain-oriented electrical steel sheet having the above-described chemical composition is used. As the grain-oriented electrical steel sheet, a grain-oriented electrical steel sheet manufactured by a well-known method may be used as long as the steel sheet has the above-described chemical composition. That is, the grain-oriented electrical steel sheet may be a grain-oriented electrical steel sheet manufactured by a well-known method (for example, a grain-oriented electrical steel sheet satisfying JIS C 2553 (2019) or an original standard product of each steelmaking company). The grain-oriented electrical steel sheet is manufactured through a slab heating step, a hot rolling step, a cold rolling step, a decarburization annealing step, a nitriding treatment, a final annealing step, and the like. The sheet thickness of the grain-oriented electrical steel sheet to be subjected to cold rolling in the width direction is preferably 0.27 to 0.35 mm. In addition, instead of the grain-oriented electrical steel sheet, a material obtained by cutting Goss orientated grains into a sheet shape from a single crystal formed using a material having the above-described chemical composition may also be used.

In the cold rolling step, cold rolling is performed on the above-described grain-oriented electrical steel sheet in the width direction of the grain-oriented electrical steel sheet at a rolling reduction (cumulative rolling reduction) of 20% to 50% (cold rolling step). When the rolling reduction in the width direction is smaller than 20%, crystal rotation rarely occurs, and an orientation that becomes nucleus of {411} recrystallized grains is not formed. In addition, when the rolling reduction exceeds 50%, deformation of the steel sheet becomes too large, and the nuclei of the {411} recrystallized grains alter into the nuclei of {111} recrystallized grains. The rolling reduction in the width direction in the cold rolling is preferably 30% to 40%. The grain-oriented electrical steel sheet mainly includes {110}<001> orientated grains, and the width direction thereof becomes a {110}<110> orientation. When the {110}<110> orientation is rolled and recrystallized, there are cases where a {411} orientation is generated, and, in the present embodiment, that mechanism is used. The width direction of the grain-oriented electrical steel sheet is a direction at 90 degrees with respect to a rolling mark and is determined by the rolling mark. In the case of being cut out from a single crystal, rolling is performed in the same manner as described above in a direction parallel to a <110> direction, and then the crystal grains are recrystallized.

When the cold rolling ends, subsequently, intermediate annealing is performed (intermediate annealing step). In the present embodiment, for example, the intermediate annealing is performed at a temperature of 650° C. or higher. When the temperature of the intermediate annealing is lower than 650° C., recrystallization does not occur, the {411} orientated grains are not sufficiently grown, and there are cases where the magnetic flux density does not become high and an iron loss improvement effect cannot be sufficiently obtained. Therefore, the temperature of the intermediate annealing is set to 650° C. or higher. The upper limit of the intermediate annealing temperature is not limited; however, when the temperature of the intermediate annealing is higher than 900° C., the crystal grains become too large and are less likely to grow during the subsequent skin pass rolling and strain-induced boundary migration, and it becomes difficult to grow the {411} orientated grains. Therefore, the temperature in the intermediate annealing is preferably set to 650° C. to 9000C.

In addition, the annealing time (holding time) is preferably set to 1 second to 60 seconds. When the annealing time is shorter than 1 second, since the time for causing recrystallization is too short, there is a possibility that the {411} orientated grains may not sufficiently grow. In addition, when the annealing time exceeds 60 seconds, the cost is unnecessarily taken, which is not desirable.

When the intermediate annealing ends, next, skin pass rolling is performed (skin pass rolling step). When rolling is performed in a state where the number of the {411} orientated grains is large as described above, the {411} orientated grains further grow. It is preferable that the skin pass rolling is performed in the same direction as in the cold rolling (the width direction of the grain-oriented electrical steel sheet) and the rolling reduction in the skin pass rolling at that time is set to 5% to 30%. This is because, when the rolling reduction is smaller than 5%, it is not possible to eliminate an unevenness in sheet thickness caused by the cold rolling in the width direction. In addition, when the rolling reduction exceeds 30%, the {411} orientated grains do not grow, and the {111} orientated grains having poor magnetic characteristics grow.

Subsequently, a first heat treatment for promoting strain-induced boundary migration is performed (first heat treatment step). The first heat treatment is preferably performed at 700° C. to 950° C. for 1 second to 100 seconds.

When the heat treatment temperature is lower than 700° C., strain-induced boundary migration does not occur. In addition, at higher than 950° C., not only strain-induced boundary migration but also normal grain growth occurs, and it becomes impossible to obtain the metallographic structure described in Embodiment 2.

In addition, when the heat treatment time (holding time) is longer than 100 seconds, the production efficiency significantly decreases, which is not realistic. Since it is not industrially easy to set the holding time to shorter than 1 second, the holding time is set to 1 second or longer.

The first heat treatment step may be skipped. That is, after the skin pass rolling step, the second heat treatment to be described below may be performed without the first heat treatment.

A second heat treatment is performed on the non-oriented electrical steel sheet after the skin pass rolling step or after the first heat treatment step (second heat treatment step). The second heat treatment step is preferably performed for 1 second to 100 seconds within a temperature range of 950° C. to 1050° C. or performed for longer than 1000 seconds within a temperature range of 700° C. to 900° C.

When the heat treatment is performed within the above-described temperature range for the above-described time, in a case where the first heat treatment has been skipped, normal grain growth occurs after strain-induced boundary migration, and, in a case where the first heat treatment has been performed, normal grain growth occurs. In addition, depending on the conditions of the first heat treatment, there are also cases where strain-induced boundary migration is caused by the subsequent second heat treatment.

The non-oriented electrical steel sheet according to the present embodiment can be manufactured as described above. However, this manufacturing method is an example of the method for manufacturing the non-oriented electrical steel sheet of the present embodiment and does not limit manufacturing methods.

### EXAMPLES

Next, the non-oriented electrical steel sheet of the present invention will be specifically described while describing examples. The examples to be described below are simply examples of the non-oriented electrical steel sheet of the present invention, and the non-oriented electrical steel sheet of the present invention is not limited to the following examples.

### First Example

Materials (base metals) having the chemical compositions shown in Table 1A and Table 1C were produced and used as test materials. (Nos. 116 and 151 were non-oriented electrical steel sheets. Nos. 117 to 150 were materials obtained by cutting out Goss orientated grains from a single crystal into a sheet shape. Others were grain-oriented electrical steel sheets.) Here, the column “Left side of Formula (1)” indicates the values of the left side of Formula (1) described above. After that, cold rolling was performed in the width direction of the materials (in the case of being cut out from a single crystal, a direction parallel to a <110> direction) to obtain cold-rolled sheets. The produced grain-oriented electrical steel sheets were cold-rolled in the width direction after insulating films were removed. The rolling reductions in the cold rolling at that time are shown in Table 1B and Table 1D.

Intermediate annealing was performed on the cold-rolled sheets in a non-oxidizing atmosphere at temperatures shown in Table 1B and Table 1D for 30 seconds, and then the second round of cold rolling (skin pass rolling) was performed at rolling reductions shown in Table 1B and Table 1D. This skin pass rolling was performed in the same direction as in the cold rolling.

Next, in order to investigate the texture, a part of each of the steel sheets was cut, the cut test piece was processed to reduce the thickness to ½, and EBSD observation (step intervals: 100 nm) was performed on the processed surface (surface parallel to the steel sheet surface) in the above-described manner. The areas and average KAM values of the orientated grains of kinds shown in Table 2A and Table 2B were obtained by EBSD observation.

In addition, as a second heat treatment, annealing was performed on the steel sheets at 800° C. for 2 hours. From each of the steel sheets after the second heat treatment, 55 mm×55 mm sample pieces were collected as measurement samples. At this time, a sample in which one side of the sample piece was parallel to a rolling direction and a sample in which one side was inclined at 45 degrees with respect to the rolling direction were collected. In addition, the samples were collected using a shearing machine. Additionally, as magnetic characteristics, the iron losses W10/400 (the average value of energy losses generated in the rolling direction and in the width direction in the test piece during excitation at a maximum magnetic flux density of 1.0 T and a frequency of 400 Hz) and W10/400 (whole direction) (the average value of energy losses generated in the rolling direction, in the width direction, in a direction at 45 degrees with respect to the rolling direction, and in a direction at 135 degrees with respect to the rolling direction in the test piece during excitation at a maximum magnetic flux density of 1.0 T and a frequency of 400 Hz) were measured according to JIS C 2556 (2015). The measurement results are shown in Table 2A and Table 2B.

TABLE 1A

| | | | | | | | | | | | | | | | | | Left |
|---|---|---|---|---|---|---|---|---|---|---|---|---|---|---|---|---|---|
| | | | | | | | | | | | | | | | | | side of |
| | Chemical composition (mass %, remainder is Fe and impurities) | | | | | | | | | | | | | | | | Formula |
| No. | C | Si | sol. Al | S | N | Mn | Ni | Co | Pt | Pb | Cu | Au | Cr | Mg | B | O | (1) |
| 101 | 0.0006 | 3.19 | 0.0013 | 0.0003 | 0.0003 | 0.01 | — | — | — | — | — | — | 0.003 | — | — | — | −3.18 |
| 102 | 0.0005 | 3.21 | 0.0015 | 0.0003 | 0.0002 | — | 0.01 | — | — | — | — | — | 0.004 | — | — | — | −3.20 |
| 103 | 0.0007 | 3.17 | 0.0017 | 0.0001 | 0.0001 | — | — | 0.01 | — | — | — | — | 0.003 | — | — | — | −3.16 |
| 104 | 0.0005 | 3.16 | 0.0015 | 0.0002 | 0.0002 | — | — | — | 0.02 | — | — | — | 0.003 | — | — | — | −3.14 |
| 105 | 0.0005 | 3.21 | 0.0009 | 0.0003 | 0.0001 | — | — | — | — | 0.01 | — | — | 0.004 | — | — | — | −3.21 |
| 106 | 0.0004 | 3.19 | 0.0017 | 0.0002 | 0.0003 | — | — | — | — | — | 0.01 | — | 0.003 | — | — | — | −3.19 |
| 107 | 0.0006 | 3.19 | 0.0005 | 0.0002 | 0.0002 | — | — | — | — | — | — | 0.02 | 0.004 | — | — | — | −3.17 |
| 108 | 0.0006 | 3.24 | 0.0012 | 0.0002 | 0.0001 | 0.01 | — | — | — | — | — | — | 0.003 | — | — | — | −3.24 |
| 109 | 0.0007 | 3.21 | 0.0012 | 0.0003 | 0.0003 | 0.02 | — | — | — | — | — | — | 0.003 | — | — | — | −3.19 |
| 110 | 0.0007 | 3.16 | 0.0013 | 0.0002 | 0.0001 | 0.02 | — | — | — | — | — | — | 0.003 | — | — | — | −3.14 |
| 111 | 0.0004 | 3.19 | 0.0006 | 0.0002 | 0.0003 | 0.02 | — | — | — | — | — | — | 0.004 | — | — | — | −3.17 |
| 112 | 0.0005 | 3.23 | 0.0010 | 0.0003 | 0.0001 | 0.02 | — | — | — | — | — | — | 0.003 | — | — | — | −3.21 |
| 113 | 0.0006 | 3.24 | 0.0017 | 0.0002 | 0.0002 | 0.02 | — | — | — | — | — | — | 0.004 | — | — | — | −3.21 |
| 114 | 0.0005 | 3.20 | 0.0009 | 0.0002 | 0.0001 | 0.02 | — | — | — | — | — | — | 0.004 | — | — | — | −3.18 |
| 115 | 0.0006 | 3.18 | 0.0016 | 0.0002 | 0.0003 | 0.01 | — | — | — | — | — | — | 0.003 | — | — | — | −3.17 |
| 116 | 0.0005 | 2.01 | 0.0013 | 0.0018 | 0.0017 | 2.42 | — | — | — | — | — | — | 0.002 | — | — | — | 0.41 |
| 117 | 0.0084 | 3.22 | 0.6033 | 0.0018 | 0.0020 | 0.02 | — | — | — | — | — | — | 0.004 | — | — | — | −3.81 |
| 118 | 0.0009 | 1.60 | 0.6047 | 0.0016 | 0.0018 | 0.01 | — | — | — | — | — | — | 0.004 | — | — | — | −2.19 |
| 119 | 0.0008 | 3.90 | 0.6047 | 0.0016 | 0.0019 | 0.01 | — | — | — | — | — | — | 0.004 | — | — | — | −4.49 |
| 120 | 0.0010 | 3.23 | 2.7996 | 0.0019 | 0.0019 | 0.02 | — | — | — | — | — | — | 0.004 | — | — | — | −6.01 |
| 121 | 0.0008 | 3.23 | 0.6040 | 0.0004 | 0.0018 | 0.01 | — | — | — | — | — | — | 0.003 | — | — | — | −3.82 |
| 122 | 0.0009 | 3.23 | 0.6041 | 0.0094 | 0.0019 | 0.02 | — | — | — | — | — | — | 0.003 | — | — | — | −3.81 |
| 123 | 0.0010 | 3.22 | 0.6032 | 0.0017 | 0.0094 | 0.01 | — | — | — | — | — | — | 0.004 | — | — | — | −3.82 |
| 124 | 0.0008 | 3.20 | 0.0022 | 0.0005 | 0.0003 | 0.02 | — | — | — | — | — | — | 0.003 | — | — | — | −3.18 |
| 125 | 0.0005 | 3.18 | 0.0008 | 0.0003 | 00003 | 0.02 | — | — | — | — | — | — | 0.003 | — | — | — | −3.17 |

TABLE 1B

| | Sheet thickness (mm) | | | | Intermediate | |
|---|---|---|---|---|---|---|
| | | After | Rolling reduction (%) | | annealing | |
| | Before | skin | | Skin | Annealing | |
| | cold | pass | Cold | pass | temperature | |
| No. | rolling | rolling | rolling | rolling | (° C.) | Note |
| 101 | 0.30 | 0.15 | 42 | 14 | 800 | Invention Example |
| 102 | 0.30 | 0.15 | 42 | 14 | 800 | Invention Example |
| 103 | 0.30 | 0.15 | 42 | 14 | 800 | Invention Example |
| 104 | 0.30 | 0.15 | 42 | 14 | 800 | Invention Example |
| 105 | 0.30 | 0.15 | 42 | 14 | 800 | Invention Example |
| 106 | 0.30 | 0.15 | 42 | 14 | 800 | Invention Example |
| 107 | 0.30 | 0.15 | 42 | 14 | 800 | Invention Example |
| 108 | 0.30 | 0.15 | 42 | 14 | 800 | Invention Example |
| 109 | 0.32 | 0.15 | 42 | 18 | 800 | Invention Example |
| 110 | 0.29 | 0.15 | 42 | 10 | 800 | Invention Example |
| 111 | 0.43 | 0.15 | 60 | 14 | 800 | Comparative Example |
| 112 | 0.22 | 0.15 | 15 | 14 | 800 | Comparative Example |
| 113 | 0.27 | 0.15 | 42 | 3 | 800 | Comparative Example |
| 114 | 0.40 | 0.15 | 42 | 35 | 800 | Comparative Example |
| 115 | 0.30 | 0.15 | 42 | 14 | 550 | Comparative Example |
| 116 | 0.30 | 0.15 | 42 | 14 | 800 | Comparative Example |
| 117 | 0.30 | 0.15 | 42 | 14 | 800 | Invention Example |
| 118 | 0.30 | 0.15 | 42 | 14 | 800 | Invention Example |
| 119 | 0.30 | 0.15 | 42 | 14 | 800 | Invention Example |
| 120 | 0.30 | 0.15 | 42 | 14 | 800 | Invention Example |
| 121 | 0.30 | 0.15 | 42 | 14 | 800 | Invention Example |
| 122 | 0.30 | 0.15 | 42 | 14 | 800 | Invention Example |
| 123 | 0.30 | 0.15 | 42 | 14 | 800 | Invention Example |
| 124 | 0.30 | 0.15 | 20 | 14 | 800 | Invention Example |
| 125 | 0.30 | 0.15 | 30 | 14 | 800 | Invention Example |

TABLE 1C

| | | | | | | | | | | | | | | | | | Left |
|---|---|---|---|---|---|---|---|---|---|---|---|---|---|---|---|---|---|
| | | | | | | | | | | | | | | | | | side of |
| | Chemical composition (mass %, remainder is Fe and impurities) | | | | | | | | | | | | | | | | Formula |
| No. | C | Si | sol. Al | S | N | Mn | Ni | Co | Pt | Pb | Cu | Au | Cr | Mg | B | O | (1) |
| 126 | 0.0008 | 3.19 | 0.0015 | 0.0004 | 0.0004 | 0.01 | — | — | — | — | — | — | 0.003 | — | — | — | −3.19 |
| 127 | 0.0007 | 3.19 | 0.0007 | 0.0003 | 0.0002 | 0.01 | — | — | — | — | — | — | 0.003 | — | — | — | −3.18 |
| 128 | 0.0005 | 3.19 | 0.0007 | 0.0003 | 0.0001 | 0.02 | — | — | — | — | — | — | 0.004 | — | — | — | −3.17 |
| 129 | 0.0007 | 3.18 | 0.0006 | 0.0004 | 0.0002 | 0.01 | — | — | — | — | — | — | 0.002 | — | — | — | −3.17 |
| 130 | 0.0010 | 3.22 | 0.6039 | 0.0016 | 0.0018 | 0.01 | — | — | — | — | — | — | 0.004 | 0.0005 | — | — | −3.81 |
| 131 | 0.0010 | 3.23 | 0.6034 | 0.0019 | 0.0020 | 0.01 | — | — | — | — | — | — | 0.002 | 0.0091 | — | — | −3.81 |
| 132 | 0.0011 | 3.22 | 0.6030 | 0.0019 | 0.0018 | 0.01 | — | — | — | — | — | — | — | — | — | — | −3.81 |
| 133 | 0.0008 | 3.22 | 0.6040 | 0.0015 | 0.0020 | 0.01 | — | — | — | — | — | — | 0.092 | — | — | — | −3.81 |
| 134 | 0.0009 | 3.22 | 2.8001 | 0.0018 | 0.0021 | 2.40 | — | — | — | — | — | — | 0.004 | — | — | — | −3.62 |
| 135 | 0.0009 | 3.21 | 0.6041 | 0.0021 | 0.0021 | 0.22 | — | — | — | — | — | — | 0.004 | — | 0.0002 | — | −3.61 |
| 136 | 0.0009 | 3.22 | 0.6035 | 0.0018 | 0.0020 | 0.22 | — | — | — | — | — | — | 0.004 | — | 0.0044 | — | −3.61 |
| 137 | 0.0008 | 3.21 | 0.6048 | 0.0018 | 0.0019 | 0.21 | — | — | — | — | — | — | 0.004 | — | — | 0.0013 | −3.61 |
| 138 | 0.0009 | 3.23 | 0.6044 | 0.0019 | 0.0018 | 0.22 | — | — | — | — | — | — | 0.003 | — | — | 0.0173 | −3.61 |
| 139 | 0.0122 | 3.23 | 0.6035 | 0.0020 | 0.0019 | 0.21 | — | — | — | — | — | — | 0.003 | — | — | — | −3.61 |
| 140 | 0.0008 | 1.39 | 0.6037 | 0.0019 | 0.0019 | 0.21 | — | — | — | — | — | — | 0.004 | — | — | — | −1.79 |
| 141 | 0.0009 | 4.20 | 0.6033 | 0.0018 | 0.0020 | 0.22 | — | — | — | — | — | — | 0.003 | — | — | — | −4.59 |
| 142 | 0.0010 | 3.21 | 4.2026 | 0.0016 | 0.0019 | 0.22 | — | — | — | — | — | — | 0.003 | — | — | — | −6.20 |
| 143 | 0.0011 | 3.21 | 0.6048 | 0.0451 | 0.0019 | 0.21 | — | — | — | — | — | — | 0.002 | — | — | — | −3.61 |
| 144 | 0.0011 | 3.22 | 0.6030 | 0.0018 | 0.0119 | 0.21 | — | — | — | — | — | — | 0.004 | — | — | — | −3.61 |
| 145 | 0.0008 | 3.21 | 0.6040 | 0.0019 | 0.0021 | 0.21 | — | — | — | — | — | — | 0.003 | 0.0120 | — | — | −3.61 |
| 146 | 0.0009 | 3.21 | 0.6048 | 0.0020 | 0.0021 | 0.22 | — | — | — | — | — | — | 0.120 | — | — | — | −3.61 |
| 147 | 0.0009 | 3.21 | 0.6031 | 0.0016 | 0.0019 | 2.60 | — | — | — | — | — | — | 0.003 | — | — | — | −1.22 |
| 148 | 0.0008 | 3.19 | 0.0018 | 0.0006 | 0.0004 | 0.02 | — | — | — | — | — | — | 0.003 | — | — | — | −3.18 |
| 149 | 0.0008 | 3.20 | 0.0018 | 0.0003 | 0.0001 | 0.01 | — | — | — | — | — | — | 0.004 | — | — | — | −3.18 |
| 150 | 0.0006 | 3.19 | 0.0012 | 0.0003 | 0.0001 | 0.01 | — | — | — | — | — | — | 0.004 | — | — | — | −3.18 |
| 151 | 0.0006 | 3.19 | 0.0013 | 0.0003 | 0.0003 | 0.01 | — | — | — | — | — | — | 0.003 | — | — | — | −3.18 |

TABLE 1D

| | Sheet thickness (mm) | | | | Intermediate | |
|---|---|---|---|---|---|---|
| | | After | Rolling reduction (%) | | annealing | |
| | Before | skin | | Skin | Annealing | |
| | cold | pass | Cold | pass | temperature | |
| No. | rolling | rolling | rolling | rolling | (° C.) | Note |
| 126 | 0.30 | 0.15 | 50 | 14 | 800 | Invention Example |
| 127 | 0.30 | 0.15 | 42 | 6 | 800 | Invention Example |
| 128 | 0.30 | 0.15 | 42 | 25 | 800 | Invention Example |
| 129 | 0.30 | 0.15 | 42 | 14 | 650 | Invention Example |
| 130 | 0.3 | 0.15 | 42 | 14 | 800 | Invention Example |
| 131 | 0.3 | 0.15 | 42 | 14 | 800 | Invention Example |
| 132 | 0.3 | 0.15 | 42 | 14 | 800 | Invention Example |
| 133 | 0.3 | 0.15 | 42 | 14 | 800 | Invention Example |
| 134 | 0.3 | 0.15 | 42 | 14 | 800 | Invention Example |
| 135 | 0.3 | 0.15 | 42 | 14 | 800 | Invention Example |
| 136 | 0.3 | 0.15 | 42 | 14 | 800 | Invention Example |
| 137 | 0.3 | 0.15 | 42 | 14 | 800 | Invention Example |
| 138 | 0.3 | 0.15 | 42 | 14 | 800 | Invention Example |
| 139 | 0.3 | 0.15 | 42 | 14 | 800 | Comparative Example |
| 140 | 0.3 | 0.15 | 42 | 14 | 800 | Comparative Example |
| 141 | 0.3 | 0.15 | 42 | Cracking occurs during cold rolling | | Comparative Example |
| 142 | 0.3 | 0.15 | 42 | Cracking occurs during cold rolling | | Comparative Example |
| 143 | 0.3 | 0.15 | 42 | 14 | 800 | Comparative Example |
| 144 | 0.3 | 0.15 | 42 | 14 | 800 | Comparative Example |
| 145 | 0.3 | 0.15 | 42 | 14 | 800 | Comparative Example |
| 146 | 0.3 | 0.15 | 42 | 14 | 800 | Comparative Example |
| 147 | 0.3 | 0.15 | 42 | Cracking occurs during cold rolling | | Comparative Example |
| 148 | 0.3 | 0.15 | 42 | 14 | 700 | Invention Example |
| 149 | 0.3 | 0.15 | 42 | 14 | 750 | Invention Example |
| 150 | 0.29 | 0.15 | 42 | 10 | 700 | Invention Example |
| 151 | 0.30 | 0.15 | 42 | 14 | 800 | Comparative Example |

TABLE 2A

| | | | | | | | | | | | | After second heat | | |
|---|---|---|---|---|---|---|---|---|---|---|---|---|---|---|
| | | | | | | | | | | | | treatment | | |
| | | | | | | | | | | | | | W10/W400 | |
| | | | | | | | | | | | | | (whole | |
| | | | | | | | | | | | | | direction | |
| | EBSD observation result after skin pass rolling | | | | | | | | | | | W10/400 | average) | |
| No. | [symbol] | [symbol] | [symbol] | [symbol] | [symbol] | [symbol] | [symbol] | [symbol] | [symbol] | [symbol] | [symbol] | (W/kg) | (W/kg) | Note |
| 101 | 0.371 | 0.365 | 0.363 | 0.365 | 0.72 | 0.16 | 0.73 | 0.980 | 0.994 | 5.57 | 0.994 | 9.6 | 9.8 | Invention |
| | | | | | | | | | | | | | | Example |
| 102 | 0.371 | 0.363 | 0.363 | 0.366 | 0.73 | 0.15 | 0.71 | 0.979 | 0.999 | 5.59 | 0.992 | 9.7 | 9.9 | Invention |
| | | | | | | | | | | | | | | Example |
| 103 | 0.370 | 0.364 | 0.362 | 0.363 | 0.72 | 0.14 | 0.73 | 0.979 | 0.995 | 5.58 | 0.996 | 9.7 | 9.9 | Invention |
| | | | | | | | | | | | | | | Example |
| 104 | 0.370 | 0.364 | 0.364 | 0.363 | 0.72 | 0.15 | 0.73 | 0.984 | 1.000 | 5.59 | 1.002 | 9.7 | 9.9 | Invention |
| | | | | | | | | | | | | | | Example |
| 105 | 0.370 | 0.365 | 0.362 | 0.364 | 0.73 | 0.15 | 0.72 | 0.978 | 0.991 | 5.57 | 0.996 | 9.7 | 9.9 | Invention |
| | | | | | | | | | | | | | | Example |
| 106 | 0.371 | 0.363 | 0.364 | 0.365 | 0.73 | 0.16 | 0.71 | 0.982 | 1.003 | 5.57 | 0.997 | 9.7 | 9.9 | Invention |
| | | | | | | | | | | | | | | Example |
| 107 | 0.371 | 0.364 | 0.363 | 0.364 | 0.71 | 0.13 | 0.73 | 0.980 | 0.999 | 5.60 | 0.999 | 9.5 | 9.7 | Invention |
| | | | | | | | | | | | | | | Example |
| 108 | 0.371 | 0.365 | 0.363 | 0.365 | 0.72 | 0.14 | 0.73 | 0.980 | 0.995 | 5.57 | 0.996 | 9.7 | 9.9 | Invention |
| | | | | | | | | | | | | | | Example |
| 109 | 0.390 | 0.381 | 0.382 | 0.384 | 0.71 | 0.14 | 0.71 | 0.979 | 1.002 | 6.57 | 0.994 | 9.7 | 9.9 | Invention |
| | | | | | | | | | | | | | | Example |
| 110 | 0.360 | 0.353 | 0.354 | 0.354 | 0.72 | 0.16 | 0.72 | 0.983 | 1.004 | 7.58 | 1.000 | 9.6 | 9.8 | Invention |
| | | | | | | | | | | | | | | Example |
| 111 | 0.371 | 0.365 | 0.363 | 0.365 | 0.72 | 0.03 | 0.72 | 0.978 | 0.995 | 5.58 | 0.994 | 11.3 | 11.7 | Comparative |
| | | | | | | | | | | | | | | Example |
| 112 | 0.370 | 0.365 | 0.362 | 0.365 | 0.73 | 0.15 | 0.33 | 0.980 | 0.994 | 0.11 | 0.992 | 11.1 | 11.5 | Comparative |
| | | | | | | | | | | | | | | Example |
| 113 | 0.365 | 0.365 | 0.367 | 0.366 | 0.73 | 0.16 | 0.54 | 1.005 | 1.007 | 0.20 | 1.003 | 11.4 | 11.8 | Comparative |
| | | | | | | | | | | | | | | Example |
| 114 | 0.370 | 0.373 | 0.373 | 0.373 | 0.81 | 0.16 | 0.73 | 1.006 | 0.999 | 5.61 | 0.998 | 11.3 | 11.7 | Comparative |
| | | | | | | | | | | | | | | Example |
| 115 | 0.371 | 0.365 | 0.363 | 0.366 | 0.15 | 0.06 | 0.21 | 0.980 | 0.996 | 0.23 | 0.992 | 11.3 | 11.7 | Comparative |
| | | | | | | | | | | | | | | Example |
| 116 | 0.370 | 0.365 | 0.363 | 0.365 | 0.89 | 0.03 | 0.71 | 0.980 | 0.995 | 1.54 | 0.992 | 14.3 | 14.7 | Comparative |
| | | | | | | | | | | | | | | Example |
| 117 | 0.372 | 0.365 | 0.362 | 0.366 | 0.71 | 0.16 | 0.73 | 0.974 | 0.993 | 5.58 | 0.989 | 9.9 | 10.1 | Invention |
| | | | | | | | | | | | | | | Example |
| 118 | 0.371 | 0.367 | 0.365 | 0.364 | 0.71 | 0.16 | 0.73 | 0.983 | 0.996 | 5.58 | 1.003 | 9.9 | 10.0 | Invention |
| | | | | | | | | | | | | | | Example |
| 119 | 0.371 | 0.367 | 0.361 | 0.364 | 0.72 | 0.16 | 0.74 | 0.974 | 0.984 | 5.58 | 0.993 | 9.4 | 9.4 | Invention |
| | | | | | | | | | | | | | | Example |
| 120 | 0.369 | 0.366 | 0.362 | 0.367 | 0.72 | 0.15 | 0.72 | 0.979 | 0.988 | 5.58 | 0.985 | 9.3 | 9.5 | Invention |
| | | | | | | | | | | | | | | Example |
| 121 | 0.369 | 0.366 | 0.363 | 0.365 | 0.72 | 0.15 | 0.74 | 0.983 | 0.990 | 5.58 | 0.993 | 9.5 | 9.8 | Invention |
| | | | | | | | | | | | | | | Example |
| 122 | 0.373 | 0.364 | 0.365 | 0.367 | 0.71 | 0.16 | 0.72 | 0.980 | 1.003 | 5.57 | 0.995 | 9.9 | 10.1 | Invention |
| | | | | | | | | | | | | | | Example |
| 123 | 0.370 | 0.366 | 0.362 | 0.367 | 0.73 | 0.16 | 0.74 | 0.980 | 0.991 | 5.58 | 0.989 | 9.9 | 10.0 | Invention |
| | | | | | | | | | | | | | | Example |
| 124 | 0.371 | 0.364 | 0.363 | 0.366 | 0.65 | 0.13 | 0.74 | 0.979 | 0.997 | 5.57 | 0.992 | 9.6 | 9.8 | Invention |
| | | | | | | | | | | | | | | Example |
| 125 | 0.371 | 0.365 | 0.365 | 0.366 | 0.68 | 0.15 | 0.72 | 0.982 | 0.999 | 5.57 | 0.996 | 9.5 | 9.8 | Invention |
| | | | | | | | | | | | | | | Example |

[symbol]

indicates data missing or illegible when filed

TABLE 2B

| | | | | | | | | | | | | After second heat | | |
|---|---|---|---|---|---|---|---|---|---|---|---|---|---|---|
| | | | | | | | | | | | | treatment | | |
| | | | | | | | | | | | | | W10/W400 | |
| | | | | | | | | | | | | | (whole | |
| | | | | | | | | | | | | | direction | |
| | EBSD observation result after skin pass rolling | | | | | | | | | | | W10/400 | average) | |
| No. | [symbol] | [symbol] | [symbol] | [symbol] | [symbol] | [symbol] | [symbol] | [symbol] | [symbol] | [symbol] | [symbol] | (W/kg) | (W/kg) | Note |
| 126 | 0.369 | 0.365 | 0.361 | 0.364 | 0.73 | 0.15 | 0.72 | 0.979 | 0.989 | 5.58 | 0.993 | 9.5 | 9.7 | Invention Example |
| 127 | 0.364 | 0.361 | 0.358 | 0.361 | 0.72 | 0.17 | 0.72 | 0.985 | 0.993 | 5.57 | 0.991 | 9.5 | 9.7 | Invention Example |
| 128 | 0.374 | 0.372 | 0.370 | 0.369 | 0.72 | 0.16 | 0.72 | 0.988 | 6.995 | 5.58 | 1.002 | 9.5 | 9.7 | Invention Example |
| 129 | 0.369 | 0.367 | 0.362 | 0.367 | 0.72 | 0.16 | 0.74 | 0.981 | 0.986 | 5.58 | 0.986 | 9.7 | 9.8 | Invention Example |
| 130 | 0.373 | 0.364 | 0.363 | 0.364 | 0.73 | 0.15 | 0.73 | 0.975 | 0.999 | 5.57 | 0.998 | 9.5 | 9.7 | Invention Example |
| 131 | 0.369 | 0.366 | 0.362 | 0.364 | 0.71 | 0.15 | 0.74 | 0.980 | 0.988 | 6.57 | 0.995 | 9.5 | 9.7 | Invention Example |
| 132 | 0.371 | 0.364 | 0.365 | 0.365 | 0.71 | 0.16 | 0.72 | 0.982 | 1.001 | 7.57 | 0.999 | 9.6 | 9.8 | Invention Example |
| 133 | 0.373 | 0.366 | 0.365 | 0.366 | 0.72 | 0.15 | 0.73 | 0.980 | 0.997 | 8.58 | 0.998 | 9.6 | 9.7 | Invention Example |
| 134 | 0.371 | 0.365 | 0.365 | 0.367 | 0.71 | 0.16 | 0.73 | 0.983 | 1.000 | 9.58 | 0.994 | 9.6 | 9.8 | Invention Example |
| 135 | 0.369 | 0.365 | 0.362 | 0.366 | 0.71 | 0.15 | 0.72 | 0.979 | 0.991 | 10.57 | 0.989 | 9.6 | 9.8 | Invention Example |
| 136 | 0.372 | 0.365 | 0.365 | 0.366 | 0.71 | 0.16 | 0.73 | 0.982 | 1.001 | 11.57 | 0.997 | 9.5 | 9.8 | Invention Example |
| 137 | 0.372 | 0.363 | 0.363 | 0.364 | 0.72 | 0.16 | 0.72 | 0.977 | 0.999 | 12.57 | 0.999 | 9.6 | 9.8 | Invention Example |
| 138 | 0.372 | 0.363 | 0.365 | 0.367 | 0.71 | 0.17 | 0.73 | 0.983 | 0.995 | 13.58 | 0.996 | 9.6 | 9.8 | Invention Example |
| 139 | 0.371 | 0.363 | 0.365 | 0.365 | 0.89 | 0.04 | 0.72 | 0.982 | 1.006 | 1.55 | 1.000 | 14.2 | 14.6 | Comparative Example |
| 140 | 0.372 | 0.365 | 0.362 | 0.366 | 0.88 | 0.04 | 0.71 | 0.973 | 0.991 | 1.53 | 0.988 | 14.3 | 14.6 | Comparative Example |
| 141 | Not evaluated since cracking occurs during cold rolling | | | | | | | | | | | | | Comparative Example |
| 142 | Not evaluated since cracking occurs during cold rolling | | | | | | | | | | | | | Comparative Example |
| 143 | 0.371 | 0.366 | 0.361 | 0.365 | 0.89 | 0.03 | 0.71 | 0.973 | 0.985 | 1.54 | 0.989 | 14.3 | 14.7 | Comparative Example |
| 144 | 0.369 | 0.366 | 0.364 | 0.366 | 0.89 | 0.03 | 0.71 | 0.986 | 0.994 | 1.54 | 0.994 | 14.2 | 14.8 | Comparative Example |
| 145 | 0.369 | 0.364 | 0.361 | 0.365 | 0.88 | 0.03 | 0.72 | 0.979 | 0.993 | 1.53 | 0.988 | 14.3 | 14.7 | Comparative Example |
| 146 | 0.371 | 0.364 | 0.362 | 0.365 | 0.88 | 0.03 | 0.71 | 0.975 | 0.994 | 1.55 | 0.990 | 14.3 | 14.8 | Comparative Example |
| 147 | Not evaluated since cracking occurs during cold rolling | | | | | | | | | | | | | Comparative Example |
| 148 | 0.369 | 0.353 | 0.363 | 0.366 | 0.72 | 0.16 | 0.75 | 0.983 | 1.026 | 5.60 | 0.992 | 9.6 | 9.8 | Invention Example |
| 149 | 0.370 | 0.362 | 0.361 | 0.367 | 0.72 | 0.07 | 0.74 | 0.974 | 0.996 | 0.90 | 0.983 | 9.5 | 9.7 | Invention Example |
| 150 | 0.372 | 0.364 | 0.363 | 0.341 | 0.72 | 0.15 | 0.74 | 0.978 | 0.998 | 5.60 | 1.064 | 9.5 | 9.8 | Invention Example |
| 151 | 0.371 | 0.365 | 0.362 | 0.365 | 0.89 | 0.04 | 0.71 | 0.975 | 0.991 | 1.53 | 0.993 | 14.2 | 14.6 | Comparative Example |

[symbol]

indicates data missing or illegible when filed

Underlined values in Table 1A to Table 1D, Table 2A, and Table 2B indicate, conditions deviating from the scope of the present invention. In all of No. 101 to No. 110, Nos. 117 to 138, and No. 148 to No. 150, which are invention examples, the iron losses W10/400 and W10/400 (whole direction) were favorable values. On the other hand, in No. 111 to No. 116, which are comparative examples, since Formula (1) was not satisfied, or at least any of the temperature in the intermediate annealing, the rolling reduction in the cold rolling, and the rolling reduction in the skin pass rolling was not optimal, at least one of Formula (3) to Formula (6) was not satisfied, and, as a result, the iron losses W10/400 and W10/400 (whole direction) were high.

In addition, in No. 139 to No. 147, which are comparative examples, since the chemical compositions were outside the scope of the present invention, cracking occurred during the cold rolling, or Formula (3) and Formula (4) were not satisfied, and, as a result, the iron losses W10/400 and W10/400 (whole direction) were high. In addition, in No. 151, which is a comparative example, since the non-oriented electrical steel sheet was used as the material (base metal), the chemical composition, the temperature in the intermediate annealing, the rolling reduction in the cold rolling, and the rolling reduction in the skin pass rolling were satisfied, but Formula (3) and Formula (4) were not satisfied, and, as a result, the iron losses W10/400 and W10/400 (whole direction) were high.

### Second Example

Materials having chemical compositions shown in Table 3A and Table 3C (a non-oriented electrical steel sheet only in No. 217, and materials obtained by cutting out Goss orientated grains from a single crystal into a sheet shape in Nos. 224 to 248. Grain-oriented electrical steel sheets in others) were produced. Here, the column “Left side of Formula (1)” indicates the values of the left side of Formula (1) described above. After that, cold rolling was performed in the width direction of the materials (in the case of being cut out from a single crystal, a direction parallel to a <110> direction) to obtain cold-rolled sheets. The produced grain-oriented electrical steel sheets were cold-rolled in the width direction after insulating films were removed. The rolling reductions in the cold rolling at that time are shown in Table 3B and Table 3D.

Intermediate annealing was performed on the cold-rolled sheets in a non-oxidizing atmosphere at temperatures shown in Table 3B and Table 3D for 30 seconds, and then the second round of cold rolling (skin pass rolling) was performed at rolling reductions shown in Table 3B and Table 3D. This skin pass rolling was performed in the same direction as in the cold rolling.

In order to investigate the textures after the skin pass rolling, a part of each of the steel sheets was cut, the cut test piece was processed to reduce the thickness to ½, and EBSD observation (step intervals: 100 nm) was performed on the processed surface in the above-described manner. The areas and average KAM values of each kind of orientated grains were obtained by EBSD observation, and S_{tyl}/Sₜₒₜ, S₄₁₁/Sₜₒₜ, S₄₁₁/Sₜᵣₐ, and K₄₁₁/K_{tyl} were obtained. The results are shown in Table 3B and Table 3D.

Next, a first heat treatment was performed under conditions shown in Table 3B and Table 3D. After the first heat treatment, in order to investigate the textures, a part of each of the steel sheets was cut, the cut test piece was processed to reduce the thickness to ½, and EBSD observation was performed on the processed surface in the above-described manner. The areas, average KAM values, and average grain sizes of kinds shown in Table 4A and Table 4B were obtained by EBSD observation.

In addition, as a second heat treatment, annealing was performed on the steel sheets at a temperature of 800° C. for 2 hours. From each of the steel sheets after the second heat treatment, 55 mm×55 mm sample pieces were collected as measurement samples. At this time, a sample in which one side of the sample piece was parallel to a rolling direction and a sample in which one side was inclined at 45 degrees with respect to the rolling direction were collected. In addition, the samples were collected using a shearing machine. Additionally, as magnetic characteristics, the iron losses W10/400 (the average value of the rolling direction and the width direction) and W10/400 (whole direction) (the average value of the rolling direction, the width direction, a direction at 45 degrees with respect to the rolling direction, and a direction at 135 degrees with respect to the rolling direction) were measured in the same manner as in First Example. The measurement results are shown in Table 4A and Table 4B.

TABLE 3A

| | | | | | | | | | | | | | | | | | Left |
|---|---|---|---|---|---|---|---|---|---|---|---|---|---|---|---|---|---|
| | | | | | | | | | | | | | | | | | side of |
| | Chemical composition (mass %, remainder is Fe and impurities) | | | | | | | | | | | | | | | | Formula |
| No. | C | Si | sol. Al | S | N | Mn | Ni | Co | Pt | Pb | Cu | Au | Cr | Mg | B | O | (1) |
| 201 | 0.0005 | 3.21 | 0.001 | 0.0001 | 0.0002 | 0.02 | — | — | — | — | — | — | 0.003 | — | — | — | −3.19 |
| 202 | 0.0004 | 3.18 | 0.001 | 0.0002 | 0.0003 | — | 0.01 | — | — | — | — | — | 0.003 | — | — | — | −3.17 |
| 203 | 0.0006 | 3.21 | 0.001 | 0.0002 | 0.0001 | — | — | 0.01 | — | — | — | — | 0.003 | — | — | — | −3.20 |
| 204 | 0.0005 | 3.21 | 0.002 | 0.0001 | 0.0001 | — | — | — | 0.02 | — | — | — | 0.003 | — | — | — | −3.20 |
| 205 | 0.0005 | 3.19 | 0.001 | 0.0001 | 0.0001 | — | — | — | — | 0.01 | — | — | 0.003 | — | — | — | −3.18 |
| 206 | 0.0006 | 3.20 | 0.001 | 0.0002 | 0.0002 | — | — | — | — | — | 0.01 | — | 0.002 | — | — | — | −3.19 |
| 207 | 0.0005 | 3.20 | 0.002 | 0.0001 | 0.0003 | — | — | — | — | — | — | 0.02 | 0.004 | — | — | — | −3.19 |
| 208 | 0.0005 | 3.19 | 0.002 | 0.0002 | 0.0002 | 0.01 | — | — | — | — | — | — | 0.002 | — | — | — | −3.18 |
| 209 | 0.0006 | 3.22 | 0.002 | 0.0003 | 0.0003 | 0.01 | — | — | — | — | — | — | 0.004 | — | — | — | −3.21 |
| 210 | 0.0006 | 3.18 | 0.001 | 0.0003 | 0.0001 | 0.01 | — | — | — | — | — | — | 0.003 | — | — | — | −3.17 |
| 211 | 0.0005 | 3.20 | 0.001 | 0.0002 | 0.0002 | 0.02 | — | — | — | — | — | — | 0.003 | — | — | — | −3.18 |
| 212 | 0.0004 | 3.22 | 0.002 | 0.0002 | 0.0002 | 0.02 | — | — | — | — | — | — | 0.002 | — | — | — | −3.20 |
| 213 | 0.0005 | 3.18 | 0.001 | 0.0002 | 0.0002 | 0.02 | — | — | — | — | — | — | 0.003 | — | — | — | −3.17 |
| 214 | 0.0006 | 3.19 | 0.001 | 0.0002 | 0.0002 | 0.02 | — | — | — | — | — | — | 0.003 | — | — | — | −3.17 |
| 215 | 0.0005 | 3.22 | 0.001 | 0.0001 | 0.0002 | 0.02 | — | — | — | — | — | — | 0.002 | — | — | — | −3.20 |
| 216 | 0.0005 | 3.20 | 0.002 | 0.0003 | 0.0002 | 0.02 | — | — | — | — | — | — | 0.003 | — | — | — | −3.19 |
| 217 | 0.0005 | 2.00 | 0.001 | 0.0018 | 0.0016 | 2.41 | — | — | — | — | — | — | 0.004 | — | — | — | 0.41 |
| 218 | 0.0005 | 3.21 | 0.001 | 0.0001 | 0.0002 | 0.01 | — | — | — | — | — | — | 0.002 | — | — | — | −3.20 |
| 219 | 0.0004 | 3.21 | 0.001 | 0.0001 | 0.0002 | 0.02 | — | — | — | — | — | — | 0.004 | — | — | — | −3.19 |
| 220 | 0.0005 | 3.22 | 0.001 | 0.0001 | 0.0002 | 0.01 | — | — | — | — | — | — | 0.004 | — | — | — | −3.20 |
| 221 | 0.0007 | 3.21 | 0.001 | 0.0001 | 0.0002 | 0.01 | — | — | — | — | — | — | 0.004 | — | — | — | −3.20 |
| 222 | 0.0005 | 3.21 | 0.001 | 0.0001 | 0.0002 | 0.02 | — | — | — | — | — | — | 0.003 | — | — | — | −3.19 |
| 223 | 0.0004 | 3.21 | 0.001 | 0.0001 | 0.0002 | 0.01 | — | — | — | — | — | — | 0.004 | — | — | — | −3.19 |
| 224 | 0.0083 | 3.23 | 0.594 | 0.0018 | 0.0020 | 0.01 | — | — | — | — | — | — | 0.003 | — | — | — | −3.81 |
| 225 | 0.0011 | 1.61 | 0.607 | 0.0020 | 0.0018 | 0.02 | — | — | — | — | — | — | 0.004 | — | — | — | −2.19 |

TABLE 3B

| | Sheet thickness | | | | | | | | | | | |
|---|---|---|---|---|---|---|---|---|---|---|---|---|
| | (mm) | | Rolling reduction | | Intermediate | | | | | | | |
| | | After | (%) | | annealing | | | | | First heat treatment | | |
| | Before | skin | | Skin | Annealing | EBSD observation result after skin pass | | | | Annealing | Annealing | |
| | cold | pass | Cold | pass | temperature | rolling | | | | temperature | time | |
| No. | rolling | rolling | rolling | rolling | (° C.) | [symbol] | [symbol] | [symbol] | [symbol] | (° C.) | (s) | Note |
| 201 | 0.30 | 0.15 | 42 | 14 | 800 | 0.71 | 0.15 | 0.73 | 0.980 | 800 | 30 | Invention Example |
| 202 | 0.30 | 0.15 | 42 | 14. | 800 | 0.74 | 0.14 | 0.71 | 0.978 | 800 | 30 | Invention Example |
| 203 | 0.30 | 0.15 | 42 | 14 | 800 | 0.73 | 0.14 | 0.73 | 0.982 | 800 | 30 | Invention Example |
| 204 | 0.30 | 0.15 | 42 | 14 | 800 | 0.71 | 0.15 | 0.73 | 0.983 | 800 | 30 | Invention Example |
| 205 | 0.30 | 0.15 | 42 | 14 | 800 | 0.73 | 0.15 | 0.71 | 0.978 | 200 | 30 | Invention Example |
| 206 | 0.30 | 0.15 | 42 | 14 | 800 | 0.72 | 0.15 | 0.71 | 0.981 | 800 | 30 | Invention Example |
| 207 | 0.30 | 0.15 | 42 | 14 | 800 | 0.71 | 0.13 | 0.72 | 0.979 | 800 | 30 | Invention Example |
| 208 | 0.30 | 0.15 | 42 | 14 | 800 | 0.72 | 0.15 | 0.72 | 0.983 | 800 | 30 | Invention Example |
| 209 | 0.32 | 0.15 | 42 | 18 | 800 | 0.72 | 0.15 | 0.70 | 0.980 | 800 | 30 | Invention Example |
| 210 | 0.29 | 0.15 | 42 | 10 | 800 | 0.72 | 0.16 | 0.73 | 0.985 | 800 | 30 | Invention Example |
| 211 | 0.43 | 0.15 | 60 | 14 | 800 | 0.72 | 0.04 | 0.71 | 0.978 | 800 | 30 | Comparative Example |
| 212 | 0.22 | 0.15 | 15 | 14 | 800 | 0.72 | 0.16 | 0.33 | 0.978 | 800 | 30 | Comparative Example |
| 213 | 0.27 | 0.15 | 42 | 3 | 800 | 0.72 | 0.16 | 0.54 | 1.007 | 800 | 30 | Comparative Example |
| 214 | 0.40 | 0.15 | 42 | 35 | 800 | 0.82 | 0.17 | 0.73 | 1.007 | 800 | 30 | Comparative Example |
| 215 | 0.30 | 0.15 | 42 | 14 | 550 | 0.16 | 0.07 | 0.20 | 0.981 | 800 | 30 | Comparative Example |
| 216 | 0.30 | 0.15 | 42 | 14 | 800 | 0.71 | 0.16 | 0.73 | 0.980 | 690 | 1 | Comparative Example |
| 217 | 0.30 | 0.15 | 42 | 14 | 800 | 0.89 | 0.03 | 0.72 | 0.980 | 800 | 30 | Comparative Example |
| 218 | 0.30 | 0.15 | 39 | 14 | 800 | 0.72 | 0.15 | 0.74 | 0.977 | 800 | 30 | Invention Example |
| 219 | 0.30 | 0.15 | 38 | 12 | 800 | 0.72 | 0.15 | 0.72 | 0.982 | 800 | 30 | Invention Example |
| 220 | 0.30 | 0.15 | 37 | 11 | 800 | 0.71 | 0.16 | 0.73 | 0.977 | 800 | 30 | Invention Example |
| 221 | 0.30 | 0.15 | 41 | 14 | 820 | 0.71 | 0.15 | 0.73 | 0.981 | 800 | 30 | Invention Example |
| 222 | 0.30 | 0.15 | 42 | 14 | 800 | 0.71 | 0.16 | 0.74 | 0.977 | 950 | 30 | Invention Example |
| 223 | 0.30 | 0.15 | 42 | 14 | 800 | 0.71 | 0.15 | 0.74 | 0.982 | 700 | 30 | Invention Example |
| 224 | 0.30 | 0.15 | 42 | 14 | 800 | 0.71 | 0.16 | 0.73 | 0.981 | 800 | 30 | Invention Example |
| 225 | 0.30 | 0.15 | 42 | 14 | 800 | 0.71 | 0.15 | 0.73 | 0.981 | 800 | 30 | Invention Example |

[symbol]

indicates data missing or illegible when filed

TABLE 3C

| | | | | | | | | | | | | | | | | | Left |
|---|---|---|---|---|---|---|---|---|---|---|---|---|---|---|---|---|---|
| | | | | | | | | | | | | | | | | | side of |
| | Chemical composition (mass %, remainder is Fe and impurities) | | | | | | | | | | | | | | | | Formula |
| No. | C | Si | sol. Al | S | N | Mn | Ni | Co | Pt | Pb | Cu | Au | Cr | Mg | B | O | (1) |
| 226 | 0.0010 | 3.90 | 0.599 | 0.0017 | 0.0018 | 0.01 | — | — | — | — | — | — | 0,003 | — | — | — | −4.49 |
| 227 | 0.0011 | 3.21 | 2.795 | 0.0019 | 0.0022 | 0.00 | — | — | — | — | — | — | 0.003 | — | — | — | −6.01 |
| 228 | 0.0008 | 3.23 | 0.611 | 0.0003 | 0.0021 | 0.01 | — | — | — | — | — | — | 0.002 | — | — | — | −3.81 |
| 229 | 0.0011 | 3.22 | 0.595 | 0.0092 | 0.0019 | 0.01 | — | — | — | — | — | — | 0.003 | — | — | — | −3.81 |
| 230 | 0.0010 | 3.23 | 0.609 | 0.0017 | 0.0091 | 0.01 | — | — | — | — | — | — | 0.003 | — | — | — | −3.81 |
| 231 | 0.0009 | 3.22 | 0.600 | 0.0019 | 0.0020 | 0.02 | — | — | — | — | — | — | 0.002 | 0.001 | — | — | −3.81 |
| 232 | 0.0009 | 3.21 | 0.607 | 0.0017 | 0.0021 | 0.00 | — | — | — | — | — | — | 0.003 | 0.009 | — | — | −3.81 |
| 233 | 0.0010 | 3.21 | 0.603 | 0.0019 | 0.0021 | 0.00 | — | — | — | — | — | — | — | — | — | — | −3.81 |
| 234 | 0.0008 | 3.22 | 0.605 | 0.0020 | 0.0021 | 0.01 | — | — | — | — | — | — | 0.092 | — | — | — | −3.81 |
| 235 | 0.0009 | 3.22 | 2.802 | 0.0019 | 0.0021 | 2.41 | — | — | — | — | — | — | 0.002 | — | — | — | −3.62 |
| 236 | 0.0008 | 3.23 | 0.608 | 0.0019 | 0.0018 | 0.21 | — | — | — | — | — | — | 0.003 | — | 0.0002 | — | −3.61 |
| 237 | 0.0010 | 3.23 | 0.601 | 0.0018 | 0.0019 | 0.21 | — | — | — | — | — | — | 0.003 | — | 0.0044 | — | −3.61 |
| 238 | 0.0011 | 3.21 | 0.609 | 0.0018 | 0.0020 | 0.21 | — | — | — | — | — | — | 0.004 | — | — | 0.0013 | −3.61 |
| 239 | 0.0009 | 3.23 | 0.611 | 0.0018 | 0.0020 | 0.22 | — | — | — | — | — | — | 0.002 | — | — | 0.0169 | −3.61 |
| 240 | 0.0122 | 3.21 | 0.601 | 0.0020 | 0.0020 | 0.22 | — | — | — | — | — | — | 0.003 | — | — | — | −3.61 |
| 241 | 0.0010 | 1.41 | 0.602 | 0.0018 | 0.0019 | 0.21 | — | — | — | — | — | — | 0.003 | — | — | — | −1.79 |
| 242 | 0.0010 | 4.21 | 0.598 | 0.0020 | 0.0021 | 0.22 | — | — | — | — | — | — | 0.003 | — | — | — | −4.59 |
| 243 | 0.0009 | 3.23 | 4.198 | 0.0017 | 0.0018 | 0.21 | — | — | — | — | — | — | 0.003 | — | — | — | −6.20 |
| 244 | 0.0011 | 3.21 | 0.615 | 0.0449 | 0.0018 | 0.22 | — | — | — | — | — | — | 0.002 | — | — | — | −3.61 |
| 245 | 0.0010 | 3.21 | 0.608 | 0.0019 | 0.0122 | 0.23 | — | — | — | — | — | — | 0.003 | — | — | — | −3.61 |
| 246 | 0.0011 | 3.22 | 0.610 | 0.0019 | 0.0020 | 0.23 | — | — | — | — | — | — | 0.004 | 0.012 | — | — | −3.61 |
| 247 | 0.0010 | 3.22 | 0.610 | 0.0017 | 0.0019 | 0.22 | — | — | — | — | — | — | 0.121 | — | — | — | −3.61 |
| 248 | 0.0010 | 3.23 | 0.598 | 0.0020 | 0.0020 | 2.60 | — | — | — | — | — | — | 0.002 | — | — | — | −1.22 |

TABLE 3D

| | Sheet thickness | | | | | | | | | | | |
|---|---|---|---|---|---|---|---|---|---|---|---|---|
| | (mm) | | Rolling reduction | | Intermediate | | | | | | | |
| | | After | (%) | | annealing | | | | | First heat treatment | | |
| | Before | skin | | Skin | Annealing. | EBSD observation result after skin pass | | | | Annealing | Annealing | |
| | gold | pass | Cold | pass | temperature | rolling | | | | temperature | time | |
| No. | rolling | rolling | rolling | rolling | (° C.) | [symbol] | [symbol] | [symbol] | [symbol] | (° C.) | (s) | Note |
| 226 | 0.30 | 0.15 | 42 | 14 | 800 | 0.71 | 0.16 | 0.73 | 0.979 | 800 | 30 | Invention Example |
| 227 | 0.30 | 0.15 | 42 | 14 | 800 | 0.71 | 0.16 | 0.74 | 0.977 | 800 | 30 | Invention Example |
| 228 | 0.30 | 0.15 | 42 | 14 | 800 | 0.71 | 0.16 | 0.74 | 0.977 | 800 | 30 | Invention Example |
| 229 | 0.30 | 0.15 | 42 | 14 | 800 | 0.71 | 0.16 | 0.73 | 0.978 | 800 | 30 | Invention Example |
| 230 | 0.30 | 0.15 | 42 | 14 | 800 | 0.72 | 0.16 | 0.73 | 0.979 | 800 | 30 | Invention Example |
| 231 | 0.30 | 0.15 | 42 | 14 | 800 | 0.71 | 0.15 | 0.74 | 0.982 | 800 | 30 | Invention Example |
| 232 | 0.30 | 0.15 | 42 | 14 | 800 | 0.71 | 0.15 | 0.73 | 0.982 | 800 | 30 | Invention Example |
| 233 | 0.30 | 0.15 | 42 | 14 | 800 | 0.71 | 0.15 | 0.72 | 0.979 | 800 | 30 | Invention Example |
| 234 | 0.30 | 0.15 | 42 | 14 | 800 | 0.71 | 0.16 | 0.73 | 0.978 | 800 | 30 | Invention Example |
| 235 | 0.30 | 0.15 | 42 | 14 | 800 | 0.72 | 0.15 | 0.72 | 0.982 | 800 | 30 | Invention Example |
| 236 | 0.30 | 0.15 | 42 | 14 | 800 | 0.72 | 0.16 | 0.74 | 0.977 | 800 | 30 | Invention Example |
| 237 | 0.30 | 0.15 | 42 | 14 | 800 | 0.72 | 0.15 | 0.74 | 0.981 | 800 | 30 | Invention Example |
| 238 | 0.30 | 0.15 | 42 | 14 | 800 | 0.73 | 0.15 | 0.73 | 0.978 | 800 | 30 | Invention Example |
| 239 | 0.30 | 0.15 | 42 | 14 | 800 | 0.71 | 0.16 | 0.74 | 0.982 | 800 | 30 | Invention Example |
| 240 | 0.30 | 0.15 | 42 | 14 | 800 | 0.88 | 0.03 | 0.72 | 0.981 | 800 | 30 | Comparative Example |
| 241 | 0.30 | 0.15 | 42 | 14 | 800 | 0.89 | 0.03 | 0.71 | 0.982 | 800 | 30 | Comparative Example |
| 242 | 0.30 | 0.15 | 42 | Cracking occurs during cold rolling | | | | | | | | Comparative Example |
| 243 | 0.30 | 0.15 | 42 | Cracking occurs during cold rolling | | | | | | | | Comparative Example |
| 244 | 0.30 | 0.15 | 42 | 14 | 800 | 0.89 | 0.03 | 0.72 | 0.978 | 800 | 30 | Comparative Example |
| 245 | 0.30 | 0.15 | 42 | 14 | 800 | 0.88 | 0.04 | 0.71 | 0.979 | 800 | 30 | Comparative Example |
| 246 | 0.30 | 0.15 | 42 | 14 | 800 | 0.89 | 0.04 | 0.72 | 0.979 | 800 | 30 | Comparative Example |
| 247 | 0.30 | 0.15 | 42 | 14 | 800 | 0.89 | 0.03 | 0.71 | 0.978 | 800 | 30 | Comparative Example |

| | | | | | |
|---|---|---|---|---|---|
| 248 | 0.30 | 0.15 | 42 | Cracking occurs during cold rolling | Comparative Example |

[symbol]

indicates data missing or illegible when filed

TABLE 4A

| | | | | | | | | | | | | | | | After second heat | | |
|---|---|---|---|---|---|---|---|---|---|---|---|---|---|---|---|---|---|
| | | | | | | | | | | | | | | | treatment | | |
| | | | | | | | | | | | | | | | | W10/W400 | |
| | | | | | | | | | | | | | | | | (whole direction | |
| | EBSD observation result after first heat treatment | | | | | | | | | | | | | | W10/400 | average) | |
| No. | K [symbol] | K [symbol] | K₄₁₁ | K₁₁₀ | S [symbol] /S [symbol] | S₄₁₁/S [symbol] | S₄₁₁/S [symbol] | K₄₁₁/K [symbol] | d₄₁₁/d [symbol] | d₄₁₁/d [symbol] | K₄₁₁/K [symbol] | d₄₁₁/d [symbol] | S₄₁₁/S₁₁₀ | K₄₁₁/K₁₁₀ | (W/kg) | (W/kg) | Note |
| 201 | 0.207 | 0.204 | 0.200 | 0.202 | 0.64 | 0.29 | 0.85 | 0.965 | 1.30 | 1.49 | 0.983 | 1.09 | 6.80 | 0.991 | 9.5 | 9.8 | Invention |
| | | | | | | | | | | | | | | | | | Example |
| 202 | 0.208 | 0.204 | 0.199 | 0.201 | 0.65 | 0.29 | 0.85 | 0.958 | 1.30 | 1.50 | 0.977 | 1.09 | 6.79 | 0.993 | 9.5 | 9.7 | Invention |
| | | | | | | | | | | | | | | | | | Example |
| 203 | 0.208 | 0.204 | 0.201 | 0.202 | 0.65 | 0.28 | 0.85 | 0.965 | 1.29 | 1.49 | 0.985 | 1.09 | 6.79 | 0.998 | 9.7 | 9.9 | Invention |
| | | | | | | | | | | | | | | | | | Example |
| 204 | 0.209 | 0.205 | 10.201 | 0202 | 0.65 | 0.29 | 0.84 | 0.959 | 1.30 | 1.49 | 0.981 | 1.10 | 6.78 | 0.994 | 9.6 | 9.8 | Invention |
| | | | | | | | | | | | | | | | | | Example |
| 205 | 0.207 | 0.204 | 0.200 | 0.202 | 0.64 | 0.28 | 0.84 | 0.962 | 1.29 | 1.50 | 0.979 | 1.09 | 6.80 | 0.986 | 9.6 | 9.8 | Invention |
| | | | | | | | | | | | | | | | | | Example |
| 206 | 0.207 | 0.203 | 0.199 | 0.201 | 0.64 | 0.28 | 0.84 | 0.962 | 1.29 | 1.50 | 0.980 | 1.10 | 6.79 | 0.990 | 9.7 | 10.0 | Invention |
| | | | | | | | | | | | | | | | | | Example |
| 207 | 0.208 | 0.204 | 0.201 | 0.201 | 0.64 | 0.28 | 0.85 | 0.966 | 1.30 | 1.48 | 0.985 | 1.09 | 6.78 | 0.997 | 9.6 | 9.9 | Invention |
| | | | | | | | | | | | | | | | | | Example |
| 208 | 0.208 | 0.205 | 0.200 | 0.202 | 0.65 | 0.29 | 0.85 | 0.960 | 1.30 | 1.49 | 0.978 | 1.09 | 6.79 | 0.988 | 9.6 | 9.9 | Invention |
| | | | | | | | | | | | | | | | | | Example |
| 209 | 0.208 | 0.204 | 0.200 | 0.202 | 0.64 | 0.29 | 0.84 | 0.960 | 1.29 | 1.50 | 0.980 | 1.09 | 6.79 | 0.990 | 9.7 | 9.9 | Invention |
| | | | | | | | | | | | | | | | | | Example |
| 210 | 0.208 | 0.203 | 0.200 | 0.201 | 0.64 | 0.29 | 0.86 | 0.957 | 1.29 | 1.49 | 0.982 | 1.09 | 6.78 | 0.994 | 9.6 | 9.8 | Invention |
| | | | | | | | | | | | | | | | | | Example |
| 211 | 0.209 | 0.203 | 0.201 | 0.201 | 0.64 | 0.15 | 0.84 | 0.963 | 1.30 | 1.50 | 0.990 | 1.10 | 6.79 | 0.998 | 12.3 | 12.7 | Comparative |
| | | | | | | | | | | | | | | | | | Example |
| 212 | 0.208 | 0.204 | 0.201 | 0.202 | 0.64 | 0.28 | 0.21 | 0.964 | 1.29 | 1.49 | 0.983 | 1.09 | 6.79 | 0.994 | 12.3 | 12.8 | Comparative |
| | | | | | | | | | | | | | | | | | Example |
| 213 | 0.208 | 0.209 | 0.209 | 0.208 | 0.64 | 0.28 | 0.84 | 1.004 | 1.30 | 1.48 | 1.000 | 1.10 | 6.79 | 1.005 | 12.4 | 12.7 | Comparative |
| | | | | | | | | | | | | | | | | | Example |
| 214 | 0.208 | 0.204 | 0.201 | 0.202 | 0.75 | 0.28 | 0.84 | 0.968 | 1.29 | 1.49 | 0.985 | 1.10 | 6.80 | 0.996 | 11.3 | 11.8 | Comparative |
| | | | | | | | | | | | | | | | | | Example |
| 215 | 0.209 | 0.205 | 0.200 | 0.202 | 0.65 | 0.29 | 0.85 | 0.957 | 1.29 | 0.95 | 0.978 | 1.09 | 6.78 | 0.990 | 11.1 | 11.5 | Comparative |
| | | | | | | | | | | | | | | | | | Example |
| 216 | 0.209 | 0.204 | 0.200 | 0.202 | 0.64 | 0.29 | 0.84 | 0.958 | 0.95 | 1.49 | 0.983 | 1.10 | 6.79 | 0.990 | 11.3 | 11.7 | Comparative |
| | | | | | | | | | | | | | | | | | Example |
| 217 | 0.207 | 0.204 | 0.201 | 0.202 | 0.88 | 0.05 | 0.86 | 0.972 | 1.28 | 1.46 | 0.985 | 1.09 | 1.51 | 0.997 | 14.2 | 14.7 | Comparative |
| | | | | | | | | | | | | | | | | | Example |
| 218 | 0.207 | 0.195 | 0.200 | 0.200 | 0.65 | 0.29 | 0.85 | 0.967 | 1.30 | 1.50 | 1.028 | 1.09 | 6.79 | 1.000 | 9.6 | 9.7 | Invention |
| | | | | | | | | | | | | | | | | | Example |
| 219 | 0.207 | 0.202 | 0.201 | 0.202 | 0.64 | 0.28 | 0.85 | 0.972 | 1.30 | 1.49 | 0.995 | 0.99 | 6.80 | 0.993 | 9.6 | 9.8 | Invention |
| | | | | | | | | | | | | | | | | | Example |
| 220 | 0.207 | 0.203 | 0.201 | 0.203 | 0.63 | 0.29 | 0.84 | 0.972 | 1.29 | 1.48 | 0.991 | 1.09 | 0.99 | 0.993 | 9.5 | 9.7 | Invention |
| | | | | | | | | | | | | | | | | | Example |
| 221 | 0.206 | 0.204 | 0.199 | 0.204 | 0.64 | 0.30 | 0.85 | 0.970 | 1.29 | 1.50 | 0.979 | 1.09 | 6.81 | 1.011 | 9.6 | 9.7 | Invention |
| | | | | | | | | | | | | | | | | | Example |
| 222 | 0.208 | 0.204 | 0.201 | 0.202 | 0.63 | 0.29 | 0.84 | 0.967 | 1.30 | 1.48 | 0.985 | 1.09 | 6.80 | 0.995 | 9.3 | 9.5 | Invention |
| | | | | | | | | | | | | | | | | | Example |
| 223 | 0.209 | 0.203 | 0.200 | 0.201 | 0.64 | 0.29 | 0.85 | 0.957 | 1.30 | 1.50 | 0.986 | 1.09 | 6.80 | 0.997 | 9.9 | 10.2 | Invention |
| | | | | | | | | | | | | | | | | | Example |
| 224 | 0.208 | 0.202 | 0.198 | 0.202 | 0.63 | 0.29 | 0.85 | 0.965 | 1.30 | 1.50 | 0.983 | 1.08 | 6.79 | 0.991 | 9.9 | 10.1 | Invention |
| | | | | | | | | | | | | | | | | | Example |
| 225 | 0.209 | 0.202 | 0.200 | 0.203 | 0.64 | 0.29 | 0.84 | 0.965 | 1.31 | 1.50 | 0.983 | 1.09 | 6.81 | 0.991 | 9.9 | 10.1 | Invention |
| | | | | | | | | | | | | | | | | | Example |

[symbol]

indicates data missing or illegible when filed

TABLE 4B

| | | | | | | | | | | | | | | | After second heat | | |
|---|---|---|---|---|---|---|---|---|---|---|---|---|---|---|---|---|---|
| | | | | | | | | | | | | | | | treatment | | |
| | | | | | | | | | | | | | | | | W10/W400 | |
| | | | | | | | | | | | | | | | | (whole direction | |
| | EBSD observation result after first heat treatment | | | | | | | | | | | | | | W10/400 | average) | |
| No. | K [symbol] | K [symbol] | K₄₁₁ | K₁₁₀ | S [symbol] /S [symbol] | S₄₁₁/S [symbol] | S₄₁₁/S [symbol] | K₄₁₁/K [symbol] | d₄₁₁/d [symbol] | d₄₁₁/d [symbol] | K₄₁₁/K [symbol] | d₄₁₁/d [symbol] | S₄₁₁/S₁₁₀ | K₄₁₁/K₁₁₀ | (W/kg) | (W/kg) | Note |
| 226 | 0.209 | 0.206 | 0.201 | 0.203 | 0.63 | 0.30 | 0.84 | 0.965 | 1.30 | 1.50 | 0.983 | 1.08 | 6.80 | 0.991 | 9.3 | 9.4 | Invention |
| | | | | | | | | | | | | | | | | | Example |
| 227 | 0.206 | 0.203 | 0.202 | 0.201 | 0.63 | 0.29 | 0.85 | 0.965 | 1.30 | 1.49 | 0.983 | 109 | 6.79 | 0.991 | 9.4 | 9.5 | Invention |
| | | | | | | | | | | | | | | | | | Example |
| 228 | 0.209 | 0.205 | 0.199 | 0.203 | 0.65 | 0.30 | 0.84 | 0.965 | 1.30 | 1.49 | 0.983 | 1.09 | 6.79 | 0.991 | 9.5 | 9.7 | Invention |
| | | | | | | | | | | | | | | | | | Example |
| 229 | 0.209 | 0.203 | 0.199 | 0.203 | 0.64 | 0.30 | 0.84 | 0.965 | 1.29 | 1.49 | 0.983 | 1.08 | 6.80 | 0.991 | 9.8 | 10.0 | Invention |
| | | | | | | | | | | | | | | | | | Example |
| 230 | 0.207 | 0.202 | 0.202 | 0.204 | 0.65 | 0.29 | 0.86 | 0.965 | 1.30 | 1.49 | 0.983 | 1.08 | 6.80 | 0.991 | 9.8 | 10.2 | Invention |
| | | | | | | | | | | | | | | | | | Example |
| 231 | 0.209 | 0.206 | 0.199 | 0.201 | 0.64 | 0.29 | 0.85 | 0.965 | 1.29 | 1.50 | 0.983 | 1.09 | 6.80 | 0.991 | 9.6 | 9.8 | Invention |
| | | | | | | | | | | | | | | | | | Example |
| 232 | 0.206 | 0.204 | 0.201 | 0.203 | 0.64 | 0.28 | 0.84 | 0.965 | 1.30 | 1.48 | 0.983 | 1.08 | 6.79 | 0.991 | 9.6 | 9.7 | Invention |
| | | | | | | | | | | | | | | | | | Example |
| 233 | 0.209 | 0.206 | 0.202 | 0.201 | 0.63 | 0.29 | 0.85 | 0.965 | 1.30 | 1.50 | 0.983 | 1.08 | 6.80 | 0.991 | 9.6 | 9.8 | Invention |
| | | | | | | | | | | | | | | | | | Example |
| 234 | 0.206 | 0.205 | 0.202 | 0.203 | 0.63 | 0.29 | 0.84 | 0.965 | 1.31 | 1.49 | 0.983 | 1.10 | 6.80 | 0.991 | 9.5 | 9.7 | Invention |
| | | | | | | | | | | | | | | | | | Example |
| 235 | 0.207 | 0.204 | 0.201 | 0.204 | 0.64 | 0.29 | 0.85 | 0.965 | 1.31 | 1.49 | 0.983 | 1.09 | 6.80 | 0.991 | 9.5 | 9.7 | Invention |
| | | | | | | | | | | | | | | | | | Example |
| 236 | 0.209 | 0.203 | 0.202 | 0.202 | 0.65 | 6.29 | 0.85 | 0.965 | 1.29 | 1.49 | 0.983 | 1.09 | 6.80 | 0.991 | 9.6 | 9.7 | Invention |
| | | | | | | | | | | | | | | | | | Example |
| 237 | 0.208 | 0.205 | 0.201 | 0.203 | 0.64 | 0.30 | 0.84 | 0.965 | 1.30 | 1.50 | 0.983 | 1.08 | 6.79 | 0.991 | 9.5 | 9.7 | Invention |
| | | | | | | | | | | | | | | | | | Example |
| 238 | 0.208 | 0.203 | 0.201 | 0.203 | 0.64 | 0.30 | 0.85 | 0.965 | 1.30 | 1.49 | 0.983 | 1.09 | 6.80 | 0.991 | 9.6 | 9.8 | Invention |
| | | | | | | | | | | | | | | | | | Example |
| 239 | 0.208 | 0.204 | 0.201 | 0.203 | 0.64 | 0.29 | 0.85 | 0.965 | 1.30 | 1.48 | 0.983 | 1.08 | 6.79 | 0.991 | 9.6 | 9.8 | Invention |
| | | | | | | | | | | | | | | | | | Example |
| 240 | 0.206 | 0.206 | 0201 | 0.202 | 0.87 | 0.05 | 0.86 | 0.972 | 1.29 | 1.45 | 0.985 | 1.09 | 1.52 | 0.997 | 14.2 | 14.6 | Comparative |
| | | | | | | | | | | | | | | | | | Example |
| 241 | 0.209 | 0.203 | 0.203 | 0.201 | 0.87 | 0.05 | 0.86 | 0.972 | 1.27 | 1.45 | 0.985 | 1.10 | 1.52 | 0.997 | 14.1 | 14.6 | Comparative |
| | | | | | | | | | | | | | | | | | Example |
| 242 | Not evaluated since cracking occurs during cold rolling | | | | | | | | | | | | | | | | Comparative |
| | | | | | | | | | | | | | | | | | Example |
| 243 | Not evaluated since cracking occurs during cold rolling | | | | | | | | | | | | | | | | Comparative |
| | | | | | | | | | | | | | | | | | Example |
| 244 | 0.206 | 0.205 | 0.203 | 0.203 | 0.88 | 0.05 | 0.87 | 0.972 | 1.28 | 1.46 | 0.985 | 1.09 | 1.51 | 0.997 | 14.2 | 14.7 | Comparative |
| | | | | | | | | | | | | | | | | | Example |
| 245 | 0.206 | 0.204 | 0.200 | 0.203 | 0.87 | 0.05 | 0.86 | 0.972 | 1.29 | 1.46 | 0.985 | 1.09 | 1.51 | 0.997 | 14.2 | 14.6 | Comparative |
| | | | | | | | | | | | | | | | | | Example |
| 246 | 0.205 | 0.202 | 0.203 | 0.203 | 0.88 | 0.06 | 0.85 | 0.972 | 1.27 | 1.45 | 0.985 | 1.08 | 1.51 | 0.997 | 14.2 | 14.6 | Comparative |
| | | | | | | | | | | | | | | | | | Example |
| 247 | 0.206 | 0.204 | 0.202 | 0.202 | 0.88 | 0.05 | 0.85 | 0.972 | 1.28 | 1.46 | 0.985 | 1.08 | 1.52 | 0.997 | 14.2 | 14.6 | Comparative |
| | | | | | | | | | | | | | | | | | Example |

| | | |
|---|---|---|
| 248 | Not evaluated since cracking occurs during cold rolling | Comparative |
| | | Example |

[symbol]

indicates data missing or illegible when filed

Underlined values in Table 3A to Table 3D, Table 4A, and Table 4B indicate conditions deviating from the scope of the present invention. In all of No. 201 to No. 210 and No. 218 to No. 239, which are invention examples, the iron losses W10/400 and W10/400 (whole direction) were favorable values.

On the other hand, in No. 211 to No. 217, which are comparative examples, since Formula (1) was not satisfied, or at least any of the temperature in the intermediate annealing, the rolling reduction in the cold rolling, the rolling reduction in the skin pass rolling, and the temperature in the first heat treatment was not optimal, any of Formula (10) to Formula (15) was not satisfied, and, as a result, the iron losses W10/400 and W10/400 (whole direction) were high.

In addition, in No. 240 to No. 248, which are comparative examples, since the chemical compositions were outside the scope of the present invention, cracking occurred during the cold rolling, or Formula (10) and Formula (11) were not satisfied, and, as a result, the iron losses W10/400 and W10/400 (whole direction) were high.

### Third Example

Materials having chemical compositions shown in Table 5A and Table 5C (a non-oriented electrical steel sheet only in No. 316, and materials obtained by cutting out Goss orientated grains from a single crystal into a sheet shape in Nos. 317 to 342. Grain-oriented electrical steel sheets in others) were produced. Here, the column “Left side of Formula (1)” indicates the values of the left side of Formula (1) described above. After that, cold rolling was performed in the width direction of the materials (in the case of being cut out from a single crystal, a direction parallel to a <110> direction) to obtain cold-rolled sheets. The produced grain-oriented electrical steel sheets were cold-rolled in the width direction after insulating films were removed. The rolling reductions in the cold rolling at that time are shown in Table 5B and Table 5D.

Intermediate annealing was performed on the cold-rolled sheets in a non-oxidizing atmosphere at temperatures shown in Table 5B and Table 5D for 30 seconds, and then the second round of cold rolling (skin pass rolling) was performed at rolling reductions shown in Table 5B and Table 5D. This skin pass rolling was performed in the same direction as in the cold rolling.

In order to investigate the textures after the skin pass rolling, a part of each of the steel sheets was cut, the cut test piece was processed to reduce the thickness to ½, and EBSD observation (step intervals: 100 nm) was performed on the processed surface in the above-described manner. The areas and average KAM values of each kind of orientated grains were obtained by EBSD observation, and S_{tyl}/St, S₄₁₁/Sₜₒₜ, S₄₁₁/Sₜᵣₐ and K₄₁₁/K_{tyl} were obtained. The results are shown in Table 5B and Table 5D.

Next, a second heat treatment was performed under conditions shown in Table 5B and Table 5D without performing a first heat treatment. After the second heat treatment, in order to investigate the textures, a part of each of the steel sheets was cut, the cut test piece was processed to reduce the thickness to ½, and EBSD observation was performed on the processed surface. The areas and average grain sizes of kinds shown in Table 6 were obtained by EBSD observation.

In addition, after the second heat treatment, from each of the steel sheets after the second heat treatment, 55 mm×55 mm sample pieces were collected as measurement samples. At this time, a sample in which one side of the sample piece was parallel to a rolling direction and a sample in which one side was inclined at 45 degrees with respect to the rolling direction were collected. In addition, the samples were collected using a shearing machine. Additionally, as magnetic characteristics, the iron losses W10/400 (the average value of the rolling direction and the width direction) and W10/400 (whole direction) (the average value of the rolling direction, the width direction, a direction at 45 degrees with respect to the rolling direction, and a direction at 135 degrees with respect to the rolling direction) were measured in the same manner as in First Example. The measurement results are shown in Table 6.

TABLE 5A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Laft side |
| | | | | | | | | | | | | | | | | | of |
| | | | | | | | | | | | | | | | | | Formula |
| No. | C | Si | sol. Al | S | N | Mn | Ni | Co | Pt | Pb | Cu | Au | Cr | Mg | B | O | (1) |
| 301 | 0.0005 | 3.18 | 0.001 | 0.0003 | 0.0001 | 0.01 | — | — | — | — | — | — | 0.002 | — | — | — | −3.17 |
| 302 | 0.0005 | 3.20 | 0.001 | 0.0002 | 0.0003 | — | 0.02 | — | — | — | — | — | 0.003 | — | — | — | −3.19 |
| 303 | 0.0004 | 3.19 | 0.001 | 0.0001 | 0.0002 | — | — | 0.02 | — | — | — | — | 0.002 | — | — | — | −3.17 |
| 304 | 0.0005 | 3.21 | 0.001 | 0.0003 | 0.0002 | — | — | — | 0.02 | — | — | — | 0.003 | — | — | — | −3.19 |
| 305 | 0.0005 | 3.21 | 0.002 | 0.0002 | 0.0001 | — | — | — | — | 0.02 | — | — | 0.003 | — | — | — | −3.20 |
| 306 | 0.0005 | 3.21 | 0.002 | 0.0001 | 0.0002 | — | — | — | — | — | 0.01 | — | 0.003 | — | — | — | −3.19 |
| 307 | 0.0005 | 3.20 | 0.002 | 0.0001 | 0.0002 | — | — | — | — | — | — | 0.02 | 0.003 | — | — | — | −3.18 |
| 308 | 0.0004 | 3.18 | 0.001 | 0.0002 | 0.0001 | 0.02 | — | — | — | — | — | — | 0.003 | — | — | — | −3.17 |
| 309 | 0.0006 | 3.21 | 0.002 | 0.0002 | 0.0002 | 0.01 | — | — | — | — | — | — | 0.003 | — | — | — | −3.20 |
| 310 | 0.0006 | 3.18 | 0.002 | 0.0002 | 0.0002 | 0.01 | — | — | — | — | — | — | 0.002 | — | — | — | −3.17 |
| 311 | 0.0004 | 3.20 | 0.001 | 0.0002 | 0.0003 | 0.02 | — | — | — | — | — | — | 0.002 | — | — | — | −3.18 |
| 312 | 0.0005 | 3.19 | 0.001 | 0.0003 | 0.0001 | 0.01 | — | — | — | — | — | — | 0.004 | — | — | — | −3.18 |
| 313 | 0.0005 | 3.20 | 0.002 | 0.0002 | 0.0002 | 0.02 | — | — | — | — | — | — | 0.002 | — | — | — | −3.18 |
| 314 | 0.0004 | 3.20 | 0.001 | 0.0002 | 0.0003 | 0.01 | — | — | — | — | — | — | 0.004 | — | — | — | −3.18 |
| 315 | 0.0005 | 3.19 | 0.001 | 0.0001 | 0.0001 | 0.01 | — | — | — | — | — | — | 0.004 | — | — | — | −3.18 |
| 316 | 0.0005 | 2.01 | 0.001 | 0.0017 | 0.0017 | 2.40 | — | — | — | — | — | — | 0.003 | — | — | — | 0.39 |
| 317 | 0.0085 | 3.23 | 0.603 | 0.0020 | 0.0020 | 0.01 | — | — | — | — | — | — | 0.003 | — | — | — | −3.81 |
| 318 | 0.0010 | 1.60 | 0.603 | 0.0020 | 0.0018 | 0.01 | — | — | — | — | — | — | 0.003 | — | — | — | −2.19 |
| 319 | 0.0011 | 3.89 | 0.603 | 0.0020 | 0.0019 | 0.01 | — | — | — | — | — | — | 0.002 | — | — | — | −4.49 |
| 320 | 0.0008 | 3.22 | 2.801 | 0.0018 | 0.0021 | 0.01 | — | — | — | — | — | — | 0.003 | — | — | — | −-6.01 |

TABLE 5B

| | | | | | Inter- | | | | | | | |
|---|---|---|---|---|---|---|---|---|---|---|---|---|
| | Sheet | | | | mediate | | | | | | | |
| | thickness | | Rolling | | annealing | | | | | First heat treatment | | |
| | (mm) | | reduction | | Anneal- | | | | | Anneal- | | |
| | | After | (%) | | ing | | | | | ing | Anneal- | |
| | Before | skin | | Skin | temper- | EBSD observation result | | | | temper- | ing | |
| | cold | pass | Cold | pass | ature | after skin pass rolling | | | | ature | time | |
| No. | rolling | rolling | rolling | rolling | (° C.) | S [symbol] /S [symbol] | S₄₁₁/S [symbol] | S₄₁₁/S [symbol] | K₄₁₁/K [symbol] | (° C.) | (s) | Note |
| 301 | 0.30 | 0.15 | 42 | 14 | 800 | 073 | 0.16 | 0.72 | 0.980 | 1050 | 30 | Invention Example |
| 302 | 0.30 | 0.15 | 42 | 14 | 800 | 0.72 | 0.15 | 0.71 | 0.981 | 800 | 7200 | Invention Example |
| 303 | 0.30 | 0.15 | 42 | 14 | 800 | 0.73 | 0.14 | 0.72 | 0.981 | 1050 | 30 | Invention Example |
| 304 | 0.30 | 0.15 | 42 | 14 | 800 | 0.72 | 0.15 | 0.73 | 0.984 | 1050 | 30 | Invention Example |
| 305 | 0.30 | 0.15 | 42 | 14 | 800 | 0.73 | 0.15 | 0.72 | 0.977 | 1050 | 30 | Invention Example |
| 306 | 0.30 | 0.15 | 42 | 14 | 800 | 0.73 | 0.16 | 0.71 | 0.984 | 1050 | 30 | Invention Example |
| 307 | 0.30 | 0.15 | 42 | 14 | 800 | 0.72 | 0.13 | 0.72 | 0.978 | 1050 | 30 | Invention Example |
| 308 | 0.30 | 0.15 | 42 | 14 | 800 | 0.71 | 0.14 | 0.73 | 0.981 | 1050 | 30 | Invention Example |
| 309 | 0.32 | 0.15 | 42 | 18 | 800 | 0.71 | 0.14 | 0.70 | 0.982 | 1050 | 30 | Invention Example |
| 310 | 0.29 | 0.15 | 42 | 10 | 800 | 0.71 | 0.16 | 0.72 | 0.985 | 1050 | 30 | Invention Example |
| 311 | 0.43 | 0.15 | 60 | 14 | 800 | 0.73 | 0.03 | 0.72 | 0.979 | 1050 | 30 | Comparative Example |
| 312 | 0.22 | 0.15 | 15 | 14 | 800 | 0.72 | 0.15 | 0.32 | 0.980 | 1050 | 30 | Comparative Example |
| 313 | 0.27 | 0.15 | 42 | 3 | 800 | 0.74 | 0.16 | 0.54 | 1.008 | 1050 | 30 | Comparative Example |
| 314 | 0.40 | 0.15 | 42 | 35 | 800 | 0.81 | 0.16 | 0.73 | 1.003 | 1050 | 30 | Comparative Example |
| 315 | 0.30 | 0.15 | 42 | 14 | 550 | 0.15 | 0.06 | 0.20 | 0.978 | 1050 | 30 | Comparative Example |
| 316 | 0.30 | 0.15 | 42 | 14 | 800 | 0.90 | 0.03 | 0.72 | 0.980 | 1050 | 30 | Comparative Example |
| 317 | 0.30 | 0.15 | 42 | 14 | 800 | 0.71 | 0.16 | 0.72 | 0.980 | 1050 | 30 | Invention Example |
| 318 | 0.30 | 0.15 | 42 | 14 | 800 | 0.71 | 0.16 | 0.74 | 0.982 | 1050 | 30 | Invention Example |
| 319 | 0.30 | 0.15 | 42 | 14 | 800 | 0.71 | 0.16 | 0.74 | 0.983 | 1050 | 30 | Invention Example |
| 320 | 0.30 | 0.15 | 42 | 14 | 800 | 0.71 | 0.16 | 0.74 | 0.979 | 1050 | 30 | Invention Example |

[symbol]

indicates data missing or illegible when filed

TABLE 5C

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Laft side |
| | | | | | | | | | | | | | | | | | of |
| | | | | | | | | | | | | | | | | | Formula |
| No. | C | Si | sol. Al | S | N | Mn | Ni | Co | Pt | Pb | Cu | Au | Cr | Mg | B | O | (1) |
| 321 | 0.0011 | 3.22x | 0.603 | 0.0003 | 0.0020 | 0.01 | — | — | — | — | — | — | 0.002 | — | — | — | −3.81 |
| 322 | 0.0010 | 3.22 | 0.604 | 0.0094 | 0.0020 | 0.01 | — | — | — | — | — | — | 0.004 | — | — | — | −3.81 |
| 323 | 0.0010 | 3.22 | 0.604 | 0.0017 | 0.0093 | 0.01 | — | — | — | — | — | — | 0.003 | — | — | — | −3.81 |
| 324 | 0.0009 | 3.22 | 0.603 | 0.0021 | 0.0021 | 0.01 | — | — | — | — | — | — | 0.004 | 0.0005 | — | — | −3.81 |
| 325 | 0.0009 | 3.23 | 0.604 | 0.0019 | 0.0018 | 0.01 | — | — | — | — | — | — | 0.003 | 0.0092 | — | — | −3.81 |
| 326 | 0.0011 | 3.21 | 0.604 | 0.0020 | 0.0019 | 0.01 | — | — | — | — | — | — | — | — | — | — | −3.81 |
| 327 | 0.0010 | 3.22 | 0.604 | 0.0019 | 0.0020 | 0.01 | — | — | — | — | — | — | 0.094 | — | — | — | −3.81 |
| 328 | 0.0010 | 3.22 | 2.801 | 0.0017 | 0.0019 | 2.40 | — | — | — | — | — | — | 0.004 | — | — | — | −3.62 |
| 329 | 0.0009 | 3.21 | 0.608 | 0.0018 | 0.0019 | 0.22 | — | — | — | — | — | — | 0.003 | — | 0.0002 | — | −3.61 |
| 330 | 0.0010 | 3.23 | 0.604 | 0.0020 | 0.0021 | 0.21 | — | — | — | — | — | — | 0.004 | — | 0.0044 | — | −3.61 |
| 331 | 0.0011 | 3.23 | 0.603 | 0.0020 | 0.0021 | 0.22 | — | — | — | — | — | — | 0.004 | — | — | 0.0013 | −3.61 |
| 332 | 0.0009 | 3.21 | 0.604 | 0.0017 | 0.0021 | 0.21 | — | — | — | — | — | — | 0.003 | — | — | 0.0170 | −3.61 |
| 333 | 0.0118 | 3.22 | 0.604 | 0.0021 | 0.0019 | 0.21 | — | — | — | — | — | — | 0.002 | — | — | — | −3.61 |
| 334 | 0.0011 | 1.39 | 0.605 | 0.0020 | 0.0021 | 0.21 | — | — | — | — | — | — | 0.003 | — | — | — | −1.79 |
| 335 | 0.0011 | 4.21 | 0.604 | 0.0019 | 0.0019 | 0.21 | — | — | — | — | — | — | 0.003 | — | — | — | −4.59 |
| 336 | 0.0007 | 3.23 | 4.203 | 0.0019 | 0.0021 | 0.21 | — | — | — | — | — | — | 0.002 | — | — | — | −6.20 |
| 337 | 0.0008 | 3.22 | 0.603 | 0.0449 | 0.0020 | 0.22 | — | — | — | — | — | — | 0.002 | — | — | — | −3.61 |
| 338 | 0.0011 | 3.22 | 0.605 | 0.0019 | 0.0121 | 0.22 | — | — | — | — | — | — | 0.004 | — | — | — | −3.61 |
| 339 | 0.0010 | 3.23 | 0.604 | 0.0017 | 0.0018 | 0.22 | — | — | — | — | — | — | 0.003 | 0.012 | — | — | −3.61 |
| 340 | 0.0008 | 3.23 | 0.603 | 0.0018 | 0.0022 | 0.21 | — | — | — | — | — | — | 0.119 | — | — | — | −3.61 |
| 341 | 0.0011 | 3.22 | 0.603 | 0.0017 | 0.0020 | 2.60 | — | — | — | — | — | — | 0.003 | — | — | — | −1.22 |
| 342 | 0.0006 | 3.19 | 0.001 | 0.0004 | 0.0002 | 0.01 | — | — | — | — | — | — | 0.002 | — | | | −3.17 |

TABLE 5D

| | | | | | Inter- | | | | | | | |
|---|---|---|---|---|---|---|---|---|---|---|---|---|
| | Sheet | | | | mediate | | | | | | | |
| | thickness | | Rolling | | annealing | | | | | Second heat treatment | | |
| | (mm) | | reduction | | Anneal- | | | | | Anneal- | | |
| | | After | (%) | | ing | | | | | ing | Anneal- | |
| | Before | skin | | Skin | temper- | EBSD observation result | | | | temper- | ing | |
| | cold | pass | Cold | pass | ature | after skin pass rolling | | | | ature | time | |
| No. | rolling | rolling | rolling | rolling | (° C.) | S [symbol] /S [symbol] | S₄₁₁/S [symbol] | S₄₁₁/S [symbol] | K₄₁₁/K [symbol] | (° C.) | (s) | Note |
| 321 | 0.30 | 0.15 | 42 | 14 | 800 | 0.71 | 0.16 | 0.73 | 0.978 | 1050 | 30 | Invention |
| | | | | | | | | | | | | Example |
| 322 | 0.30 | 0.15 | 42 | 14 | 800 | 0.72 | 0.16 | 0.72 | 0.982 | 1050 | 30 | Invention |
| | | | | | | | | | | | | Example |
| 323 | 0.30 | 0.15 | 42 | 14 | 800 | 0.71 | 0.16 | 0.73 | 0.980 | 1050 | 30 | Invention |
| | | | | | | | | | | | | Example |
| 324 | 0.30 | 0.15 | 42 | 14 | 800 | 0.71 | 0.16 | 0.74 | 0.982 | 1050 | 30 | Invention |
| | | | | | | | | | | | | Example |
| 325 | 0.30 | 0.15 | 42 | 14 | 800 | 0.72 | 0.16 | 0.73 | 0.982 | 1050 | 30 | Invention |
| | | | | | | | | | | | | Example |
| 326 | 0.30 | 0.15 | 42 | 14 | 800 | 0.71 | 0.16 | 0.74 | 0.982 | 1050 | 30 | Invention |
| | | | | | | | | | | | | Example |
| 327 | 0.30 | 0.15 | 42 | 14 | 800 | 0.71 | 0.16 | 0.73 | 0.979 | 1050 | 30 | Invention |
| | | | | | | | | | | | | Example |
| 328 | 0.30 | 0.15 | 42 | 14 | 800 | 0.73 | 0.16 | 0.74 | 0.981 | 1050 | 30 | Invention |
| | | | | | | | | | | | | Example |
| 329 | 0.30 | 0.15 | 42 | 14 | 800 | 0.72 | 0.16 | 0.73 | 0.981 | 1050 | 30 | Invention |
| | | | | | | | | | | | | Example |
| 330 | 0.30 | 0.15 | 42 | 14 | 800 | 0.71 | 0.16 | 0.73 | 0.978 | 1050 | 30 | Invention |
| | | | | | | | | | | | | Example |
| 331 | 0.30 | 0.15 | 42 | 14 | 800 | 0.72 | 0.16 | 0.74 | 0.979 | 1050 | 30 | Invention |
| | | | | | | | | | | | | Example |
| 332 | 0.30 | 0.15 | 42 | 14 | 800 | 0.72 | 0.16 | 0.72 | 0.977 | 1050 | 30 | Invention |
| | | | | | | | | | | | | Example |
| 333 | 0.30 | 0.15 | 42 | 14 | 800 | 0.89 | 0.03 | 0.72 | 0.978 | 1050 | 30 | Comparative |
| | | | | | | | | | | | | Example. |
| 334 | 0.30 | 0.15 | 42 | 14 | 800 | 0.89 | 0.03 | 0.71 | 0.983 | 1050 | 30 | Comparative |
| | | | | | | | | | | | | Example |
| 335 | 0.30 | 0.15 | 42 | Cracking occurs during cold rolling | | | | | | | | Comparative |
| | | | | | | | | | | | | Example |
| 336 | 0.30 | 0.15 | 42 | Cracking occurs during cold rolling | | | | | | | | Comparative |
| | | | | | | | | | | | | Example |
| 337 | 0.30 | 0.15 | 42 | 14 | 800 | 0.89 | 0.03 | 0.71 | 0.982 | 1050 | 30 | Comparative |
| | | | | | | | | | | | | Example |
| 338 | 0.30 | 0.15 | 42 | 14 | 800 | 0.89 | 0.03 | 0.71 | 0.979 | 1050 | 30 | Comparative |
| | | | | | | | | | | | | Example |
| 339 | 0.30 | 0.15 | 42 | 14 | 800 | 0.88 | 0.03 | 0.72 | 0.983 | 1050 | 30 | Comparative |
| | | | | | | | | | | | | Example |
| 340 | 0.30 | 0.15 | 42 | 14 | 800 | 0.89 | 0.03 | 0.72 | 0.980 | 1050 | 30 | Comparative |
| | | | | | | | | | | | | Example |
| 341 | 0.30 | 0.15 | 42 | Cracking occurs during cold rolling | | | | | | | | Comparative |
| | | | | | | | | | | | | Example |
| 342 | 0.30 | 0.15 | 42 | 14 | 800 | 0.72 | 0.16 | 0.74 | 0.982 | 960 | 30 | Invention |
| | | | | | | | | | | | | Example |

[symbol]

indicates data missing or illegible when filed

TABLE 6

| | | | | | | | After second | | |
|---|---|---|---|---|---|---|---|---|---|
| | | | | | | | heat treatment | | |
| | | | | | | | | W10/W400 | |
| | | | | | | | | (whole direction | |
| | EBSD observation result after second heat treatment | | | | | | W10/400 | average) | |
| No. | S [symbol] /S [symbol] | S₄₁₁/S [symbol] | S₄₁₁/S [symbol] | d₄₁₁/d [symbol] | d₄₁₁/d [symbol] | d₄₁₁/d [symbol] | (W/kg) | (W/kg) | Note |
| 301 | 0.45 | 0.35 | 0.77 | 1.02 | 1.04 | 0.98 | 9.5 | 9.7 | Invention Example |
| 302 | 0.46 | 0.34 | 0.77 | 1.02 | 1.03 | 0.98 | 9.6 | 9.8 | Invention Example |
| 308 | 0.47 | 0.35 | 0.76 | 1.01 | 1.04 | 0.98 | 9.6 | 9.8 | Invention Example |
| 304 | 0.46 | 0.35 | 0.76 | 1.02 | 1.04 | 0.98 | 9.7 | 9.9 | Invention Example |
| 305 | 0.45 | 0.36 | 0.77 | 1.01 | 1.03 | 0.99 | 9.7 | 9.9 | Invention Example |
| 306 | 0.45 | 0.33 | 0.78 | 1.02 | 1.05 | 0.98 | 9.6 | 9.8 | Invention Example |
| 307 | 0.46 | 0.36 | 0.78 | 1.03 | 1.04 | 0.99 | 9.5 | 9.7 | Invention Example |
| 308 | 0.45 | 0.35 | 0.76 | 1.02 | 1.03 | 0.99 | 9.6 | 9.8 | Invention Example |
| 309 | 0.45 | 0.35 | 0.78 | 1.02 | 1.03 | 0.99 | 9.6 | 9.8 | Invention Example |
| 310 | 0.46 | 0.35 | 0.78 | 1.02 | 1.05 | 0.98 | 9.6 | 9.8 | Invention Example |
| 311 | 0.64 | 0.36 | 0.76 | 1.01 | 1.04 | 0.99 | 12.3 | 12.7 | Comparative Example |
| 312 | 0.47 | 0.20 | 0.62 | 1.02 | 1.03 | 0.98 | 12.2 | 12.6 | Comparative Example |
| 313 | 0.46 | 0.36 | 0.32 | 0.94 | 1.05 | 0.98 | 12.2 | 12.6 | Comparative Example |
| 314 | 0.47 | 0.35 | 0.78 | 1.01 | 0.94 | 0.98 | 12.2 | 12.6 | Comparative Example |
| 315 | 0.45 | 0.31 | 0.56 | 1.02 | 0.93 | 0.93 | 12.1 | 12.5 | Comparative Example |
| 316 | 0.84 | 0.03 | 0.75 | 1.01 | 1.03 | 0.98 | 14.2 | 14.6 | Comparative Example |
| 317 | 0.45 | 0.35 | 0.76 | 1.02 | 1.04 | 0.97 | 9.8 | 10.1 | Invention Example |
| 318 | 0.45 | 0.35 | 0.76 | 1.01 | 1.05 | 0.97 | 9.9 | 10.2 | Invention Example |
| 319 | 0.45 | 0.35 | 0.77 | 1.01 | 1.04 | 0.97 | 9.3 | 9.5 | Invention Example |
| 320 | 0.45 | 0.34 | 0.78 | 1.02 | 1.05 | 0.98 | 9.2 | 9.5 | Invention Example |
| 321 | 0.44 | 0.35 | 0.77 | 1.03 | 1.05 | 0.97 | 9.5 | 9.6 | Invention Example |
| 322 | 0.44 | 0.34 | 0.76 | 1.02 | 1.04 | 0.97 | 9.8 | 10.1 | Invention Example |
| 323 | 0.45 | 0.36 | 0.77 | 1.01 | 1.05 | 0.97 | 9.9 | 10.1 | Invention Example |
| 324 | 0.45 | 0.35 | 0.77 | 1.02 | 1.05 | 0.97 | 9.5 | 9.7 | Invention Example |
| 325 | 0.46 | 0.36 | 0.78 | 1.03 | 1.04 | 0.97 | 9.5 | 9.8 | Invention Example |
| 326 | 0.45 | 0.35 | 0.78 | 1.02 | 1.05 | 0.99 | 9.6 | 9.8 | Invention Example |
| 327 | 0.44 | 0.35 | 0.77 | 1.03 | 1.03 | 0.98 | 9.5 | 9.7 | Invention Example |
| 328 | 0.45 | 0.35 | 0.78 | 1.02 | 1.05 | 0.98 | 9.5 | 9.7 | Invention Example |
| 329 | 0.45 | 0.36 | 0.76 | 1.01 | 1.04 | 0.98 | 9.6 | 9.7 | Invention Example |
| 330 | 0.44 | 0.35 | 0.76 | 1.03 | 1.04 | 0.98 | 9.6 | 9.8 | Invention Example |
| 331 | 0.46 | 0.35 | 0.78 | 1.02 | 1.05 | 0.98 | 9.5 | 9.8 | Invention Example |
| 332 | 0.45 | 0.36 | 0.77 | 1.02 | 1.04 | 0.97 | 9.6 | 9.8 | Invention Example |
| 333 | 0.83 | 0.02 | 0.76 | 1.00 | 1.03 | 0.97 | 14.2 | 14.7 | Comparative Example |
| 334 | 0.84 | 0.02 | 0.75 | 1.01 | 1.03 | 0.97 | 14.3 | 14.6 | Comparative Example |
| 335 | Not evaluated since cracking occurs during cold rolling | | | | | | | | Comparative Example |
| 336 | Not evaluated since cracking occurs during cold rolling | | | | | | | | Comparative Example |
| 337 | 0.85 | 0.03 | 0.74 | 1.00 | 1.04 | 0.98 | 14.2 | 14.6 | Comparative Example |
| 338 | 0.84 | 0.02 | 0.75 | 1.00 | 1.04 | 0.98 | 14.2 | 14.5 | Comparative Example |
| 339 | 0.84 | 0.03 | 0.74 | 1.01 | 1.04 | 0.97 | 14.2 | 14.5 | Comparative Example |
| 340 | 0.83 | 0.03 | 0.76 | 1.01 | 1.03 | 0.98 | 14.1 | 14.6 | Comparative Example |
| 341 | Not evaluated since cracking occurs during cold rolling | | | | | | | | Comparative Example |
| 342 | 0.44 | 0.36 | 0.78 | 1.01 | 1.03 | 0.93 | 9.8 | 10.1 | Invention Example |

[symbol]

indicates data missing or illegible when filed

Underlined values in Table 5A to Table 5D and Table 6 indicate conditions deviating from the scope of the present invention. In all of No. 301 to No. 310, No. 317 to No. 332, and No. 342, which are invention examples, the iron losses W10/400 and W10/400 (whole direction) were favorable values.

On the other hand, in No. 311 to No. 316, which are comparative examples, since Formula (1) was not satisfied, or at least any of the temperature in the intermediate annealing, the rolling reduction in the cold rolling, and the rolling reduction in the skin pass rolling was not optimal, at least one of Formula (20) to Formula (24) was not satisfied, and, as a result, the iron losses W10/400 and W10/400 (whole direction) were high.

In addition, in No. 333 to No. 341, which are comparative examples, since the chemical compositions were outside the scope of the present invention, cracking occurred during the cold rolling, or Formula (20) and Formula (21) were not satisfied, and, as a result, the iron losses W10/400 and W10/400 (whole direction) were high.

### Fourth Example

Materials having chemical compositions shown in Table 7A and Table 7C (a non-oriented electrical steel sheet only in No. 416, and materials obtained by cutting out Goss orientated grains from a single crystal into a sheet shape in Nos. 423 to 448. Grain-oriented electrical steel sheets in others) were produced. Here, the column “Left side of Formula (1)” indicates the values of the left side of Formula (1) described above. After that, cold rolling was performed in the width direction of the materials (in the case of being cut out from a single crystal, a direction parallel to a <110> direction) to obtain cold-rolled sheets. The produced grain-oriented electrical steel sheets were cold-rolled in the width direction after insulating films were removed. The rolling reductions in the cold rolling at that time are shown in Table 7B and Table 7D.

Intermediate annealing was performed on the cold-rolled sheets in a non-oxidizing atmosphere at temperatures shown in Table 7B and Table 7D for 30 seconds, and then the second round of cold rolling (skin pass rolling) was performed at rolling reductions shown in Table 7B and Table 7D. This skin pass rolling was performed in the same direction as in the cold rolling.

Next, a first heat treatment was performed under conditions of 800° C. and 30 seconds.

After the first heat treatment, in order to investigate the texture, a part of each of the steel sheets was cut, the cut test piece was processed to reduce the thickness to ½, and EBSD observation (step intervals: 100 nm) was performed on the processed surface in the above-described manner. The areas, average KAM values, and average grain sizes of each kind of orientated grains were obtained by EBSD observation, and S_{tyl}/Sₜₒₜ, S₄₁₁/Sₜₒₜ, S₄₁₁/Sₜᵣₐ, K₄₁₁/K_{tyl}, d₄₁₁/dₐᵥₑ, and d₄₁₁/d_{tyl} were obtained.

On the steel sheets after the first heat treatment, a second heat treatment was performed under conditions shown in Table 7B and Table 7D. After the second heat treatment, in order to investigate the textures, a part of each of the steel sheets was cut, the cut test piece was processed to reduce the thickness to ½, and EBSD observation was performed on the processed surface. The areas and average grain sizes of kinds shown in Table 8 were obtained by EBSD observation.

In addition, from each of the steel sheets after the second heat treatment, 55 mm×55 mm sample pieces were collected as measurement samples. At this time, a sample in which one side of the sample piece was parallel to a rolling direction and a sample in which one side was inclined at 45 degrees with respect to the rolling direction were collected. In addition, the samples were collected using a shearing machine. Additionally, as magnetic characteristics, the iron losses W 10/400 (the average value of the rolling direction and the width direction) and W10/400 (whole direction) (the average value of the rolling direction, the width direction, a direction at 45 degrees with respect to the rolling direction, and a direction at 135 degrees with respect to the rolling direction) were measured in the same manner as in First Example. The measurement results are shown in Table 8.

TABLE 7A

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Laft side |
| | | | | | | | | | | | | | | | | | of |
| | | | | | | | | | | | | | | | | | Formula |
| No. | C | Si | sol. Al | S | N | Mn | Ni | Co | Pt | Pb | Cu | Au | Cr | Mg | B | O | (1) |
| 401 | 0.0005 | 3.20 | 0.001 | 0.0003 | 0.0001 | 0.01 | — | — | — | — | — | — | 0.004 | — | — | — | −3.19 |
| 402 | 0.0005 | 3.21 | 0.001 | 0.0002 | 0.0003 | — | 0.02 | — | — | — | — | — | 0.002 | — | — | — | −3.19 |
| 403 | 0.0004 | 3.20 | 0.001 | 0.0002 | 0.0002 | — | — | 0.01 | — | — | — | — | 0.003 | — | — | — | −3.19 |
| 404 | 0.0006 | 3.19 | 0.002 | 0.0002 | 0.0002 | — | — | — | 0.01 | — | — | — | 0.002 | — | — | — | −3.18 |
| 405 | 0.0005 | 3.20 | 0.002 | 0.0002 | 0.0002 | — | — | — | — | 0.02 | — | — | 0.003 | — | — | — | −3.19 |
| 406 | 0.0004 | 3.21 | 0.002 | 0.0002 | 0.0002 | — | — | — | — | — | 0.01 | — | 0.003 | — | — | — | −3.20 |
| 407 | 0.0006 | 3.21 | 0.001 | 0.0002 | 0.0002 | — | — | — | — | — | — | 0.01 | 0.004 | — | — | — | −3.20 |
| 408 | 0.0004 | 3.19 | 0.002 | 0.0002 | 0.0002 | 0.01 | — | — | — | — | — | — | 0.003 | — | — | — | −3.18 |
| 409 | 0.0006 | 3.20 | 0.001 | 0.0002 | 0.0002 | 0.01 | — | — | — | — | — | — | 0.003 | — | — | — | −3.19 |
| 410 | 0.0004 | 3.19 | 0.001 | 0.0002 | 0.0003 | 0.02 | — | — | — | — | — | — | 0.004 | — | — | — | −3.18 |
| 411 | 0.0005 | 3.20 | 0.001 | 0.0001 | 0.0003 | 0.02 | — | — | — | — | — | — | 0.002 | — | — | — | −3.19 |
| 412 | 0.0005 | 3.20 | 0.001 | 0.0002 | 0.0001 | 0.01 | — | — | — | — | — | — | 0.003 | — | — | — | −3.19 |
| 413 | 0.0005 | 3.21 | 0.001 | 0.0003 | 0.0003 | 0.01 | — | — | — | — | — | — | 0.002 | — | — | — | −3.19 |
| 414 | 0.0004 | 3.20 | 0.001 | 0.0001 | 0.0001 | 0.02 | — | — | — | — | — | — | 0.003 | — | — | — | −3.18 |
| 415 | 0.0005 | 3.19 | 0.001 | 0.0003 | 0.0003 | 0.01 | — | — | — | — | — | — | 0.002 | — | — | — | −3.18 |
| 416 | 0.0005 | 2.02 | 0.002 | 0.0016 | 0.0018 | 2.41 | — | — | — | — | — | — | 0.003 | — | — | — | 0.39 |
| 417 | 0.0006 | 3.20 | 0.001 | 0.0002 | 0.0001 | 0.01 | — | — | — | — | — | — | 0.004 | — | — | — | −3.19 |
| 418 | 0.0005 | 3.21 | 0.001 | 0.0002 | 0.0001 | 0.01 | — | — | — | — | — | — | 0.004 | — | — | — | −3.20 |
| 419 | 0.0003 | 3.20 | 0.001 | 0.0002 | 0.0001 | 0.01 | — | — | — | — | — | — | 0.003 | — | — | — | −3.19 |
| 420 | 0.0007 | 3.21 | 0.001 | 0.0003 | 0.0001 | 0.01 | — | — | — | — | — | — | 0.003 | — | — | — | −3.20 |
| 421 | 0.0004 | 3.19 | 0.001 | 0.0002 | 0.0001 | 0.01 | — | — | — | — | — | — | 0.003 | — | — | — | −3.18 |
| 422 | 0.0004 | 3.19 | 0.001 | 0.0003 | 0.0001 | 0.01 | — | — | — | — | — | — | 0.004 | — | — | — | −3.18 |
| 423 | 0.0085 | 3.21 | 0.604 | 0.0017 | 0.0019 | 0.01 | — | — | — | — | — | — | 0.003 | — | — | — | −3.81 |
| 424 | 0.0012 | 1.61 | 0.604 | 0.0019 | 0.0020 | 0.01 | — | — | — | — | — | — | 0.003 | — | — | — | −2.19 |
| 425 | 0.0010 | 3.90 | 0.604 | 0.0018 | 0.0021 | 0.01 | — | — | — | — | — | — | 0.003 | — | — | — | −4.49 |

TABLE 7B

| | | | | | Inter- | | | | | | | | | |
|---|---|---|---|---|---|---|---|---|---|---|---|---|---|---|
| | Sheet | | | | mediate | | | | | | | Second heat | | |
| | thickness | | Rolling | | annealing | | | | | | | treatment | | |
| | (mm) | | reduction | | Anneal- | | | | | | | Anneal- | | |
| | | After | (%) | | ing | EBSD observation result | | | | | | ing | Anneal- | |
| | Before | skin | | Skin | temper- | after first heat treatment | | | | | | temper- | ing | |
| | cold | pass | Cold | pass | ature | S [symbol] / | S₄₁₁/ | S₄₁₁/ | K₄₁₁/ | d₄₁₁/ | d₄₁₁/ | ature | time | |
| No. | rolling | rolling | rolling | rolling | (° C.) | S [symbol] | S [symbol] | S [symbol] | K [symbol] | d [symbol] | d [symbol] | (° C.) | (s) | Note |
| 401 | 0.30 | 0.15 | 42 | 14 | 800 | 0.63 | 0.30 | 0.84 | 0.965 | 1.29 | 1.49 | 1050 | 30 | Invention |
| | | | | | | | | | | | | | | Example |
| 402 | 0.30 | 0.15 | 42 | 14 | 800 | 0.66 | 0.30 | 0.84 | 0.958 | 1.29 | 1.50 | 800 | 7200 | Invention |
| | | | | | | | | | | | | | | Example |
| 403 | 0.30 | 0.15 | 42 | 14 | 800 | 0.65 | 0.28 | 0.84 | 0.965 | 1.29 | 1.49 | 1050 | 30 | Invention |
| | | | | | | | | | | | | | | Example |
| 404 | 0.30 | 0.15 | 42 | 14 | 800 | 0.65 | 0.29 | 0.83 | 0.959 | 1.30 | 1.49 | 1050 | 30 | Invention |
| | | | | | | | | | | | | | | Example |
| 405 | 0.30 | 0.15 | 42 | 14 | 800 | 0.63 | 0.29 | 0.84 | 0.962 | 1.29 | 1.50 | 1050 | 30 | Invention |
| | | | | | | | | | | | | | | Example |
| 406 | 0.30 | 0.15 | 42 | 14 | 800 | 0.64 | 0.28 | 0.84 | 0.962 | 1.28 | 1.50 | 1050 | 30 | Invention |
| | | | | | | | | | | | | | | Example |
| 407 | 0.30 | 0.15 | 42 | 14 | 800 | 0.64 | 0.28 | 0.84 | 0.966 | 1.30 | 1.48 | 1050 | 30 | Invention |
| | | | | | | | | | | | | | | Example |
| 408 | 0.30 | 0.15 | 42 | 14 | 800 | 0.65 | 0.30 | 0.85 | 0.960 | 1.29 | 1.49 | 1050 | 30 | Invention |
| | | | | | | | | | | | | | | Example |
| 409 | 0.32 | 0.15 | 42 | 18 | 800 | 0.64 | 0.28 | 0.84 | 0.960 | 1.28 | 1.50 | 1050 | 30 | Invention |
| | | | | | | | | | | | | | | Example |
| 410 | 0.29 | 0.15 | 42 | 10 | 800 | 0.63 | 0.28 | 0.86 | 0.957 | 1.28 | 1.49 | 1050 | 30 | Invention |
| | | | | | | | | | | | | | | Example |
| 411 | 0.43 | 0.15 | 60 | 14 | 800 | 0.63 | 0.16 | 0.84 | 0.963 | 1.30 | 1.50 | 1050 | 30 | Comparative |
| | | | | | | | | | | | | | | Example |
| 412 | 0.22 | 0.15 | 15 | 14 | 800 | 0.64 | 0.29 | 0.21 | 0.964 | 1.28 | 1.49 | 1050 | 30 | Comparative |
| | | | | | | | | | | | | | | Example |
| 413 | 0.27 | 0.15 | 42 | 3 | 800 | 0.63 | 0.27 | 0.84 | 1.004 | 1.30 | 1.48 | 1050 | 30 | Comparative |
| | | | | | | | | | | | | | | Example |
| 414 | 0.40 | 0.15 | 42 | 35 | 800 | 0.74 | 0.27 | 0.84 | 0.968 | 1.28 | 1.49 | 1050 | 30 | Comparative |
| | | | | | | | | | | | | | | Example |
| 415 | 0.30 | 0.15 | 42 | 14 | 550 | 0.65 | 0.29 | 0.86 | 0.957 | 1.28 | 0.95 | 1050 | 30 | Comparative |
| | | | | | | | | | | | | | | Example |
| 416 | 0.30 | 0.15 | 42 | 14 | 800 | 0.89 | 0.05 | 0.86 | 0.972 | 1.28 | 1.46 | 1050 | 30 | Comparative |
| | | | | | | | | | | | | | | Example |
| 417 | 0.30 | 0.15 | 42 | 14 | 800 | 0.64 | 0.29 | 0.85 | 0.965 | 1.29 | 1.49 | 960 | 30 | Invention |
| | | | | | | | | | | | | | | Example |
| 418 | 0.30 | 0.15 | 42 | 14 | 800 | 0.63 | 0.29 | 0.85 | 0.965 | 1.29 | 1.49 | 1100 | 30 | Comparative |
| | | | | | | | | | | | | | | Example |
| 419 | 0.30 | 0.15 | 42 | 14 | 800 | 0.65 | 0.29 | 0.86 | 0.965 | 1.30 | 1.49 | 750 | 7200 | Invention |
| | | | | | | | | | | | | | | Example |
| 420 | 0.30 | 0.15 | 42 | 14 | 800 | 0.64 | 0.30 | 0.85 | 0.965 | 1.30 | 1.49 | 850 | 7200 | Invention |
| | | | | | | | | | | | | | | Example |
| 421 | 0.30 | 0.15 | 42 | 14 | 800 | 0.64 | 0.30 | 0.85 | 0.965 | 1.30 | 1.49 | 650 | 7200 | Comparative |
| | | | | | | | | | | | | | | Example |
| 422 | 0.30 | 0.15 | 42 | 14 | 800 | 0.65 | 0.28 | 0.85 | 0.965 | 1.30 | 1.49 | 950 | 7200 | Comparative |
| | | | | | | | | | | | | | | Example |
| 423 | 0.30 | 0.15 | 42 | 14 | 800 | 0.64 | 0.29 | 0.84 | 0.965 | 1.30 | 1.49 | 1050 | 30 | Invention |
| | | | | | | | | | | | | | | Example |
| 424 | 0.30 | 0.15 | 42 | 14 | 800 | 0.64 | 0.29 | 0.85 | 0.965 | 1.30 | 1.49 | 1050 | 30 | Invention |
| | | | | | | | | | | | | | | Example |
| 425 | 0.30 | 0.15 | 42 | 14 | 800 | 0.63 | 0.30 | 0.85 | 0.965 | 1.31 | 1.49 | 1050 | 30 | Invention |
| | | | | | | | | | | | | | | Example |

[symbol]

indicates data missing or illegible when filed

TABLE 7C

| | Chemical composition (mass %, remainder is Fe and impurities) | | | | | | | | | | | | | | | | |
|---|---|---|---|---|---|---|---|---|---|---|---|---|---|---|---|---|---|
| | | | | | | | | | | | | | | | | | Laft side |
| | | | | | | | | | | | | | | | | | of |
| | | | | | | | | | | | | | | | | | Formula |
| No. | C | Si | sol. Al | S | N | Mn | Ni | Co | Pt | Pb | Cu | Au | Cr | Mg | B | O | (1) |
| 426 | 0.0009 | 3.22 | 2.800 | 0.0017 | 0.0018 | 0.01 | — | — | — | — | — | — | 0.004 | — | — | — | −6.01 |
| 427 | 0.0008 | 3.21 | 0.604 | 0.0005 | 0.0020 | 0.01 | — | — | — | — | — | — | 0.003 | — | — | — | −3.81 |
| 428 | 0.0009 | 3.23 | 0.604 | 0.0092 | 0.0019 | 0.01 | — | — | — | — | — | — | 0.003 | — | — | — | −3.81 |
| 429 | 0.0010 | 3.23 | 0.604 | 0.0019 | 0.0091 | 0.01 | — | — | — | — | — | — | 0.004 | — | — | — | −3.81 |
| 430 | 0.0010 | 3.22 | 0.604 | 0.0019 | 0.0019 | 0.01 | — | — | — | — | — | — | 0.003 | 0.0005 | — | — | −3.81 |
| 431 | 0.0009 | 3.22 | 0.604 | 0.0018 | 0.0018 | 0.01 | — | — | — | — | — | — | 0.004 | 0.0092 | — | — | −3.81 |
| 432 | 0.0007 | 3.22 | 0.604 | 0.0018 | 0.0022 | 0.01 | — | — | — | — | — | — | — | — | — | — | −3.81 |
| 433 | 0.0010 | 3.22 | 0.604 | 0.0017 | 0.0018 | 0.01 | — | — | — | — | — | — | 0.094 | — | — | — | −3.81 |
| 434 | 0.0010 | 3.23 | 2.800 | 0.0017 | 0.0019 | 2.41 | — | — | — | — | — | — | 0.003 | — | — | — | −3.62 |
| 435 | 0.0009 | 3.22 | 0.604 | 0.0019 | 0.0020 | 0.22 | — | — | — | — | — | — | 0.003 | — | 0.0002 | — | −3.61 |
| 436 | 0.0008 | 3.22 | 0.604 | 0.0020 | 0.0020 | 0.21 | — | — | — | — | — | — | 0.003 | — | 0.0045 | — | −3.61 |
| 437 | 0.0008 | 3.21 | 0.604 | 0.0020 | 0.0021 | 0.22 | — | — | — | — | — | — | 0.003 | — | — | 0.0013 | −3.61 |
| 438 | 0.0009 | 3.22 | 0.604 | 0.0020 | 0.0018 | 0.22 | — | — | — | — | — | — | 0.003 | — | — | 0.0170 | −3.61 |
| 439 | 0.0122 | 3.21 | 0.604 | 0.0018 | 0.0020 | 0.21 | — | — | — | — | — | — | 0.003 | — | — | — | −3.61 |
| 440 | 0.0010 | 1.40 | 0.604 | 0.0019 | 0.0021 | 0.21 | — | — | — | — | — | — | 0.003 | — | — | — | −1.79 |
| 441 | 0.0012 | 4.21 | 0.604 | 0.0020 | 0.0021 | 0.22 | — | — | — | — | — | — | 0.003 | — | — | — | −4.59 |
| 442 | 0.0012 | 3.22 | 4.2033 | 0.0018 | 0.0020 | 0.22 | — | — | — | — | — | — | 0.003 | — | — | — | −6.20 |
| 443 | 0.0012 | 3.22 | 0.604 | 0.0451 | 0.0019 | 0.21 | — | — | — | — | — | — | 0.002 | — | — | — | −3.61 |
| 444 | 0.0012 | 3.22 | 0.604 | 0.0017 | 0.0121 | 0.22 | — | — | — | — | — | — | 0.004 | — | — | — | −3.61 |
| 445 | 0.0009 | 3.22 | 0.604 | 0.0019 | 0.0018 | 0.22 | — | — | — | — | — | — | 0.002 | 0.0120 | — | — | −3.61 |
| 446 | 0.0007 | 3.23 | 0.604 | 0.0018 | 0.0019 | 0.22 | — | — | — | — | — | — | 0.120 | — | — | — | −3.61 |
| 447 | 0.0010 | 3.23 | 0.604 | 0.0021 | 0.0022 | 2.59 | — | — | — | — | — | — | 0.002 | — | — | — | −1.22 |
| 448 | 0.0005 | 3.17 | 0.001 | 0.0001 | 0.0002 | 0.01 | — | — | — | — | — | — | 0.003 | — | — | — | −3.17 |

TABLE 7D

| | | | | | Inter- | | | | | | | | | |
|---|---|---|---|---|---|---|---|---|---|---|---|---|---|---|
| | Sheet | | | | mediate | | | | | | | Second heat | | |
| | thickness | | Rolling | | annealing | | | | | | | treatment | | |
| | (mm) | | reduction | | Anneal- | | | | | | | Anneal- | | |
| | | After | (%) | | ing | EBSD observation result | | | | | | ing | Anneal- | |
| | Before | skin | | Skin | temper- | after first heat treatment | | | | | | temper- | ing | |
| | cold | pass | Cold | pass | ature | S [symbol] / | S₄₁₁/ | S₄₁₁/ | K₄₁₁/ | d₄₁₁/ | d₄₁₁/ | ature | time | |
| No. | rolling | rolling | rolling | rolling | (° C.) | S [symbol] | S [symbol] | S [symbol] | K [symbol] | d [symbol] | d [symbol] | (° C.) | (s) | Note |
| 426 | 0.30 | 0.15 | 42 | 14 | 800 | 0.65 | 0.29 | 0.84 | 0.965 | 1.30 | 1.49 | 1050 | 30 | Invention Example |
| 427 | 0.30 | 0.15 | 42 | 14 | 800 | 0.64 | 0.30 | 0.85 | 0.965 | 1.29 | 1.49 | 1050 | 30 | Invention Example |
| 428 | 0.30 | 0.15 | 42 | 14 | 800 | 0.63 | 0.29 | 0.84 | 0.965 | 1.30 | 1.49 | 1050 | 30 | Invention Example |
| 429 | 0.30 | 0.15 | 42 | 14 | 800 | 0.63 | 0.29 | 0.84 | 0.965 | 1.30 | 1.49 | 1050 | 30 | Invention Example |
| 430 | 0.30 | 0.15 | 42 | 14 | 800 | 0.64 | 0.28 | 0.84 | 0.965 | 1.29 | 1.49 | 1050 | 30 | Invention Example |
| 431 | 0.30 | 0.15 | 42 | 14 | 800 | 0.63 | 0.30 | 0.85 | 0.965 | 1.29 | 1.49 | 1050 | 30 | Invention Example |
| 432 | 0.30 | 0.15 | 42 | 14 | 800 | 0.64 | 0.29 | 0.85 | 0.965 | 1.30 | 1.49 | 1050 | 30 | Invention Example |
| 433 | 0.30 | 0.15 | 42 | 14 | 800 | 0.64 | 0.29 | 0.85 | 0.965 | 1.30 | 1.49 | 1050 | 30 | Invention Example |
| 434 | 0.30 | 0.15 | 42 | 14 | 800 | 0.63 | 0.29 | 0.84 | 0.965 | 1.30 | 1.49 | 1050 | 30 | Invention Example |
| 435 | 0.30 | 0.15 | 42 | 14 | 800 | 0.63 | 0.29 | 0.85 | 0.965 | 1.31 | 1.49 | 1050 | 30 | Invention Example |
| 436 | 0.30 | 0.15 | 42 | 14 | 800 | 0.65 | 0.29 | 0.84 | 0.965 | 1.29 | 1.49 | 1050 | 30 | Invention Example |
| 437 | 0.30 | 0.15 | 42 | 14 | 800 | 0.64 | 0.29 | 0.84 | 0.965 | 1.30 | 1.49 | 1050 | 30 | Invention Example |
| 438 | 0.30 | 0.15 | 42 | 14 | 800 | 0.64 | 0.28 | 0.86 | 0.965 | 1.30 | 1.49 | 1050 | | Invention Example |
| 439 | 0.30 | 0.15 | 42 | 14 | 800 | 0.89 | 0.05 | 0.86 | 0.972 | 1.27 | 1.46 | 1050 | 30 | Comparative |
| | | | | | | | | | | | | | | Example |
| 440 | 0.30 | 0.15 | 42 | 14 | 800 | 0.88 | 0.05 | 0.87 | 0.972 | 1.28 | 1.46 | 1050 | 30 | Comparative |
| | | | | | | | | | | | | | | Example |
| 441 | 0.30 | 0.15 | 42 | Cracking occurs during cold rolling | | | | | | | | | | Comparative |
| | | | | | | | | | | | | | | Example |
| 442 | 0.30 | 0.15 | 42 | Cracking occurs during cold rolling | | | | | | | | | | Comparative |
| | | | | | | | | | | | | | | Example |
| 443 | 0.30 | 0.15 | 42 | 14 | 800 | 0.87 | 0.05 | 0.87 | 0.972 | 1.28 | 1.46 | 1050 | 30 | Comparative |
| | | | | | | | | | | | | | | Example |
| 444 | 0.30 | 0.15 | 42 | 14 | 800 | 0.89 | 0.05 | 0.86 | 0.972 | 1.28 | 1.46 | 1050 | 30 | Comparative |
| | | | | | | | | | | | | | | Example |
| 445 | 0.30 | 0.15 | 42 | 14 | 800 | 0.87 | 0.05 | 0.86 | 0.972 | 1.28 | 1.46 | 1050 | 30 | Comparative |
| | | | | | | | | | | | | | | Example |
| 446 | 0.30 | 0.15 | 42 | 14 | 800 | 0.88 | 0.05 | 0.87 | 0.972 | 1.28 | 1.46 | 1050 | 30 | Comparative |
| | | | | | | | | | | | | | | Example |
| 447 | 0.30 | 0.15 | 42 | Cracking occurs during cold rolling | | | | | | | | | | Comparative |
| | | | | | | | | | | | | | | Example |
| 448 | 0.30 | 0.15 | 42 | 14 | 800 | 0.63 | 0.30 | 0.84 | 0.965 | 1.29 | 1.49 | 960 | 30 | Invention Example |

[symbol]

indicates data missing or illegible when filed

TABLE 8

| | | | | | | | Second | | |
|---|---|---|---|---|---|---|---|---|---|
| | | | | | | | heat treatment | | |
| | | | | | | | | W10/W400 | |
| | | | | | | | | (whole direction | |
| | EBSD observation result after second heat treatment | | | | | | W10/400 | average) | |
| No. | S [symbol] /S [symbol] | S₄₁₁/S [symbol] | S₄₁₁/S [symbol] | d₄₁₁/d [symbol] | d₄₁₁/d [symbol] | d₄₁₁/d [symbol] | (W/kg) | (W/kg) | Note |
| 401 | 0.46 | 0.34 | 0.77 | 1.01 | 1.04 | 0.98 | 9.6 | 9.8 | Invention Example |
| 402 | 0.45 | 0.34 | 0.76 | 1.02 | 1.03 | 0.98 | 9.5 | 9.7 | Invention Example |
| 403 | 0.46 | 0.35 | 0.77 | 1.02 | 1.04 | 0.98 | 9.7 | 10.0 | Invention Example |
| 404 | 0.46 | 0.35 | 0.78 | 1.02 | 1.03 | 0.99 | 9.6 | 9.7 | Invention Example |
| 405 | 0.45 | 0.34 | 0.78 | 1.02 | 1.03 | 0.98 | 9.7 | 9.9 | Invention Example |
| 406 | 0.46 | 0.34 | 0.78 | 1.02 | 1.04 | 0.98 | 9.7 | 9.8 | Invention Example |
| 407 | 0.45 | 0.35 | 0.77 | 1.02 | 1.04 | 0.99 | 9.7 | 9.9 | Invention Example |
| 408 | 0.46 | 0.35 | 0.76 | 1.02 | 1.04 | 0.98 | 9.7 | 9.9 | Invention Example |
| 409 | 0.46 | 0.34 | 0.76 | 1.01 | 1.04 | 0.98 | 9.7 | 9.9 | Invention Example |
| 410 | 0.46 | 0.35 | 0.78 | 1.02 | 1.04 | 0.99 | 9.5 | 9.6 | Invention Example |
| 411 | 0.64 | 0.35 | 0.76 | 1.03 | 1.04 | 0.99 | 12.1 | 12.5 | Comparative Example |
| 412 | 0.45 | 0.21 | 0.60 | 1.02 | 1.03 | 0.99 | 12.3 | 12.7 | Comparative Example |
| 413 | 0.46 | 0.35 | 0.32 | 0.94 | 1.04 | 0.98 | 12.3 | 12.6 | Comparative Example |
| 414 | 0.45 | 0.34 | 0.78 | 1.03 | 0.93 | 0.98 | 12.2 | 12.5 | Comparative Example |
| 415 | 0.46 | 0.31 | 0.55 | 1.02 | 0.95 | 0.93 | 12.2 | 12.6 | Comparative Example |
| 416 | 0.85 | 0.03 | 0.76 | 1.02 | 1.03 | 0.99 | 14.3 | 14.7 | Comparative Example |
| 417 | 0.45 | 0.35 | 0.78 | 1.02 | 1.04 | 0.98 | 9.7 | 9.8 | Invention Example |
| 418 | 0.65 | 0.35 | 0.76 | 1.03 | 1.05 | 0.99 | 10.2 | 10.5 | Comparative Example |
| 419 | 0.46 | 0.35 | 0.75 | 1.03 | 1.03 | 0.98 | 9.8 | 10.1 | Invention Example |
| 420 | 0.45 | 0.34 | 0.77 | 1.03 | 1.02 | 0.98 | 9.4 | 9.5 | Invention Example |
| 421 | 0.46 | 0.30 | 0.55 | 1.02 | 0.96 | 0.94 | 12.3 | 12.6 | Comparative Example |
| 422 | 0.65 | 0.36 | 0.76 | 1.03 | 1.03 | 0.99 | 10.1 | 10.5 | Comparative Example |
| 423 | 0.45 | 0.35 | 0.77 | 1.01 | 1.04 | 0.98 | 10.0 | 10.2 | Invention Example |
| 424 | 0.46 | 0.34 | 0.76 | 1.02 | 1.04 | 0.98 | 10.0 | 10.2 | Invention Example |
| 425 | 0.46 | 0.34 | 0.77 | 1.02 | 1.05 | 0.97 | 9.3 | 9.6 | Invention Example |
| 426 | 0.46 | 0.34 | 0.77 | 1.02 | 1.04 | 0.98 | 9.4 | 9.4 | Invention Example |
| 427 | 0.45 | 0.34 | 0.78 | 1.01 | 1.04 | 0.97 | 9.5 | 9.7 | Invention Example |
| 428 | 0.46 | 0.34 | 0.77 | 1.01 | 1.03 | 0.98 | 9.9 | 10.2 | Invention Example |
| 429 | 0.46 | 0.34 | 0.78 | 1.01 | 1.04 | 0.97 | 9.9 | 10.1 | Invention Example |
| 430 | 0.45 | 0.34 | 0.77 | 1.01 | 1.05 | 0.97 | 9.6 | 9.7 | Invention Example |
| 431 | 0.45 | 0.35 | 0.77 | 1.01 | 1.03 | 0.97 | 9.6 | 9.9 | Invention Example |
| 432 | 0.45 | 0.33 | 0.77 | 1.01 | 1.05 | 0.98 | 9.5 | 9.8 | Invention Example |
| 433 | 0.46 | 0.34 | 0.77 | 1.02 | 1.05 | 0.98 | 9.6 | 9.8 | Invention Example |
| 434 | 0.46 | 0.33 | 0.78 | 1.01 | 1.03 | 6.97 | 9.5 | 9.8 | Invention Example |
| 435 | 0.45 | 0.34 | 0.77 | 1.01 | 1.05 | 0.97 | 9.5 | 9.7 | Invention Example |
| 436 | 0.46 | 0.35 | 0.78 | 1.01 | 1.04 | 0.98 | 9.5 | 9.7 | Invention Example |
| 437 | 0.45 | 0.33 | 0.77 | 1.01 | 1.04 | 0.98 | 9.5 | 9.8 | Invention Example |
| 438 | 0.46 | 0.33 | 0.78 | 1.01 | 1.04 | 0.98 | 9.6 | 9.7 | Invention Example |
| 439 | 0.83 | 0.02 | 0.75 | 1.00 | 1.04 | 0.96 | 14.2 | 14.6 | Comparative Example |
| 440 | 0.83 | 0.03 | 0.75 | 1.01 | 1.03 | 0.97 | 14.2 | 14.5 | Comparative Example |
| 441 | Not evaluated since cracking occurs during cold rolling | | | | | | | | Comparative Example |
| 442 | Not evaluated since cracking occurs during cold rolling | | | | | | | | Comparative Example |
| 443 | 0.84 | 0.03 | 0.75 | 1.01 | 1.03 | 0.98 | 14.3 | 14.6 | Comparative Example |
| 444 | 0.84 | 0.03 | 0.75 | 1.00 | 1.02 | 0.98 | 14.2 | 14.6 | Comparative Example |
| 445 | 0.83 | 0.03 | 0.77 | 1.00 | 1.02 | 0.96 | 14.1 | 14.6 | Comparative Example |
| 446 | 0.84 | 0.02 | 0.77 | 1.00 | 1.04 | 0.98 | 14.1 | 14.5 | Comparative Example |
| 447 | Not evaluated since cracking occurs during cold rolling | | | | | | | | Comparative Example |
| 448 | 0.46 | 0.34 | 0.77 | 1.02 | 1.05 | 0.92 | 9.9 | 10.0 | Invention Example |

[symbol]

indicates data missing or illegible when filed

Underlined values in Table 7A to Table 7D and Table 8 indicate conditions deviating from the scope of the present invention. In all of No. 401 to No. 410, No. 417, No. 419, No. 420, No. 423 to No. 438, and No. 448, which are invention examples, the iron losses W10/400 and W10/400 (whole direction) were favorable values.

On the other hand, in No. 411 to No. 416, which are comparative examples, since at least any of Formula (1), the temperature in the intermediate annealing, the rolling reduction in the cold rolling, and the rolling reduction in the skin pass rolling was not optimal, at least one of Formula (20) to Formula (24) was not satisfied, and, as a result, the iron losses W 10/400 and W10/400 (whole direction) were high.

In addition, in No. 418, No. 421, and No. 422, which are comparative examples, since the temperature or time of the second heat treatment was not optimal, at least one of Formula (20) to Formula (24) was not satisfied, and, as a result, the iron losses W10/400 and W10/400 (whole direction) were high.

In addition, in No. 439 to No. 447, which are comparative examples, since the chemical compositions were outside the scope of the present invention, cracking occurred during the cold rolling, or Formula (20) and Formula (21) were not satisfied, and, as a result, the iron losses W10/400 and W10/400 (whole direction) were high.

### Fifth Example

Grain-oriented electrical steel sheets having chemical compositions shown in Table 9A were produced. Here, the column “Left side of Formula (1)” indicates the values of the left side of Formula (1) described above. After that, insulating films on the produced grain-oriented electrical steel sheets were removed, and cold rolling was performed in the width direction. The rolling reductions in the cold rolling at that time are shown in Table 9B.

Intermediate annealing was performed on the cold-rolled sheets in a non-oxidizing atmosphere at temperatures shown in Table 9B for 30 seconds, and then the second round of cold rolling (skin pass rolling) was performed at rolling reductions shown in Table 9B. This skin pass rolling was performed in the same direction as in the cold rolling.

Next, in order to investigate the texture, a part of each of the steel sheets was cut, the cut test piece was processed to reduce the thickness to 112, and EBSD observation (step intervals: 100 nm) was performed on the processed surface. The areas and average KAM values of kinds shown in Table 10 were obtained by EBSD observation.

In addition, as a second heat treatment, annealing was performed on the steel sheets at 800° C. for 2 hours. From each of the steel sheets after the second heat treatment, 55 mm×55 mm sample pieces were collected as measurement samples. At this time, a sample in which one side of the sample piece was parallel to a rolling direction and a sample in which one side was inclined at 45 degrees with respect to the rolling direction were collected. In addition, the samples were collected using a shearing machine. Additionally, as magnetic characteristics, the iron losses W10/400 (the average value of the rolling direction and the width direction) and W10/400 (whole direction) (the average value of the rolling direction, the width direction, a direction at 45 degrees with respect to the rolling direction, and a direction at 135 degrees with respect to the rolling direction) were measured in the same manner as in First Example. The measurement results are shown in Table 10.

TABLE 9A

| | Chemical composition (mass %, remainder is Fe and impurities) | | | | | | | | | | | |
|---|---|---|---|---|---|---|---|---|---|---|---|---|
| No. | C | Si | sol. Al | S | N | Mn | Sn | Sb | P | Mg | Ca | Sr |
| 501 | 0.0005 | 3.20 | 0.002 | 0.0002 | 0.0003 | 0.02 | — | — | — | — | — | — |
| 502 | 0.0006 | 3.18 | 0.002 | 0.0001 | 0.0003 | 0.02 | 0.04 | — | — | — | — | — |
| 503 | 0.0005 | 3.19 | 0.001 | 0.0003 | 0.0002 | 0.01 | — | 0.05 | — | — | — | — |
| 504 | 0.0005 | 3.21 | 0.002 | 0.0002 | 0.0003 | 0.02 | — | — | 0.06 | — | — | — |
| 505 | 0.0004 | 3.21 | 0.001 | 0.0002 | 0.0003 | 0.02 | — | — | — | 0.005 | — | — |
| 506 | 0.0005 | 3.19 | 0.001 | 0.0003 | 0.0002 | 0.02 | — | — | — | — | 0.005 | — |
| 507 | 0.0006 | 3.20 | 0.001 | 0.0002 | 0.0003 | 0.02 | — | — | — | — | — | 0.005 |
| 508 | 0.0005 | 3.20 | 0.002 | 0.0003 | 0.0002 | 0.01 | — | — | — | — | — | — |
| 509 | 0.0005 | 3.21 | 0.001 | 0.0003 | 0.0002 | 0.02 | — | — | — | — | — | — |
| 510 | 0.0005 | 3.22 | 0.001 | 0.0002 | 0.0003 | 0.02 | — | — | — | — | — | — |
| 511 | 0.0004 | 3.21 | 0.001 | 0.0002 | 0.0003 | 0.02 | — | — | — | — | — | — |
| 512 | 0.0005 | 3.19 | 0.001 | 0.0003 | 0.0002 | 0.02 | — | — | — | — | — | — |
| 513 | 0.0005 | 3.21 | 0.001 | 0.0001 | 0.0001 | 0.01 | — | — | — | — | — | — |
| 514 | 0.0004 | 3.21 | 0.001 | 0.0003 | 0.0002 | 0.01 | — | — | — | — | — | — |
| 515 | 0.0005 | 3.20 | 0.002 | 0.0002 | 0.0003 | 0.02 | — | — | — | — | — | — |
| 516 | 0.0005 | 3.20 | 0.002 | 0.0002 | 0.0003 | 0.02 | — | — | — | — | — | — |
| 517 | 0.0005 | 3.20 | 0.002 | 0.0002 | 0.0003 | 0.02 | — | — | — | — | — | — |
| 518 | 0.0005 | 3.20 | 0.002 | 0.0002 | 0.0003 | 0.02 | — | — | — | — | — | — |

| | Chemical composition (mass %, remainder is Fe and impurities) | | | | | | | | | |
|---|---|---|---|---|---|---|---|---|---|---|
| | | | | | | | | | | Laft side |
| | | | | | | | | | | of |
| | | | | | | | | | | Formula |
| No. | Ba | Ce | La | Nd | Pr | An | Cd | B | O | (1) |
| 501 | — | — | — | — | — | — | — | — | — | −3.19 |
| 502 | — | — | — | — | — | — | — | — | — | −3.17 |
| 503 | — | — | — | — | — | — | — | — | — | −3.18 |
| 504 | — | — | — | — | — | — | — | — | — | −3.19 |
| 505 | — | — | — | — | — | — | — | — | — | −3.20 |
| 506 | — | — | — | — | — | — | — | — | — | −3.17 |
| 507 | — | — | — | — | — | — | — | — | — | −3.19 |
| 508 | 0.005 | — | — | — | — | — | — | — | — | −3.19 |
| 509 | — | 0.005 | — | — | — | — | — | — | — | −3.20 |
| 510 | — | — | 0.006 | — | — | — | — | — | — | −3.20 |
| 511 | — | — | — | 0.005 | — | — | — | — | — | −3.19 |
| 512 | — | — | — | — | 0.006 | — | — | — | — | −3.18 |
| 513 | — | — | — | — | — | 0.005 | — | — | — | −3.20 |
| 514 | — | — | — | — | — | — | 0.004 | — | — | −3.20 |
| 515 | — | — | — | — | — | — | — | 0.0002 | — | −3.19 |
| 516 | — | — | — | — | — | — | — | 0.0045 | — | −3.19 |
| 517 | — | — | — | — | — | — | — | — | 0.0013 | −3.19 |
| 518 | — | — | — | — | — | — | — | — | 0.0170 | −3.19 |

TABLE 9B

| | | | | | Inter- | |
|---|---|---|---|---|---|---|
| | Sheet | | | | mediate | |
| | thickness | | Rolling | | annealing | |
| | (mm) | | reduction | | Anneal- | |
| | | After | (%) | | ing | |
| | Before | skin | | Skin | temper- | |
| | cold | pass | Cold | pass | ature | |
| No. | rolling | rolling | rolling | rolling | (° C.) | Note |
| 501 | 0.30 | 0.15 | 42 | 14 | 800 | Invention |
| | | | | | | Example |
| 502 | 0.30 | 0.15 | 42 | 14 | 800 | Invention |
| | | | | | | Example |
| 503 | 0.30 | 0.15 | 42 | 14 | 800 | Invention |
| | | | | | | Example |
| 504 | 0.30 | 0.15 | 42 | 14 | 800 | Invention |
| | | | | | | Example |
| 505 | 0.30 | 0.15 | 42 | 14 | 800 | Invention |
| | | | | | | Example |
| 506 | 0.30 | 0.15 | 42 | 14 | 800 | Invention |
| | | | | | | Example |
| 507 | 0.30 | 0.15 | 42 | 14 | 800 | Invention |
| | | | | | | Example |
| 508 | 0.30 | 0.15 | 42 | 14 | 800 | Invention |
| | | | | | | Example |
| 509 | 0.30 | 0.15 | 42 | 14 | 800 | Invention |
| | | | | | | Example |
| 510 | 0.30 | 0.15 | 42 | 14 | 800 | Invention |
| | | | | | | Example |
| 511 | 0.30 | 0.15 | 42 | 14 | 800 | Invention |
| | | | | | | Example |
| 512 | 0.30 | 0.15 | 42 | 14 | 800 | Invention |
| | | | | | | Example |
| 513 | 0.30 | 0.15 | 42 | 14 | 800 | Invention |
| | | | | | | Example |
| 514 | 0.30 | 0.15 | 42 | 14 | 800 | Invention |
| | | | | | | Example |
| 515 | 0.30 | 0.15 | 42 | 14 | 800 | Invention |
| | | | | | | Example |
| 516 | 0.30 | 0.15 | 42 | 14 | 800 | Invention |
| | | | | | | Example |
| 517 | 0.30 | 0.15 | 42 | 14 | 800 | Invention |
| | | | | | | Example |
| 518 | 0.30 | 0.15 | 42 | 14 | 800 | Invention |
| | | | | | | Example |

TABLE 10

| Second heat | |
|---|---|
| treatment | |
| | W10/W400 |
| | (whole |

| | EBSD observation result after skin pass rolling | | | | | | | | | | | | direction | |
|---|---|---|---|---|---|---|---|---|---|---|---|---|---|---|
| | | | | | S [symbol] / | S₄₁₁/ | S₄₁₁/ | K₄₁₁/ | K₄₁₁/ | S₄₁₁/ | K₄₁₁/ | W10/400 | average) | |
| No. | K [symbol] | K [symbol] | K₄₁₁ | K₁₁₀ | S [symbol] | S [symbol] | S [symbol] | K [symbol] | K [symbol] | S₁₁₀ | K₁₁₀ | (W/kg) | (W/kg) | Note |
| 501 | 0.370 | 0.365 | 0.364 | 0.366 | 0.71 | 0.15 | 0.72 | 0.984 | 0.998 | 5.57 | 0.995 | 9.6 | 9.8 | Invention |
| | | | | | | | | | | | | | | Example |
| 502 | 0.372 | 0.366 | 0.362 | 0.364 | 0.71 | 0.16 | 0.72 | 0.973 | 0.989 | 5.59 | 0.994 | 9.6 | 9.8 | Invention |
| | | | | | | | | | | | | | | Example |
| 503 | 0.370 | 0.365 | 0.363 | 0.365 | 0.71 | 0.17 | 0.74 | 0.981 | 0.995 | 5.58 | 0.994 | 9.6 | 9.8 | Invention |
| | | | | | | | | | | | | | | Example |
| 504 | 0.372 | 0.366 | 0.364 | 0.365 | 0.71 | 0.17 | 0.73 | 0.981 | 0.996 | 5.58 | 0.999 | 9.6 | 9.8 | Invention |
| | | | | | | | | | | | | | | Example |
| 505 | 0.371 | 0.365 | 0.363 | 0.366 | 0.73 | 0.16 | 0.73 | 0.979 | 0.995 | 5.56 | 0.994 | 9.6 | 9.8 | Invention |
| | | | | | | | | | | | | | | Example |
| 506 | 0.372 | 0.366 | 0.364 | 0.366 | 0.72 | 0.16 | 0.73 | 0.978 | 0.995 | 5.57 | 0.994 | 9.5 | 9.7 | Invention |
| | | | | | | | | | | | | | | Example |
| 507 | 0.371 | 0.366 | 0.363 | 0.365 | 0.71 | 0.16 | 0.72 | 0.980 | 0.993 | 5.57 | 0.996 | 9.6 | 9.8 | Invention |
| | | | | | | | | | | | | | | Example |
| 508 | 0.371 | 0.366 | 0.363 | 0.365 | 0.71 | 0.16 | 0.73 | 0.979 | 0.993 | 5.57 | 0.995 | 9.5 | 9.7 | Invention |
| | | | | | | | | | | | | | | Example |
| 509 | 0.371 | 0.366 | 0.363 | 0.366 | 0.71 | 0.16 | 0.73 | 0.979 | 0.991 | 5.57 | 0.991 | 9.4 | 9.6 | Invention |
| | | | | | | | | | | | | | | Example |
| 510 | 0.370 | 0.366 | 0.364 | 0.364 | 0.73 | 0.16 | 0.73 | 0.983 | 0.993 | 5.57 | 0.999 | 9.4 | 9.6 | Invention |
| | | | | | | | | | | | | | | Example |
| 511 | 0.371 | 0.366 | 0.364 | 0.367 | 0.71 | 0.15 | 0.74 | 0.981 | 0.994 | 5.58 | 0.992 | 9.5 | 9.7 | Invention |
| | | | | | | | | | | | | | | Example |
| 512 | 0.371 | 0.364 | 0.364 | 0.365 | 0.72 | 0.16 | 0.73 | 0.979 | 0.999 | 5.57 | 0.997 | 9.5 | 9.7 | Invention |
| | | | | | | | | | | | | | | Example |
| 513 | 0.370 | 0.366 | 0.363 | 0.365 | 0.73 | 0.15 | 0.73 | 0.983 | 0.994 | 5.58 | 0.997 | 9.4 | 9.6 | Invention |
| | | | | | | | | | | | | | | Example |
| 514 | 0.370 | 0.366 | 0.363 | 0.364 | 0.71 | 0.17 | 0.73 | 0.979 | 0.992 | 5.58 | 0.995 | 9.6 | 9.8 | Invention |
| | | | | | | | | | | | | | | Example |
| 515 | 0.370 | 0.366 | 0.363 | 0.365 | 0.73 | 0.15 | 0.73 | 0.983 | 0.994 | 5.58 | 0.997 | 9.4 | 9.6 | Invention |
| | | | | | | | | | | | | | | Example |
| 516 | 0.370 | 0.366 | 0.363 | 0.364 | 0.71 | 0.17 | 0.73 | 0.979 | 0.992 | 5.58 | 0.995 | 9.6 | 9.8 | Invention |
| | | | | | | | | | | | | | | Example |
| 517 | 0.370 | 0.366 | 0.363 | 0.365 | 0.73 | 0.15 | 0.73 | 0.983 | 0.994 | 5.58 | 0.997 | 9.4 | 9.6 | Invention |
| | | | | | | | | | | | | | | Example |
| 518 | 0.370 | 0.366 | 0.363 | 0.364 | 0.71 | 0.17 | 0.73 | 0.979 | 0.992 | 5.58 | 0.995 | 9.6 | 9.8 | Invention |
| | | | | | | | | | | | | | | Example |

[symbol]

indicates data missing or illegible when filed

In all of No. 501 to No. 518, which are invention examples, Formula (3) to Formula (9) were satisfied, and the iron losses W10/400 and W10/400 (whole direction) were favorable values.

### INDUSTRIAL APPLICABILITY

According to the present invention, it is possible to provide a non-oriented electrical steel sheet in which excellent magnetic characteristics can be obtained on a whole direction average and a method for manufacturing the same. Therefore, the present invention is highly industrially applicable.

1. A non-oriented electrical steel sheet comprising, as a chemical composition, by mass %:
C: 0.0100% or less;
Si: 1.50% to 4.00%;
one or more of Mn, Ni, Co, Pt, Pb, Cu, and Au: less than 2.50% in total;
sol. Al: 4.000% or less;
S: 0.0400% or less;
N: 0.0100% or less;
Sn: 0.00% to 0.40%;
Sb: 0.00% to 0.40%;
P: 0.00% to 0.40%;
Cr: 0.000% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {411}orientated grains is indicated by K₄₁₁, and an average KAM value of the orientated grains in which the Taylor factor M becomes more than 2.8 is indicated by K_{tyl}, Formulas (3) to (6) are satisfied,
([Mn]+[Ni]+[Co]+[Pt]+[Pb]+[Cu]+[Au])−([Si]+[sol. Al])≤0.00% (1)
M=(cosϕ×cosλ)⁻¹ (2)
0.20≤S_{tyl}/Sₜₒₜ≤0.85 (3)
0.05≤S₄₁₁/Sₜₒₜ≤0.80 (4)
S₄₁₁/S^{tra}≥0.50 (5)
K_{411/}K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

2. The non-oriented electrical steel sheet according to claim 1,
wherein, in a case where an average KAM value of the orientated grains in which the Taylor factor M becomes 2.8 or less is indicated by Kₜᵣₐ, Formula (7) is satisfied,
K₄₁₁/Kₜᵣₐ≤1.010 (7).

3. The non-oriented electrical steel sheet according to claim 1,
wherein, in a case where an area of {110} orientated grains is indicated by S₁₁₀, Formula (8) is satisfied,
S₄₁₁/S₁₁₀≥1.00 (8)
here, it is assumed that Formula (8) is satisfied even when an area ratio S₄₁₁/S₁₁₀ diverges to infinity.

4. The non-oriented electrical steel sheet according claim 1,
wherein, in a case where an average KAM value of {110} orientated grains is indicated by K₁₁₀, Formula (9) is satisfied,
K₄₁₁/K₁₁₀<1.010 (9).

5. A non-oriented electrical steel sheet comprising, as a chemical composition, by mass %:
C: 0.0100% or less;
Si: 1.50% to 4.00%;
one or more of Mn, Ni, Co, Pt, Pb, Cu, and Au: less than 2.50% in total;
sol. Al: 4.000% or less;
S: 0.0400% or less;
N: 0.0100% or less;
Sn: 0.00% to 0.40%;
Sb: 0.00% to 0.40%;
P: 0.00% to 0.40%;
Cr: 0.000% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {411}orientated grains is indicated by K₄₁₁, an average KAM value of the orientated grains in which the Taylor factor M becomes more than 2.8 is indicated by K_{tyl}, an average grain size in an observation region is indicated by dₐᵥₑ, an average grain size of the {411} orientated grains is indicated by d₄₁₁, and an average grain size of the orientated grains in which the Taylor factor M becomes more than 2.8 is indicated by d_{tyl}, Formulas (10) to (15) are satisfied,
([Mn]+[Ni]+[Co]+[Pt]+[Pb]+[Cu]+[Au])−([Si]+[sol. Al])≤0.00% (1)
M=(cosϕ×cosλ)⁻¹ (2)
S_{tyl}/Sₜₒₜ≤0.70 (10)
0.20≤S₄₁₁/Sₜₒₜ (11)
S₄₁₁/Sₜᵣₐ≥0.55 (12)
K₄₁₁/K_{tyl}≤1.010 (13)
d₄₁₁/dₐᵥₑ>1.00 (14)
d₄₁₁/d_{tyl}>1.00 (15)
here, ϕ in Formula (2) represents an angle formed by a stress vector and a slip direction vector of a crystal, and λ represents an angle formed by the stress vector and a normal vector of a slip plane of the crystal.

6. The non-oriented electrical steel sheet according to claim 5,
wherein, in a case where an average KAM value of the orientated grains in which the Taylor factor M becomes 2.8 or less is indicated by Kₜᵣₐ, Formula (16) is satisfied,
K₄₁₁/Kₜᵣₐ≤1.010 (16).

7. The non-oriented electrical steel sheet according to claim 5,
wherein, in a case where an average grain size of the orientated grains in which the Taylor factor M becomes 2.8 or less is indicated by dₜᵣₐ, Formula (17) is satisfied,
d₄₁₁/dₜᵣₐ>1.00 (17).

8. The non-oriented electrical steel sheet according to claim 5,
wherein, in a case where an area of {110} orientated grains is indicated by S₁₁₀, Formula (18) is satisfied,
S₄₁₁/S₁₁₀≥1.00 (18)
here, it is assumed that Formula (18) is satisfied even when an area ratio S₄₁₁/S₁₁₀ diverges to infinity.

9. The non-oriented electrical steel sheet according to claim 5,
wherein, in a case where an average KAM value of {110} orientated grains is indicated by K₁₁₀, Formula (19) is satisfied,
K₄₁₁/K₁₁₀<1.010 (19).

10. The non-oriented electrical steel sheet according to claim 1,
wherein the chemical composition contains, by mass %, one or more of:
Sn: 0.02% to 0.40%;
Sb: 0.02% to 0.40%; and
P: 0.02% to 0.40%.

11. The non-oriented electrical steel sheet according to claim 5,
wherein the chemical composition contains, by mass %, one or more of:
Mg, Ca, Sr, Ba, Ce, La, Nd, Pr, Zn, and Cd: 0.0005% to 0.0100% in total.

12. A method for manufacturing the non-oriented electrical steel sheet according to claim 1, the method comprising:
performing cold rolling in a width direction at a rolling reduction of 20% to 50% on a grain-oriented electrical steel sheet containing, as a chemical composition, by mass %:
C: 0.0100% or less,
Si: 1.50% to 4.00%,
one or more of Mn, Ni, Co, Pt, Pb, Cu, and Au:
less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities;
performing intermediate annealing on the steel sheet on which the cold rolling has been performed at a temperature of 650° C. or higher; and
performing skin pass rolling in the same direction as a rolling direction of the cold rolling at a rolling reduction of 5% to 30% on the steel sheet on which the intermediate annealing has been performed,
([Mn]+[Ni]+[Co]+[Pt]+[Pb]+[Cu]+[Au])−([Si]+[sol. Al])≤0.00% (1).

13. A method for manufacturing the non-oriented electrical steel sheet according to claim 5, the method comprising:
performing a heat treatment on the non-oriented electrical steel sheet which includes, as a chemical composition, by mass %: C: 0.0100% or less; Si: 1.50% to 4.00%; one or more of Mn, Ni, Co, Pt, Pb, Cu, and Au: less than 2.50% in total: sol. Al: 4.000% or less: S: 0.0400% or less: N: 0.0100% or less; Sn: 0.00% to 0.40%; Sb: 0.00% to 0.40%; P: 0.00% to 0.40%; Cr: 0.000% to 0.100%; B; 0.0000% to 0.0050%; O: 0.0000% to 0.0200%; one or more of Mg, Ca, Sr, Ba, Ce, La, Nd, Pr, Zn, and Cd: 0.0000% to 0.0100% in total, in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and a remainder of Fe and impurities, wherein, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average KAM value of the {411} orientated grains is indicated by K₄₁₁, and an average KAM value of the orientated grains in which the Taylor factor M becomes more than 2.8 is indicated by Ki, Formulas (3) to (6) are satisfied, at a temperature of 700° C. to 950° C. for 1 second to 100 seconds,
([Mn]+[Ni]+[Co]+[Pt]+[Pb]+[Cu]+[Au])−([Si]+[sol. Al])≤0.00% (1)
M=(cosϕ×cosλ)⁻¹ (2)
0.20≤S_{tyl}/Sₜₒₜ≤0.85 (3)
0.05≤S₄₁₁/Sₜₒₜ≤0.80 (4)
S₄₁₁/S^{tra}≥0.50 (5)
K_{411/}K_{tyl}≤0.990 (6)
here, ϕ in Formula (2) represents an angle formed by a stress vector and a slip direction vector of a crystal, and λ represents an angle formed by the stress vector and a normal vector of a slip plane of the crystal.

14. A non-oriented electrical steel sheet comprising, as a chemical composition, by mass %:
C: 0.0100% or less;
Si: 1.50% to 4.00%;
one or more of Mn, Ni, Co, Pt, Pb, Cu, and Au: less than 2.50% in total;
sol. Al: 4.000% or less;
S: 0.0400% or less;
N: 0.0100% or less;
Sn: 0.00% to 0.40%;
Sb: 0.00% to 0.40%;
P: 0.00% to 0.40%;
Cr: 0.000% to 0.100%;
B: 0.0000% to 0.0050%;
O: 0.0000% to 0.0200%;
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied; and
a remainder of Fe and impurities,
wherein, when EBSD observation is performed on a surface parallel to a steel sheet surface, in a case where a total area is indicated by Sₜₒₜ, an area of {411} orientated grains is indicated by S₄₁₁, an area of orientated grains in which a Taylor factor M according to Formula (2) becomes more than 2.8 is indicated by S_{tyl}, a total area of orientated grains in which the Taylor factor M becomes 2.8 or less is indicated by Sₜᵣₐ, an average grain size in an observation region is indicated by dₐᵥₑ, an average grain size of the {411} orientated grains is indicated by d₄₁₁, and an average grain size of the orientated grains in which the Taylor factor M becomes more than 2.8 is indicated by d_{tyl}, Formulas (20) to (24) are satisfied,
([Mn]+[Ni]+[Co]+[Pt]+[Pb]+[Cu]+[Au])−([Si]+[sol. Al])≤0.00% (1)
M=(cosϕ×cosλ)⁻¹ (2)
S_{tyl}/Sₜₒₜ<0.55 (20)
S₄₁₁/Sₜₒₜ>0.30 (21)
S₄₁₁/Sₜᵣₐ≥0.60 (22)
d₄₁₁/dₐᵥₑ≥0.95 (23)
d₄₁₁/d_{tyl}≥0.95 (24)
here, ϕ in Formula (2) represents an angle formed by a stress vector and a slip direction vector of a crystal, and λ represents an angle formed by the stress vector and a normal vector of a slip plane of the crystal.

15. The non-oriented electrical steel sheet according to claim 14,
wherein, in a case where an average grain size of the orientated grains in which the Taylor factor M becomes 2.8 or less is indicated by dₜᵣₐ, Formula (25) is satisfied,
d₄₁₁/dₜᵣₐ≥0.95 (25).

16. A method for manufacturing a non-oriented electrical steel sheet, comprising:
performing a heat treatment on the non-oriented electrical steel sheet according to claim 1 at a temperature of 950° C. to 1050° C. for 1 second to 100 seconds or at a temperature of 700° C. to 900° C. for longer than 1000 seconds.

17. The non-oriented electrical steel sheet according to claim 5,
wherein the chemical composition contains, by mass %, one or more of:
Sn: 0.02% to 0.40%;
Sb: 0.02% to 0.40%; and
P: 0.02% to 0.40%.

18. The non-oriented electrical steel sheet according to claim 5,
wherein the chemical composition contains, by mass %, one or more of:
Mg, Ca, Sr, Ba, Ce, La, Nd, Pr, Zn, and Cd: 0.0005% to 0.0100% in total.

19. A method for manufacturing a non-oriented electrical steel sheet, comprising:
performing a heat treatment on the non-oriented electrical steel sheet according to claim 5 at a temperature of 950° C. to 1050° C. for 1 second to 100 seconds or at a temperature of 700° C. to 900° C. for longer than 1000 seconds.

20. A method for manufacturing the non-oriented electrical steel sheet according to claim 2, the method comprising:
performing cold rolling in a width direction at a rolling reduction of 20% to 50% on a grain-oriented electrical steel sheet containing, as a chemical composition, by mass %:
C: 0.0100% or less,
Si: 1.50% to 4.00%,
one or more of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities;
performing intermediate annealing on the steel sheet on which the cold rolling has been performed at a temperature of 650° C. or higher; and
performing skin pass rolling in the same direction as a rolling direction of the cold rolling at a rolling reduction of 5% to 30% on the steel sheet on which the intermediate annealing has been performed,
([Mn]+[Ni]+[Co]+[Pt]+[Pb]+[Cu]+[Au])−([Si]+[sol. Al])≤0.00% (1).

21. A method for manufacturing the non-oriented electrical steel sheet according to claim 3, the method comprising:
performing cold rolling in a width direction at a rolling reduction of 20% to 50% on a grain-oriented electrical steel sheet containing, as a chemical composition, by mass %:
C: 0.0100% or less,
Si: 1.50% to 4.00%,
one or more of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities;
performing intermediate annealing on the steel sheet on which the cold rolling has been performed at a temperature of 650° C. or higher; and
performing skin pass rolling in the same direction as a rolling direction of the cold rolling at a rolling reduction of 5% to 30% on the steel sheet on which the intermediate annealing has been performed,
([Mn]+[Ni]+[Co]+[Pt]+[Pb]+[Cu]+[Au])−([Si]+[sol. Al])≤0.00% (1).

22. A method for manufacturing the non-oriented electrical steel sheet according to claim 4, the method comprising:
performing cold rolling in a width direction at a rolling reduction of 20% to 50% on a grain-oriented electrical steel sheet containing, as a chemical composition, by mass %:
C: 0.0100% or less,
Si: 1.50% to 4.00%,
one or more of Mn, Ni, Co, Pt, Pb, Cu, and Au: less than 2.50% in total,
sol. Al: 4.000% or less,
S: 0.0400% or less,
N: 0.0100% or less,
Sn: 0.00% to 0.40%,
Sb: 0.00% to 0.40%,
P: 0.00% to 0.40%,
Cr: 0.000% to 0.100%,
B: 0.0000% to 0.0050%,
O: 0.0000% to 0.0200%,
one or more of Mg, Ca, Sr, Ba, Ce, La, Nd, Pr, Zn, and Cd: 0.0000% to 0.0100% in total,
in which, when a Mn content (mass %) is indicated by [Mn], a Ni content (mass %) is indicated by [Ni], a Co content (mass %) is indicated by [Co], a Pt content (mass %) is indicated by [Pt], a Pb content (mass %) is indicated by [Pb], a Cu content (mass %) is indicated by [Cu], a Au content (mass %) is indicated by [Au], a Si content (mass %) is indicated by [Si], and a sol. Al content (mass %) is indicated by [sol. Al], Formula (1) is satisfied, and
a remainder of Fe and impurities;
performing intermediate annealing on the steel sheet on which the cold rolling has been performed at a temperature of 650° C. or higher; and
performing skin pass rolling in the same direction as a rolling direction of the cold rolling at a rolling reduction of 5% to 30% on the steel sheet on which the intermediate annealing has been performed,
([Mn]+[Ni]+[Co]+[Pt]+[Pb]+[Cu]+[Au])−([Si]+[sol. Al])≤0.00% (1).
